(19) United States
(12) Patent Application Publication
(10) Pub. No.: US 2024/0042411 A1
(43) Pub. Date: Feb. 8, 2024

(54) Pre-Stabilisation Reactor and System

(71) Applicant: Deakin University, Geelong, Victoria (AU)

(72) Inventors: Stephen Paul Atkiss, Scotland (GB); Maxime Robert Maghe, Victoria (AU)

(21) Appl. No.: 18/264,466

(22) PCT Filed: Feb. 8, 2021
(86) PCT No.: PCT/AU2021/050100

§ 371 Date: Aug. 7, 2023

(51) Int. Cl. B01J 19/00

(52) U.S. Cl. CPC B01J 19/0073; B01J 19/0006

(57) ABSTRACT

The present invention relates to a reactor for pre-stabilising a precursor for a carbon-based material, the reactor comprising: a reaction chamber adapted to pre-stabilise the precursor in a substantially oxygen-free atmosphere as the precursor is passed through the reaction chamber under a predetermined tension; an inlet for allowing the precursor to enter the reaction chamber; an outlet for allowing the precursor to exit the reaction chamber; and a gas delivery system for delivering substantially oxygen-free gas to the reaction chamber, the gas delivery system comprising: a gas seal assembly for sealing the reaction chamber to provide the substantially oxygen-free atmosphere therein and for limiting incidental gas flow out of the reactor through the inlet and the outlet; and a forced gas flow assembly for providing a flow of heated substantially oxygen-free gas in the reaction chamber to heat the precursor in the substantially oxygen-free atmosphere.

### TECHNICAL FIELD

The invention relates to a reactor and system for forming a partially stabilised precursor, in particular a partially stabilised precursor that can be used in the manufacture of carbon-based materials such as carbon fibre.

### BACKGROUND

Carbon fibres are fibres predominately composed of carbon atoms, which are manufactured by converting organic precursors, such as polyacrylonitrile (PAN) precursors, into carbon.

Conventionally, carbon fibre is manufactured by subjecting a PAN precursor to a series of heat treatments, which can be broadly divided into two major steps; stabilisation and carbonisation. The first major step, called stabilisation, involves the heating of a PAN precursor in air at a temperature of from 200° C. to 300° C. in order to prepare the precursor to be able to withstand the following carbonisation step. During carbonisation, the stabilised precursor is pyrolysed and undergoes chemical rearrangement, leading to the release of non-carbonaceous atoms and the formation of a highly ordered carbon-based structure. The carbonisation step is often performed at temperatures ranging from 400° C. to 1600° C., in furnaces containing an inert atmosphere.

The stabilisation process is often performed in a series of ovens and can take a number of hours to complete. Consequently, precursor stabilisation can be costly from a time and energy perspective, thus making it an expensive part of the carbon fibre manufacturing process. Additionally, the exothermic nature of stabilisation reactions as well as the combination of heat and oxygen used for precursor stabilisation can present a fire risk, thus giving rise to serious safety concerns.

It would be desirable to provide a system for the preparation of a stabilised PAN precursor that overcomes or ameliorates one or more shortcomings of conventional precursor stabilisation systems. It would also be desirable to provide a system that enables carbon fibre to be manufactured in a more efficient manner.

### SUMMARY OF THE INVENTION

Embodiments of the present invention are directed to a reactor for preparing a pre-stabilised precursor. The pre-stabilised precursor may be suitable for use in the manufacture of carbon materials, such as carbon fibre. Advantageously, in some embodiments, the reactor of the invention may enable a stabilised precursor fibre useful for carbon fibre manufacture to be formed rapidly.

The present invention provides reactor for pre-stabilising a precursor for a carbon-based material, the reactor comprising:
a reaction chamber adapted to pre-stabilise the precursor in a substantially oxygen-free atmosphere as the precursor is passed through the reaction chamber under a predetermined tension;
an inlet for allowing the precursor to enter the reaction chamber;
an outlet for allowing the precursor to exit the reaction chamber; and
a gas delivery system for delivering substantially oxygen-free gas to the reaction chamber, the gas delivery system comprising:
a gas seal assembly for sealing the reaction chamber to provide the substantially oxygen-free atmosphere therein and for limiting incidental gas flow out of the reactor through the inlet and the outlet; and
a forced gas flow assembly for providing a flow of heated substantially oxygen-free gas in the reaction chamber to heat the precursor in the substantially oxygen-free atmosphere.

In some embodiments, the forced gas flow assembly may be configured to provide a recirculating flow of heated substantially oxygen-free gas in the reaction chamber to heat the precursor in the substantially oxygen-free atmosphere. Accordingly, in some embodiments, the forced gas flow assembly comprises at least one return duct arranged to receive substantially oxygen-free gas from the reaction chamber and return substantially oxygen-free gas to the reaction chamber to recirculate substantially oxygen-free gas through the reaction chamber.

The forced gas flow assembly may be adapted to recirculate 80% to 98% of the flow of heated substantially oxygen-free gas in the reaction chamber. In some embodiments, the forced gas flow assembly is adapted to recirculate at least 90% of the flow of heated substantially oxygen-free gas in the reaction chamber.

The reaction chamber may comprise two or more reaction zones. Alternatively or additionally, the reactor may comprise two or more reaction chambers.

In some embodiments, the forced gas flow assembly is adapted to provide a flow of heated substantially oxygen-free gas from the centre of the reaction chamber towards each end of the reaction chamber. In some other embodiments, the forced gas flow assembly is adapted to provide a flow of heated substantially oxygen-free gas from each end of the reaction chamber towards the centre of the reaction chamber.

In some embodiments, the reactor comprises a heating system for externally heating one or more reaction zones of the reaction chamber. The heating system may comprise one or more heating elements for heating said one or more reaction zones. The one or more heating elements may be positioned within a heating jacket, the heating jacket being adapted to contain a heat transfer medium for distributing the heat from the heating elements along said one or more reaction zones.

In some embodiments, the heating system comprises at least one return line (e.g. at least one return duct) arranged to receive heat transfer medium from the heating jacket and return heat transfer medium to the heating jacket to recirculate heat transfer medium through the heating jacket.

In some embodiments, the gas seal assembly comprises: a gas curtain sub-assembly for providing a sealing gas curtain between the reaction chamber and each of the inlet and outlet; and an exhaust sub-assembly for extracting exhaust gases.

In some embodiments, the exhaust sub-assembly comprises a hazardous gas abatement system for decontaminating the exhaust gases. The hazardous gas abatement system may include a burner for combusting the exhaust gases so as to destroy reaction by-products and produce hot combustion gasses. In some of those embodiments, the gas delivery system comprises a supply line fluidly connected to a source of substantially oxygen-free gas for supplying substantially oxygen-free gas; and the hazardous gas abatement system comprises a heat exchanger for transferring heat from the hot combustion gasses to the substantially oxygen-free gas supplied by the supply line so as to warm the substantially oxygen-free gas and cool the combustion gasses.

In some embodiments, the reactor comprises a cooling section, between the reaction chamber and the outlet, for actively cooling the precursor before the precursor exits the reactor.

In some embodiments, the reaction chamber is vertically-orientated; the reactor has a lower end and an upper end; the inlet and the outlet are located at the lower end of the reactor; and the reactor further comprises a roller for passing the precursor through the reaction chamber from the inlet to the outlet, wherein the roller is located at the upper end of the reactor and is for being disposed in the substantially oxygen-free atmosphere.

Embodiments of the reactor of the present invention can be used to prepare a pre-stabilised precursor for a carbon fibre where the pre-stabilisation comprises the step of: heating a precursor comprising polyacrylonitrile in a substantially oxygen-free atmosphere while applying a predetermined amount of tension to the precursor, the temperature and time period in which the precursor is heated in the atmosphere and the tension applied to the precursor being sufficient to form a pre-stabilised precursor comprising at least 10% cyclised nitrile groups as determined by Fourier transform infrared (FT-IR) spectroscopy.

Furthermore, embodiments of the reactor of the present invention can be used to prepare a pre-stabilised precursor comprising:
heating a precursor comprising polyacrylonitrile in a substantially oxygen-free atmosphere while applying a substantially constant amount of tension to the precursor to promote cyclisation of nitrile groups in the precursor, the temperature and time period in which the precursor is heated in the substantially oxygen-free atmosphere and the amount of tension applied to the precursor each being selected to form a pre-stabilised precursor having at least 10% cyclised nitrile groups as determined by Fourier transform infrared (FT-IR) spectroscopy.

The temperature, time and tension conditions selected for a pre-stabilisation process using the reactor of the present invention may enable a pre-stabilised precursor having at least 10% cyclised nitrile groups to be generated in a short period of time.

In particular embodiments, the temperature in which the precursor is heated in the substantially oxygen-free atmosphere and the amount of tension applied to the precursor as it is heated are each selected to promote formation at least 10% cyclised nitrile groups in the precursor in a time period selected from the group consisting of less than 5 minutes, less than 4 minutes, less than 3 minutes, or less than 2 minutes. Thus in some embodiments, the precursor need only be heated in the substantially oxygen-free atmosphere for a short period of time (i.e. several minutes) to generate a pre-stabilised precursor having at least 10% cyclised nitrile groups.

During the precursor stabilisation process using the reactor described herein, the precursor may be heated in the substantially oxygen-free atmosphere at a temperature that is sufficient to trigger formation of at least 10% cyclised nitrile groups in the precursor within the time period selected.

In some embodiments, the precursor is heated in the substantially oxygen-free atmosphere at a temperature that is in proximity to the degradation temperature of the precursor. In one preference, the precursor is heated in the substantially oxygen-free atmosphere at a temperature that is not more than 30° C. below the degradation temperature of the precursor.

In particular embodiments, the precursor is heated in the substantially oxygen-free atmosphere at a temperature in a range of from about 250° C. to 400° C., preferably a temperature in a range of from about 280° C. to 320° C.

The amount of tension applied to the precursor can influence the extent of nitrile group cyclisation. Tension can be selected to enable a desired amount of cyclised nitrile groups to be formed in the pre-stabilised precursor under selected parameters of temperature and time period for heating the precursor in the substantially oxygen-free atmosphere.

In one or more embodiments, the amount of tension applied to the precursor is selected to form a pre-stabilised precursor having at least 15% cyclised nitrile groups, preferably at least 20% cyclised nitrile groups, as determined by Fourier transform infrared (FT-IR) spectroscopy.

In a specific embodiment, the amount of tension applied to the precursor is selected to form a pre-stabilised precursor having 20% to 30% cyclised nitrile groups, as determined by Fourier transform infrared (FT-IR) spectroscopy.

It has been found that precursors comprising polyacrylonitrile have the potential to attain a maximum amount of nitrile group cyclisation. Pre-stabilisation process parameters of temperature, time and tension can be selected to promote a maximum extent of nitrile group cyclisation in the precursor. Alternatively, pre-stabilisation process parameters of temperature, time and tension can be selected to promote an extent of nitrile group cyclisation in the precursor that varies from the maximum amount potentially attainable by an acceptable amount.

Accordingly the process of pre-stabilising a precursor using the reactor of the present invention may comprise a step of determining a tension parameter for a precursor prior to forming the pre-stabilised precursor, wherein determining the tension parameter for the precursor comprises:
selecting a temperature and time period for heating a precursor in a substantially oxygen-free atmosphere;
applying a range of different substantially constant amounts of tension to the precursor while heating the precursor in the substantially oxygen-free atmosphere at the selected temperature and for the selected time period;
determining by Fourier transform infrared (FT-IR) spectroscopy the amount of cyclised nitrile groups formed in the precursor for each substantially constant amount of tension applied to the precursor;
calculating a trend of extent of nitrile group cyclisation (% EOR) versus tension;
identifying, from the calculated trend, the amounts of tension providing at least 10% nitrile group cyclisation and maximum nitrile group cyclisation in the precursor; and
selecting an amount of tension giving rise to at least 10% nitrile group cyclisation to pre-stabilise the precursor.

In some embodiments of the tension parameter determining step, an amount of tension giving rise to maximum nitrile cyclisation is selected to pre-stabilise the precursor as described herein.

In some embodiments, the amount of tension applied to the precursor is selected to promote an extent of nitrile group cyclisation that is up to 80% less than the maximum amount that is attainable in the precursor.

In another embodiment, the amount of tension applied to the precursor is selected to promote formation of the maximum amount of nitrile group cyclisation that is attainable in the precursor. A pre-stabilised precursor having a maximum amount of cyclised nitrile groups can facilitate formation of a stabilised precursor with improved efficiency.

In one or more embodiments, an amount of tension in a range of from about 50 cN to about 50,000 cN may be applied to precursor as it is heated in the substantially oxygen-free atmosphere.

The substantially oxygen-free atmosphere that can be provided within the reaction chamber of the reactor described herein may comprise a suitable gas. In one embodiment, the substantially oxygen-free atmosphere comprises nitrogen.

Once pre-stabilised, the precursor can be exposed to an oxygen containing atmosphere under conditions that are sufficient to form a stabilised precursor. Desirably, the stabilised precursor is capable of being carbonised to form a carbon-based material, such as carbon fibre.

The reactor of the present invention may be combined with a suitable oxidation reactor to provide a stabilisation apparatus. In particular, the present invention provides an apparatus for stabilising a precursor for a carbon-based material, the apparatus comprising:
a reactor for producing a pre-stabilised precursor according to the present invention; and
an oxidation reactor downstream from the reactor, the oxidation reactor comprising
   at least one oxidation chamber adapted to stabilise the pre-stabilised precursor in an oxygen-containing atmosphere as the pre-stabilised precursor is passed through the oxidation chamber(s).

The or each oxidation chamber the oxidation reactor comprises:
an inlet for allowing the precursor to enter the oxidation chamber; and
an outlet for allowing the precursor to exit the oxidation chamber;
   and the oxidation reactor may further comprise
an oxidation gas delivery system for delivering oxygen-containing gas to the or each oxidation chamber, the oxidation gas delivery system comprising:
a gas seal assembly for limiting incidental gas flow out of the oxidation reactor through the inlet(s) and the outlet(s); and
a forced gas flow assembly for providing a flow of heated oxygen-containing gas in the or each oxidation chamber to heat the pre-stabilised precursor in the oxygen-containing atmosphere.

In some embodiments, the forced gas flow assembly of the oxidation reactor may be configured to provide a recirculating flow of heated oxygen-containing gas in the or each oxidation chamber to heat the pre-stabilised precursor in the oxygen-containing atmosphere. Accordingly, the forced gas flow assembly of the oxidation reactor may comprise at least one return duct arranged to receive oxygen-containing gas from the oxidation chamber and return oxygen-containing gas to the oxidation chamber to recirculate oxygen-containing gas through the oxidization chamber.

In some embodiments, the reactor is located beneath the oxidation reactor.

In some embodiments, the apparatus comprises two or more oxidation chambers, for example four or more oxidation chambers.

In some embodiments, the apparatus is adapted for production volumes of stabilised precursor up to 1,500 tonne per year.

In some embodiments, the apparatus is configured to fit within a standard 40-foot shipping container.

In some embodiments, the apparatus may comprise tensioning devices located upstream and downstream of the reaction chamber, wherein the tensioning devices are adapted to pass the precursor through the reaction chamber under a predetermined tension.

The present invention further provides a system for stabilising a precursor for a carbon-based material, the system comprising:
a reactor for producing a pre-stabilised precursor according to the present invention;
tensioning devices located upstream and downstream of the reaction chamber, wherein the tensioning devices are adapted to pass the precursor through the reaction chamber under a predetermined tension; and
an oxidation reactor downstream from the reactor, the oxidation reactor comprising
   at least one oxidation chamber adapted to stabilise the pre-stabilised precursor in an oxygen-containing atmosphere as the pre-stabilised precursor is passed through the oxidation chamber(s).

The pre-stabilised precursor may only need to be exposed to the oxygen containing atmosphere for a relatively short period of time to form a stabilised precursor, compared to conventional precursor stabilisation processes known in the prior art. In some embodiments, the pre-stabilised precursor is exposed to the oxygen containing atmosphere in the oxidation reactor for a time period of no more than about 30 minutes.

The pre-stabilised precursor is preferably heated when in the oxygen containing atmosphere. Heating of the pre-stabilised precursor can facilitate rapid formation of the stabilised precursor. In some particular embodiments, the pre-stabilised precursor is heated in the oxygen containing atmosphere at a temperature in a range of from about 200° C. to 300° C.

In one set of embodiments, the pre-stabilised precursor is heated in the oxygen containing atmosphere at a temperature that is lower than that used to form the pre-stabilised precursor using the reactor.

As temperature for forming the stabilised precursor may be lower than that employed for forming the pre-stabilised precursor, some embodiments of the precursor stabilisation process described herein may further comprise a step of cooling the pre-stabilised precursor prior to exposing the pre-stabilised precursor to the oxygen containing atmosphere. As noted above, the reactor may comprise a cooling section and the cooling section may be used for this cooling step.

The apparatus and system for stabilising a precursor of the present invention can each enable a suitably stabilised precursor to be formed rapidly.

In some embodiments, the apparatus and system may each enable a stabilised precursor to be formed in a time period selected from no more than about 60 minutes, no more than about 45 minutes, no more than about 30 minutes, and no more than about 25 minutes.

In some embodiments, the apparatus and system of the invention may each form a stabilised precursor with an average energy consumption in a range of from about 1.1 to 2.6 kWh/kg.

The present invention further provides a system for preparing a carbon-based material, the system comprising:
a reactor for producing a pre-stabilised precursor according to the present invention;
tensioning devices located upstream and downstream of the reaction chamber, wherein the tensioning devices are adapted to pass the precursor through the reaction chamber under a predetermined tension; and
an oxidation reactor downstream from the reactor, the oxidation reactor comprising
   at least one oxidation chamber adapted to stabilise the pre-stabilised precursor in an oxygen-containing atmosphere as the pre-stabilised precursor is passed through the oxidation chamber(s); and
a carbonisation unit for carbonising the stabilised precursor to form the carbon-based material.

In some embodiments, the system for preparing a carbon-based material may be used to prepare a carbon fibre. In some embodiments, the system for preparing a carbon-based material may be used to continuously prepare a carbon fibre.

Conventional carbonisation process conditions may be employed in the carbonisation unit, during use, to convert the stabilised precursor into carbon fibre. In one set of embodiments, carbonising the stabilised precursor comprises heating the stabilised precursor in an inert atmosphere in the carbonisation unit at a temperature in a range of from about 350° C. to 3,000° C.

In one or more embodiments, the system for preparing a carbon-based material may be used to form a carbon fibre within a time period of no more that about 70 minutes, no more than about 60 minutes, no more than about 50 minutes, no more than about 45 minutes, or no more than about 30 minutes.

In some embodiments, the system for preparing a carbon-based material is configured to continuously prepare a carbon-based material, such as carbon fibre. In such embodiments, the continuous process using the system may comprise:
feeding a precursor comprising polyacrylonitrile to the reactor and heating the precursor in the substantially oxygen-free atmosphere while applying a substantially constant amount of tension to the precursor to promote cyclisation of nitrile groups in the precursor, the temperature and time period in which the precursor is heated in the substantially oxygen-free atmosphere and the amount of tension applied to the precursor each being selected to form a pre-stabilised precursor having at least 10% cyclised nitrile groups as determined by Fourier transform infrared (FT-IR) spectroscopy;
feeding the pre-stabilised precursor to the oxidation reactor; and
feeding the stabilised precursor to the carbonisation unit and carbonising the stabilised precursor in the carbonisation unit to form the carbon fibre.

In some embodiments of a continuous carbon fibre preparation process there may be a further step of actively cooling the pre-stabilised precursor in a cooling section of the reactor prior to the pre-stabilised precursor exiting the reactor.

In the apparatus or the system of the present invention, there may be provided tensioning devices located upstream and downstream of the or each oxidation chamber, wherein the tensioning devices are adapted to pass the pre-stabilised precursor through the or each oxidation chamber under a predetermined tension. In some embodiments, each tensioning device comprises a load cell for sensing the amount of tension being applied.

The apparatus or the system of the present invention may comprised a reflectance Fourier-transform infra-red (FT-IR) spectrometer disposed downstream of the outlet of the reactor and upstream of the oxidation reactor, said FT-IR spectrometer being for monitoring the percentage of cyclised nitrile groups in the pre-stabilised precursor output from the reactor.

Also provided is a pre-stabilised precursor prepared using any one of the embodiments of the reactor described herein. Further provided is a stabilised precursor prepared using any of the embodiments of the apparatus and system described herein. The stabilised precursor can suitably be used in the manufacture of carbon-based materials, such as carbon fibre.

Further, there is also provided a carbon fibre prepared using any of the embodiments described herein of a system for preparing a carbon-based material.

Embodiments of a pre-stabilisation process for which the reactor of the present invention may be used, embodiments of a stabilisation process for which the apparatus and system of the present invention may be used, and embodiments of a carbonisation process for which the system for preparing a carbon-based material of present invention may be used are described in each of: Australian Provisional Patent Application No. 2016904220, and International Patent Application No. PCT/AU2017/051094 (published as International Publication No. WO/2019/071286), the contents of each of which are incorporated herein by reference.

### DISCLOSURE OF THE INVENTION

The present invention provides a reactor suitable for pre-stabilising a precursor for a carbon fibre, which is useful in the manufacture of a carbon-based material, in particular, carbon fibre. Referring to FIG. 12, some embodiments of the present invention generally relate to a reactor 10 used to treat a precursor 80 as part of a system 90 for continuously manufacturing carbon fibre. FIG. 12 shows the carbon fibre production system 90 in the form of a block diagram. The illustrated reactor 10 is used to produce a pre-stabilised precursor 81 from a polyacrylonitrile fibre precursor 80, but other types of reactors (for example for treating or processing other types of precursors such as precursors in the form of a yarn, web, film, fabric, weave, felt or mat) are within the scope of the present invention.

A fibre source 40 is used to dispense the precursor 80. In some embodiments, the fibre source may be a boxed, spooled or baled fibre. For example, the fibre source may be a creel. Multiple fibres of the precursor 80 are simultaneously dispensed by the fibre source 40 as groups of fibres called tows. After the precursor fibres 80 are dispensed, they are passed through a material handling device 30, such as a tension stand having a plurality of rollers, as is well known in the art. This material handling device 30 is used, together with the material handling device 30 downstream of the reactor 10, to apply a predetermined tension to the precursor 80 as it passes through the reactor 10 to form the pre-stabilised precursor 81.

The pre-stabilised precursor 81 is then fed into an oxidation reactor 20, which may include a series of oxidation chambers. A further material handling device 30 is used to draw the pre-stabilised precursor 81 through the oxidation reactor 20. Similarly to the reactor 10, the material handling devices 30 upstream and downstream of the oxidation reactor 20 may be used to apply a predetermined tension to the pre-stabilised precursor 81 as it passes through the oxidation reactor 20 to form the stabilised precursor 82. The structural and operational characteristics of the reactor 10 and the oxidation reactor 20 will be discussed in further detail below.

The stabilised precursor 82 is then processed by the carbonisation unit 50 to pyrolyse the stabilised precursor 82 and convert it into carbon fibre 83. The carbonisation unit includes one or more carbonisation reactors. The carbonisation reactors may be ovens or furnaces that are adapted to contain a substantially oxygen-free atmosphere and can withstand the high temperature conditions generally employed for carbon fibre formation. Next, a surface treatment may be performed at a treatment station 60. Then, a sizing may be applied to the treated carbon fibre 84 at a sizing station 65.

The tows of sized carbon fibres 85 are then wound using a winder 70. Each tow contains hundreds or thousands of individual carbon fibre filaments 85. Multiple tows are typically braided, stitched or weaved together to form carbon fibre fabrics. As one skilled in the art will appreciate, other processing apparatus, including additional treatment devices and/or additional materials handling devices 30, may be employed as needed for the carbon fibre production system 90.

The reactor of the present invention can be used to prepare a pre-stabilised precursor for a carbon fibre where the pre-stabilisation comprises the step of: heating a precursor comprising polyacrylonitrile in a substantially oxygen-free atmosphere while applying a predetermined amount of tension to the precursor, the temperature and time period in which the precursor is heated in the atmosphere and the tension applied to the precursor being sufficient to form a pre-stabilised precursor comprising at least 10% cyclised nitrile groups as determined by Fourier transform infrared (FT-IR) spectroscopy. In some embodiments, the amount of tension applied may be a substantially constant amount as the precursor is pre-stabilised.

The reactor of the present invention can be used to prepare a pre-stabilised precursor, said use comprising: heating a precursor comprising polyacrylonitrile in a substantially oxygen-free atmosphere while applying a substantially constant amount of tension to the precursor to promote cyclisation of nitrile groups in the precursor, the temperature and time period in which the precursor is heated in the atmosphere and the amount of tension applied to the precursor each being selected to form a pre-stabilised precursor having at least 10% cyclised nitrile groups as determined by Fourier transform infrared (FTIR) spectroscopy.

After the pre-stabilisation, the precursor will be partially stabilised and may have at least 10% cyclised nitrile groups. This pre-stabilised precursor can be further treated in an oxygen-containing atmosphere in an oxidation reactor to form a stabilised precursor.

It has been found that by initiating stabilisation reactions in a substantially oxygen-free atmosphere by heating the precursor at a selected temperature in the substantially oxygen-free atmosphere for a selected period of time and as a selected substantially constant amount of tension is applied to the precursor, a pre-stabilised precursor having at least 10% cyclised nitrile groups can be formed, which is activated for subsequent reaction in an oxygen containing atmosphere. Upon exposure of the pre-stabilised precursor to the oxygen-containing atmosphere, a stabilised precursor can then be readily formed. Accordingly, the reactor of the present invention may be used to prepare a stabilised precursor, such as a stabilised precursor suitable for carbon fibre manufacture, with improved efficiency.

In particular, the reactor of the present invention may be used to prepare a stabilised precursor in a rapid manner.

The term “rapid” as used in relation to a process described herein is intended to indicate that the process is performed more quickly (i.e. in a shorter period of time) than a reference process that is designed to achieve the same result, but which does not include the pre-stabilisation step as a part of the process. Processes using the reactor of the present invention to perform the pre-stabilisation step can therefore provide a time saving, compared to the reference process. In addition, use of the reactor of the present invention can provide energy savings and equipment savings, compared to the reference process. As an example, a conventional reference stabilisation process may achieve a stabilised PAN precursor comprising a desired amount of cyclised nitrile groups in a time period of about 70 minutes. In comparison, some embodiments of the stabilisation process using the reactor of the present invention can enable a stabilised precursor comprising the same amount of cyclised nitrile groups to be formed in a time period of about 15 minutes. Thus the stabilisation process using the reactor of the invention can achieve a time saving of about 55 minutes (or about 78%) over the reference process.

Advantageously, the reactor of the present invention may be used to form a pre-stabilised precursor having at least 10% cyclised nitrile groups by heating a precursor comprising polyacrylonitrile in a substantially oxygen-free atmosphere. Without wishing to be limited by theory, it is believed that by forming at least 10% cyclised nitrile groups in the pre-stabilised precursor, downstream advantages can be conferred to oxidative precursor stabilisation, as well as carbonisation of the oxidatively stabilised precursor to form carbon-based materials (such as carbon fibre) of acceptable quality, including high performance quality. In particular, it is believed that a pre-stabilised precursor having at least 10% cyclised nitrile groups can facilitate faster, safer, and lower cost precursor stabilisation and carbon-based material formation (e.g. carbon fibre). It is further believed that when less than 10% nitrile group cyclisation is obtained in the pre-stabilised precursor, benefits provided, such as high speed formation of a suitably stabilised precursor that can be converted into a carbon-based material, improved safety in precursor stabilisation and reduction in energy consumption, are not achieved.

Stabilised precursors, which are formed in accordance with the stabilisation process described herein, are thermally stable. By being “thermally stable” is meant that the stabilised precursor is resistant to combustion or degradation when exposed to a naked flame and can suitably be carbonised to form a carbon-based material, such as carbon fibre.

Stabilised precursors formed by the stabilisation process described herein may also be referred to herein as “fully stabilised precursors”. This compares to the pre-stabilised precursors described herein, which are partially stabilised precursors.

In some embodiments, the present invention provides an apparatus for stabilising a precursor for a carbon fibre, the apparatus comprising:
a reactor according to the present invention for producing a pre-stabilised precursor; and
an oxidation reactor downstream from the reactor, the oxidation reactor comprising
at least one oxidation chamber adapted to stabilise the pre-stabilised precursor in an oxygen-containing atmosphere as the pre-stabilised precursor is passed through the oxidation chamber(s). This apparatus can be used for preparing a stabilised precursor, said use comprising:
heating a precursor comprising polyacrylonitrile in a substantially oxygen-free atmosphere while applying a substantially constant amount of tension to the precursor to promote cyclisation of nitrile groups in the precursor, the temperature and time period in which the precursor is heated in the substantially oxygen-free atmosphere and the amount of tension applied to the precursor each being selected to form a pre-stabilised precursor having at least 10% cyclised nitrile groups as determined by Fourier transform infrared (FT-IR) spectroscopy; and
exposing the pre-stabilised precursor to an oxygen containing atmosphere to form a stabilised precursor.

In some embodiments, the apparatus can be used for preparing a stabilised precursor for a carbon fibre. In some embodiments, the apparatus can be used for preparing a stabilised precursor suitable for the manufacture of carbon-based material, such as carbon fibre, with improved efficiency by subjecting a precursor to initial pre-stabilisation in the reactor and forming a pre-stabilised precursor having at least 10% cyclised nitrile groups as described herein.

The reactor of the present invention may be used to facilitate rapid formation of a stabilised precursor and aid in accelerating the precursor stabilisation step used in carbon fibre manufacture. Moreover, the reactor described herein may be used help to reduce costs associated with the precursor stabilisation step, as well as help to improve the safety of precursor stabilisation.

As noted above, the reactor, apparatus and system of the present invention can be useful for the stabilisation of precursors comprising polyacrylonitrile (PAN). A precursor comprising PAN is also referred to herein as a “polyacrylonitrile precursor” or “PAN precursor”.

PAN precursors referred to herein include precursors comprising homopolymers of acrylonitrile as well as copolymers and terpolymers of acrylonitrile with one or more co-monomers.

Thus the term “polyacrylonitrile” as used herein includes homopolymers and copolymers formed through at least the polymerisation of acrylonitrile. Such polymers are generally linear and will have nitrile groups pendant from a carbon-based polymer backbone.

As will be discussed further below, cyclisation of the pendant nitrile groups will play an important part in the advantageous use of the reactor of the present invention.

Precursors used may comprise polyacrylonitrile having at least about 85% by weight acrylonitrile units. In some embodiments, the precursor used may comprise polyacrylonitrile having less than 85% by weight acrylonitrile units. Such polymers can include modacrylic polymers, generally defined as polymers comprising 35-85% by weight acrylonitrile units and typically copolymerized with vinyl chloride or vinylidene chloride.

Polyacrylonitrile (PAN) is a suitable polymer for inclusion in a precursor for producing carbon-based materials such as carbon fibre due to its physical and molecular properties and its ability to provide a high carbon yield.

In one set of embodiments, the precursor employed may comprise a polyacrylonitrile homopolymer, a polyacrylonitrile copolymer, or mixtures thereof.

A person skilled in the relevant art would understand that a polyacrylonitrile homopolymer is a polymer composed of polymerised units derived only from acrylonitrile.

Polyacrylonitrile copolymers are copolymers of acrylonitrile with at least one co-monomer. Examples of co-monomers include acids such as itaconic acid and acrylic acid, ethylenically unsaturated esters such as vinyl acetate, methyl acrylate and methyl methacrylate, ethylenically unsaturated amides such as acrylamide and methacrylamide, ethylenically unsaturated halides such as vinyl chloride and sulfonic acids such as vinyl sulfonate and p-styrene sulfonate. Polyacrylonitrile copolymers may comprise from 1 to 15% by weight, or from 1 to 10% by weight, of one or more co-monomers. The precursor may comprise two or more different types of PAN copolymer.

Polyacrylonitrile in the precursor may have a molecular weight of at least 200 kDa.

Chemical mechanisms involved in stabilisation of polyacrylonitrile precursors in preparation for carbonisation are not well understood. However, it is believed that cyclisation of pendant nitrile groups on acrylonitrile units in a polyacrylonitrile polymer can play an important role in forming a sufficiently stabilised precursor that is able to withstand the high temperature conditions employed for carbonisation.

Cyclisation of pendant nitrile groups in a polyacrylonitrile polymer generate hexagonal carbon-nitrogen rings as illustrated below:

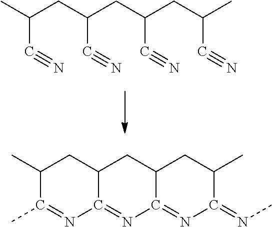

Heat and gases (such as HCN gas) are typically generated as a result of nitrile group cyclisation.

In one set of embodiments, the precursor may be a polyacrylonitrile copolymer of acrylonitrile with at least one acidic co-monomer. Examples of acidic co-monomers include acids such as itaconic acid and acrylic acid. The polyacrylonitrile copolymer may comprise from 1 to 15% by weight, or from 1 to 10% by weight of polymerised units derived from at least one acidic co-monomer.

In some embodiments it is preferable to utilise a precursor comprising a polyacrylonitrile copolymer of acrylonitrile with at least one acidic co-monomer as a feedstock for the stabilisation process (including a pre-stabilisation step using the reactor of the invention). It is believed that polymerised units derived from an acidic co-monomer can become deprotonated, thereby catalysing nitrile group cyclisation in the precursor. Thus the initiation of nitrile group cyclisation can occur at lower temperature. The inclusion in the polyacrylonitrile of polymerised units derived from an acidic co-monomer may also assist in controlling the exotherm generated by nitrile group cyclisation.

In a precursor comprising a polyacrylonitrile copolymer of acrylonitrile and at least one acidic co-monomer, cyclic groups formed during stabilisation of the precursor may have structures as illustrated below:

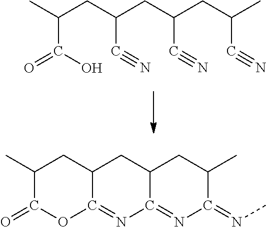

In one set of embodiments, the precursor employed when using the reactor of the invention may comprise polyacrylonitrile mixed or blended with an additional substance.

In some embodiments, the additional substance may be a further polymer. In such embodiments, a blend or mixture preferably comprises at least 50% by weight of polyacrylonitrile (PAN), and the PAN is in admixture with at least one further polymer.

In embodiments where the precursor comprises polyacrylonitrile blended or mixed with at least one further polymer, the weight ratio of PAN: further polymer in the precursor may be selected from 55:45, 60:40, 70:30, 80:20, 85:15, 90:10 and 95:5.

Polyacrylonitrile in a blend or mixture may be a polyacrylonitrile homopolymer or polyacrylonitrile copolymer, as described herein.

A polyacrylonitrile copolymer may comprise at least 85% by weight, or at least 90% by weight, of polymerised units derived from acrylonitrile. The remaining portion of polymerised units in the polyacrylonitrile copolymer is derived from one or more co-monomer, such as acidic co-monomers.

In some embodiments of mixtures and blends referred to herein, the further polymer may be selected from polymers known for use in the manufacture of carbon fibre manufacture. In some embodiments, the further polymer may be selected from the group consisting of petroleum pitch, thermoplastic polymers, cellulose, rayon, lignin and mixtures thereof. Thermoplastic polymers may include, but are not limited to, polyethylene (PE), poly(ethylene terephthalate) (PET), poly(butylene terephthalate) (PBT), polypropylene (PP), poly(vinyl chloride) (PVC), poly(vinylidene fluoride) (PVDF), polycarbonate (PC), poly(phenylene oxide) (PPO) and poly(styrene) (PS).

In some embodiments, the precursor may comprise polyacrylonitrile mixed or blended with a filler, such as a nano-filler. Exemplary nano-fillers may be carbon nanoparticles, such as carbon nanotubes or graphene nanoparticles.

In some embodiments the precursor may be surface treated. For example, the precursor may comprise an optional surface coating (i.e. sizing or spin finish). The presence of a surface treatment does not detract from benefits of pre-stabilisation using the reactor of the invention.

The precursor employed in the process performed using the reactor of the invention may be in a range of forms, including but not limited to fibre, yarn, web, film, fabric, weave, felt and mat forms. Mats may be woven or non-woven mats.

The precursor is preferably in the form of a continuous length of material, such as continuous length of fibre. Precursor fibres may comprise bundles of filaments.

The precursor may also have different cross-sectional morphologies, including for example, round, oval, bean-shaped, dog-bone shaped, petal-shaped or other shaped cross sections. Precursors may be hollow, with one or more internal voids. Internal voids may be continuous or discontinuous.

In one set of embodiments, the precursor is in the form of a fibre, preferably a continuous fibre. A number of PAN precursor fibres are known and are commercially available. The process that can be performed in the reactor of the present invention may be utilised to stabilise a variety of PAN precursors, both from commercial and non-commercial sources.

The PAN precursor fibres may be provided in one or more tows, each tow having fibres comprising a multitude of continuous filaments. Tows comprising the PAN precursor may be in variety of sizes, where size is dependent upon the number of filaments per tow. For example, tows may comprise from between 100 to 1,000,000 filaments per tow. This corresponds to a tow size of from about 0.1 K to about 1,000 K. In some embodiments, tows may comprise from 100 to 320,000 filaments per tow, which corresponds to a tow size of from about 0.1 K to about 320 K.

Filaments forming a PAN precursor fibre can have a range of diameters. For example, diameters may range from between about 1 to 100 microns, or between about 1 to 30 microns, or between about 1 to 20 microns. However, the magnitude of such diameter is not critical to the process described herein.

The stabilisation process using the reactor of the present invention involves two precursor treatment stages: pre-stabilisation using the reactor and oxidation using an oxidation reactor, in order to form a stabilised precursor. These two stages are discussed further below.

For convenience, in the description of the present invention below, a reference to a precursor is meant a precursor in fibre form. It is envisaged that the invention will have particular utility in the pre-stabilisation of a precursor that may be useful for the manufacture of carbon-fibre and this embodiment will be discussed in detail. However, this should not be taken as meaning that the invention is limited to that context of use. It will be appreciated that other forms of precursor, such as the yarn, web and mat forms described above, can be pre-stabilised using the reactor of the present invention.

It will be further appreciated that the capacity of the reaction chamber and size of the inlet and outlet may limit the size and shape of precursor that can be treated by a reactor. Typically, the reactor will be designed with a particular feedstock in mind. However, there can be limits on the dimensions of precursors that may be treated. For example, as will be explained in further detail below, the precursor is conveyed through the reaction chamber using rollers that are external to the reaction chamber, and there are limits to the distance that precursor can span between the rollers while being suitably conveyed through the chamber. Thus, the maximum roller separation distance can impose a limitation on the maximum reaction chamber length.

Often, the roller preceding the reactor inlet is a free-running pass-back roller.

As the width of the precursor to be fed into the reactor increases, it will be appreciated that the length of the roller will increase. As the length of the roller increases it has a greater tendency to bend or flex. Accordingly, as roller length increases, the diameter of the roller is often also increased to increase roller stiffness.

In some embodiments of a commercial scale reactor, the length of the roller may be about 2 to 4 metres long, for example about 3 metres. Typically, the roller length will be less than 6.5 metres. The roller diameter may be about 200 to 400 mm. For example, the roller diameter may be about 250 to 350 mm. For example the diameter may be about 300 mm.

Smaller scale reactors may be used in research and, in some of these embodiments, the length of the roller may be may be about 300 to 500 mm long, for example about 400 mm. The roller diameter may be about 200 mm to 250 mm. For example the diameter may be about 200 mm.

In some embodiments, the rollers may have a plain smooth surface, while in other embodiments the rollers may have a grooved surface. In embodiments were the rollers have a grooved surface, each groove may be configured to receive a tow of precursor. Accordingly, in some embodiments, the number of grooves may be equal to the number of tows of precursor being transported through the reactor.

In some embodiments, the rollers may be heated or cooled.

In some embodiments, combinations of different roller types may be used.

In order to form a stabilised precursor, the process for using the reactor described herein involves a step of heating a precursor fibre in a substantially oxygen-free atmosphere while a predetermined amount of tension is applied to the precursor. A pre-stabilised precursor fibre is thereby produced as a result of this step. This step of the precursor stabilisation process may also be referred to herein as a “pre-stabilisation” or “pre-stabilising” step. The pre-stabilisation step therefore converts a PAN precursor into a pre-stabilised precursor.

The terms “pre-stabilisation” and “pre-stabilising” used herein in relation to a step of the stabilisation process described herein indicates that the step is a preparative step, which takes place prior to full stabilisation of the precursor in an oxidation step described below. The pre-stabilisation step may therefore be regarded as a pre-treatment step or pre-oxidation step, which subjects the precursor to a preliminary treatment prior to full stabilisation of the precursor in the oxidation step. Thus the reactor of the invention can be used to perform a step of pre-treating the precursor to help prepare the precursor for oxidative stabilisation in the oxygen containing atmosphere discussed below. The term “pre-stabilised precursor” therefore indicates a precursor that has undergone the “pre-stabilisation” treatment described herein.

The pre-stabilisation step described herein can advantageously facilitate rapid and efficient conversion of a precursor into a stabilised precursor by enabling initial formation of a partially stabilised precursor that is activated for oxidative stabilisation. Rapid formation of a stabilised precursor can confer downstream advantages when the stabilised precursor is carbonised to form a carbon-based material such as carbon fibre, as discussed below. The downstream benefits may be particularly advantageous in a continuous process for manufacturing a material such as carbon fibre. Accordingly, the reactor of the present invention may be configured to continuously pre-stabilise a precursor.

The reaction chamber of the reactor is adapted to pre-stabilise the precursor in a substantially oxygen-free atmosphere as the precursor is passed through the reaction chamber under a predetermined tension. The precursor will enter the reactor via an inlet before, typically passing through an inlet vestibule and then entering the reaction chamber. After passing through the reaction chamber, the precursor will typically pass through an outlet vestibule, before exiting via the outlet.

References herein to a “vestibule” of the reactor can be understood as referring to an intermediate region, through which the precursor passes, between the reaction chamber and either or each of the inlet and outlet of the reactor. Various components and parts of the reactor may be located within the vestibule, as described herein.

In some embodiments, the inlet and/or outlet of the reactor may comprise adjustable choke(s) and/or baffle(s). For example, an adjustable choke may be provided at the inlet and/or outlet. In addition, an adjustable choke may be provided within the inlet vestibule and/or outlet vestibule, such as at a position between the inlet (or outlet) and the point at which process gas is introduced into the reactor. It has been found that having the smallest possible workable gap for the precursor to pass through can assist in reducing the ingress of oxygen into the reactor. Furthermore, it has been found that having the smallest possible workable gap for the precursor to pass through can assist in reducing heat losses from the reactor.

A suitable choke mechanism may comprise one or two sliding plates that can be adjusted to alter the size and/or position of the opening between them.

Preferably, the choke comprises two sliding plates with each plate sliding independently of the other such that the position of the opening formed between the two plates (to permit passage of the precursor) may be altered between an upper position and a lower position (including intermediate positions therebetween). This embodiment may enable the position of the opening of each of the inlet and outlet to be adjusted to take account of catenary of the precursor.

The temperature and time in which the precursor is heated in the substantially oxygen-free atmosphere and the tension applied to the precursor during the heat treatment are each selected to facilitate nitrile group cyclisation in the PAN precursor. The heating of the PAN precursor fibre in the substantially oxygen-free atmosphere may proceed for a desired amount of time and at a desired temperature. In addition, the reactor is adapted to having the precursor pass through the reaction chamber under a predetermined tension. Suitable tensioning devices for applying a predetermined tension can be provided upstream and downstream of the reaction chamber. In some embodiments, the reactor comprises tensioning devices adapted to pass the precursor through the reaction chamber under a predetermined tension.

The reactor of the present invention comprises a gas delivery system for delivering substantially oxygen-free gas to the reaction chamber, the gas delivery system including a forced gas flow assembly for providing a flow of heated substantially oxygen-free gas in the reaction chamber to heat the precursor in the substantially oxygen-free atmosphere.

In some embodiments, the forced gas flow assembly may be configured to provide a recirculating flow of heated substantially oxygen-free gas in the reaction chamber to heat the precursor in the substantially oxygen-free atmosphere.

The flow of heated substantially oxygen-free gas is used to bring the precursor up to reaction temperature. The substantially oxygen-free gas may also be referred to herein as a “process gas”.

The gas delivery system of the reactor of the present invention comprises at least one process gas supply inlet for supplying fresh process gas to the reactor from the source of substantially oxygen-free gas. The substantially oxygen-free gas may be pre-heated so that it is emitted from the inlet at a desired temperature. In some embodiments, that may be the desired pre-stabilisation process temperature. In some embodiments, the reactor may comprise a heater for heating the process gas before it is emitted from the process gas supply inlet. Suitable process gas supply inlets may include supply inlets typically used for conventional oxidation ovens for stabilising precursors. In typical use, such inlets are not required to provide a flow that can be balanced with gas supply and extraction from an oxidation oven so as to seal the oxidation chamber to provide the substantially oxygen-free atmosphere therein, as such an atmosphere is not required for oxidation ovens. However, when such gas supply inlets are used in the reactor of the present invention the flow of fresh process gas provided will be balanced with other gas supply to the reactor and the extraction of exhaust gases so that the gas seal assembly seals the reaction chamber to provide the substantially oxygen-free atmosphere therein and limits incidental gas flow out of the reactor through the inlet and the outlet. In some embodiments, the process gas is emitted from the process gas supply inlet at a gas velocity of 0.1 to 1.5 m/s, for example the velocity may be 0.5 to 0.75 m/s.

The or each gas supply inlet may comprise one or more process gas delivery nozzles. Suitable nozzles may be configured to direct and/or distribute process gas above and below the precursor as it passes through the reactor across the full width of the precursor. It is particular preferred for nozzles to be configured to direct and/or distribute process gas equally above and below the precursor as it passes through the reactor, and evenly across the full width of the precursor. In some embodiments, the or each process gas delivery nozzle may include upper and lower output tubes located so as to be positioned above and below the precursor as it passes through the reactor. Each output tube will include one or more apertures for providing a jet or stream of process gas. In some embodiments, each output tube may have a slot shaped aperture for directing gas towards the precursor. In some embodiments, the or each process gas delivery nozzle may comprise upper and lower output tubes located so as to be positioned above and below the precursor, with each output tube having a slot shaped aperture for directing process gas towards a distributor for directing and distributing the flow of gas across the width of the precursor. In these embodiments, the slot-shaped aperture may be at least as long as the width of the precursor.

The term “nozzle”, as used herein, need not require a taper or constriction for changing air velocity.

In some embodiments, the process gas delivery nozzles include plenum plates or arrays of nozzle tubes adapted to providing a curtain of process gas. Embodiments of nozzles including plenum plates or arrays of nozzle tubes are described further below with reference to a sealing gas delivery nozzle, but it will be understood that such nozzle configurations can also be suitable for the process gas delivery nozzle.

During pre-stabilisation, exothermic energy is released as nitrile groups in the PAN precursor fibre undergo cyclisation. If unmanaged, the amount of exothermic energy released can cause the temperature of the precursor to increase significantly, damaging the precursor. Degradation to the precursor may lead to evolution of toxic gases and produce a potentially explosive gas mixture. To avoid exothermic runaway, the temperature and flow rate of the heated substantially oxygen-free gas is selected to maintain the temperature of the precursor within acceptable limits. Accordingly, the forced gas flow is used to control the temperature of the precursor as it passes through the reaction chamber. A skilled person would appreciate that when the released exothermic energy results in the precursor reaching a temperature that is higher than the temperature of the process gas, then the flow of substantially oxygen-free process gas can act to cool and control the temperature of the precursor to the desired temperature.

It can be advantageous to subject the precursor to a high temperature for a brief period of time when in the substantially oxygen-free atmosphere in order to trigger nitrile group cyclisation in the precursor.

In some embodiments the temperature selected for the substantially oxygen-free atmosphere is high enough to trigger or initiate nitrile group cyclisation in the PAN precursor yet is not so high that the physical integrity of the precursor is compromised (e.g. the precursor fibre melts, breaks or degrades). For instance, it is desirable that the PAN precursor be heated at a temperature that is not greater than the degradation temperature of the precursor. Meanwhile, as a minimum, the PAN precursor should be heated when in the substantially oxygen-free atmosphere at a temperature that is sufficient to initiate nitrile group cyclisation in the precursor in the desired processing time period.

In some embodiments, during the pre-stabilisation step, the PAN precursor is heated in the substantially oxygen-free atmosphere at a temperature that is sufficient to initiate nitrile group cyclisation without causing degradation of the precursor.

In some embodiments, the temperature at which the precursor is heated in the substantially oxygen-free atmosphere can also influence the extent of nitrile group cyclisation, as it has been found that higher heating temperatures can promote and increase nitrile group cyclisation in the precursor.

Thus in some embodiments it is preferable that the temperature at which the precursor is heated when in the substantially oxygen-free atmosphere is in proximity to the degradation temperature of the precursor. A high temperature in proximity of the degradation temperature of the precursor can help to ensure that a high content of cyclised nitrile groups is achieved in a short period of time.

PAN precursors are generally reported in the literature to have a degradation temperature of from about 300 to 320° C. However, a skilled person would appreciate that precursor degradation temperature may differ from reported literature values as it could be dependent on the composition of the PAN precursor.

Should one skilled in the art wish to determine the degradation temperature of a given PAN precursor, this may be ascertained using differential scanning calorimetry (DSC) under a nitrogen atmosphere. Using DSC, a sample of a given precursor may be placed in a nitrogen atmosphere and heated at rate of 10° C./minute. Changes in heat flux with temperature is then measured. Thermal degradation of the precursor can be detected by observing an exothermic transition in the DSC curve. The temperature corresponding to the peak (or maximum) of the exothermic transition is thus the degradation temperature of the precursor.

In some embodiments, the precursor is heated in the substantially oxygen-free atmosphere at a temperature that is not more than 30° C. below the precursor degradation temperature. This will be understood to mean that the precursor cannot be heated at a temperature that exceeds the degradation temperature of the precursor and furthermore, cannot be more than 30° C. below the degradation temperature. Accordingly, in such embodiments, the PAN precursor can be heated in the substantially oxygen-free atmosphere at a temperature (T) that is selected to be in a range represented by the following: (T_{D}−30° C.)≤T<T_{D}, where T_{D} is the degradation temperature (in ° C.) of the precursor.

In another set of embodiments, the precursor is heated in the substantially oxygen-free atmosphere at a maximum temperature that is at least 5° C. below the degradation temperature of the precursor, and not more than 30° C. below the degradation temperature. This will be understood to mean that the precursor is heated in the substantially oxygen-free atmosphere at a temperature (T) that is selected to be in a range represented by the following: (T_{D}−30° C.)≤T≤(T_{D}−5° C.), where T_{D} is the degradation temperature (in ° C.) of the precursor.

In one set of embodiments, the precursor fibre is heated in a substantially oxygen-free atmosphere at a maximum temperature that is no more than about 400° C., preferably no more than about 380° C., more preferably no more than about 320° C.

In one set of embodiments, the precursor fibre is heated in a substantially oxygen-free atmosphere at a minimum temperature that is no less than about 250° C., preferably no less than about 270° C., more preferably no less than about 280° C.

Typically, the gas flow rate will be such that the temperature measured adjacent to the precursor is within 40° C. of the temperature of the process gas, preferably within 30° C. of the temperature of the process gas. As used herein, “adjacent to the precursor” means within 10 mm of the precursor, preferably within 3 mm of the precursor, more preferably within 1 mm of the precursor. In some embodiments, the gas flow rate may be such that the actual precursor temperature is within 50° C. of the temperature of the process gas, preferably within 40° C. of the temperature of the gas, more preferably within 30° C. of the temperature of the gas.

The desired gas flow rate may be determined by how close the process gas temperature is to the degradation temperature of the precursor. For example, in some embodiments, the precursor is heated in the substantially oxygen-free atmosphere at a temperature that is not more than 30° C. below the degradation temperature of the precursor. In such embodiments, the gas flow rate will be such that the temperature measured adjacent to the precursor is within 30° C. of the temperature of the process gas and below the degradation temperature of the precursor. In general, it is desirable for the gas flow rate to be such that the temperature measured adjacent to the precursor is below degradation temperature of the precursor. Furthermore, it is desirable for the gas flow rate to be such that the actual precursor temperature is below degradation temperature of the precursor.

The temperature of the process gas is the temperature of the gas flow measured at least 30 mm away from the precursor, preferably at least 40 mm away from the precursor, more preferably at least 50 mm away from the precursor.

The temperature of the process gas may be monitored using thermocouples suitably positioned in the reaction chamber. That is, the reactor may comprise suitably positioned thermocouples. In some embodiments, the reactor comprises thermocouples proximal each end of each reaction zone. In some embodiments, the or each thermocouple may be configured to permit continuous monitoring of the process gas temperature.

In some embodiments, the reactor is configured to permit a thermocouple to be periodically positioned adjacent to the precursor to enable the temperature adjacent to the precursor to be measured. In some embodiments, the reactor may include an infra-red temperature sensor suitable for monitoring the actual surface temperature of the precursor as it passes through the reaction chamber.

The flow rate of the forced gas will be controlled so that it is not too high. The flow rate of the forced gas will not be so high that the precursor is excessively agitated as this can lead to fibre damage, including fibre breakage. Furthermore, an excessive flow rate can over-pressurise the reactor such that the performance of the gas seal provided by the gas seal assembly is impaired. For example, over-pressurizing may result in unacceptable levels of incidental gas flow out of the reactor through the inlet and the outlet.

In one embodiment, the flow rate of the forced gas will be high enough that there will be localised turbulent gas flow around the precursor. This localised turbulent flow in the vicinity of the precursor will induce some fibre agitation and shaking that facilitates effective removal of the reaction by-products, as well as aiding in the management of the exothermic behaviour of the precursor. Agitation of the fibres in the gas flow can facilitate heat transfer from the precursor to the flow of process gas so as to ensure that the temperature of the fibre remains within an acceptable limit.

It will be appreciated that this localised turbulent gas flow is a turbulent boundary layer. The thickness of this boundary layer may be less than the height of the reaction chamber such that, except for the localised turbulent gas flow in the vicinity of the precursor, the bulk of the gas flow through the reaction chamber is substantially laminar. Such embodiments may include reactors where the reaction chamber height is large relative to the length of the reaction chamber. Reaction chambers with large height to length ratio may have smaller production capacities and may be part of reactors suited to research and development applications. It is nevertheless desirable to provide the process gas with a flow that it is as uniform as possible in order to control the temperature of the precursor evenly. Regions of low gas flow may lead to the formation of “hot spots” in the reaction chamber, and this may lead to localised overheating damaging the precursor. The gas flow uniformity may be such that there is only a 1% to 10% variation in gas flow velocity across each of the width, height, and length of the reaction chamber. The velocity of the process gas flow may be 0.5 to 4.5 m/s, for example it may be 2 to 4 m/s.

In some other embodiments, the thickness of this boundary layer compared to the height of the reaction chamber is such that the flow through the reaction chamber is predominantly turbulent. Such flow may be in reaction chambers with smaller height to length ratios. These reactors where the reaction chamber height is small relative to the length of the reaction chamber may have larger production capacities and may be part of reactors suited to commercial applications.

In one embodiment, it is desirable for the bulk of the gas flow through the reaction chamber to be substantially turbulent, to enhance heat transfer from the precursor to the forced gas flow. The greater region of turbulent flow can facilitate heat transfer from the precursor by convection. It remains desirable to provide the process gas with a flow that it is as uniform as possible in order to control the temperature of the precursor evenly. Regions of low gas flow may lead to the formation of “hot spots” in the reaction chamber, and this may lead to localised overheating damaging the precursor. The gas flow uniformity may be such that there is only a 1% to 10% variation in gas velocity across each of the width, height, and length of the reaction chamber. The velocity of the process gas flow may be 0.5 to 4.5 m/s, for example it may be 2 to 4 m/s. To ensure a suitably turbulent flow, the process gas flow should be such that the Reynolds number of the flow is above 100,000 when calculated at points further than 1.0 m from the main process gas inlet for the or each reaction zone along the direction of the gas flow.

In some embodiments, the reactor may comprise one or more gas velocity sensors, in the form of anemometers or manometers, for monitoring the velocity of the forced gas flow. So as to measure the gas flow velocity of the process gas, the gas velocity sensors may be located such that the velocity of the gas flow is measured at least 30 mm away from the precursor, preferably at least 40 mm away from the precursor, more preferably at least 50 mm away from the precursor.

In some embodiments, the reactor comprises gas velocity sensors proximal each end of each reaction zone. In some embodiments, the or each gas velocity sensor may be configured to permit continuous monitoring of the process gas velocity.

In embodiments where the reactor comprises one or more thermocouples, the one or more gas velocity sensors may each be co-located with a thermocouple.

Often, so as to provide the process gas with good flow uniformity as it flows through the reaction chamber, the forced gas flow assembly will be adapted to supply the process gas so that it flows largely parallel to the passage of the precursor through the reaction chamber. Accordingly, the force gas flow assembly may be configured so that, for each reaction zone of the reaction chamber, the forced process gas flows from one end of the zone to the other, with the direction of gas flow either being provided on a counter-flow basis or a co-flow basis to the passage of the precursor through the reaction zone. A forced gas flow in the reaction chamber may be directed from the centre of the reactor towards its ends, or from the ends of the reactor towards its centre, or from one end of the reactor towards its other end. For example, the forced gas flow assembly may be adapted to supply a centre-to-ends flow of process gas. Alternatively, the forced gas flow assembly may be adapted to supply an ends-to-centre flow of process gas.

Other arrangements for providing the process gas to the reaction chamber can include providing a cross-flow of the process gas, relative to the passage of the precursor. In these embodiments, the forced gas flow assembly may be adapted to provide a flow of gas travelling from one side of the chamber across to the other. Alternatively, the forced gas flow assembly may be adapted to provide process gas vertically. For example, the forced gas flow assembly may be adapted to provide a flow of process gas down from the top of the reaction chamber towards the floor, or vice versa. However, with these alternative arrangements it can be more difficult to achieve the desired uniformity in gas flow. For example, with a vertical flow of process gas, the air must pass through the precursor which may lead to a venturi effect as it passes between tows of the precursor. Accordingly, a forced gas flow assembly adapted to provide a centre-to-ends flow or ends-to-centre flow of process gas is typically preferred.

The forced gas flow assembly may comprise a fan or blower for providing the flow of substantially oxygen-free gas in the reaction chamber at the desired gas velocity. The fan or blower may be adjustable (e.g. by adjusting fan revolution rate) so that the velocity of the flow of substantially oxygen-free gas can be adjusted. In embodiments where the forced gas flow assembly is configured to recirculate substantially oxygen-free gas through the reaction chamber, the fan or blower may be disposed along a return line to recirculate substantially oxygen-free gas through the reaction chamber at the desired gas velocity.

Exothermic behaviour can vary between precursors. Accordingly, the temperature and gas flow within the reactor will be adapted to each precursor so as to suitably pre-stabilise the precursor and manage the exothermic behaviour of the precursor.

In some embodiments, the precursor fibre is heated in a substantially oxygen-free atmosphere with a process gas temperature in a range of from about 200 to 400° C. For example, from about 250 to 400° C., and in some embodiments preferably in a range of from about 280 to 320° C. The temperature of the process gas may be controlled so that the fluctuation in the temperature away from the desired process gas temperature is such that the process gas is either at the desired process gas temperature or below. In some embodiments, the temperature of the process gas may be controlled so that the temperature is kept to within 5° C. less than the desired process gas temperature.

In some particular embodiments, during the pre-stabilisation step, the precursor is heated in a substantially oxygen-free atmosphere at a process gas temperature that is sufficient to initiate nitrile group cyclisation in the precursor without degrading the precursor. In one preference, the process gas temperature is sufficient to promote nitrile group cyclisation of at least 10%.

In one set of embodiments, the process gas temperature is in a range selected from the group consisting of: 250 to 400° C., from about 260° C. to 380° C., from about 280° C. to 320° C., and from about 290° C. to 310° C. Heating at a temperature within such ranges may occur for a time period selected from the group consisting of no more than about 5 minutes, no more than about 4 minutes, no more than about 3 minutes or no more than about 2 minutes.

The above-mentioned temperatures represent environmental temperatures within the or each reaction chamber of the pre-stabilisation reactor. That is, they represent the temperature of the flow of heated substantially oxygen-free gas in the or each reaction chamber to heat the precursor in the substantially oxygen-free atmosphere. As described above the process gas temperature may be measured by a thermocouple or other appropriate temperature measurement device. The environmental temperature within the pre-stabilisation reactor is preferably maintained substantially constant during the pre-stabilisation step.

The precursor may be heated under a substantially constant temperature profile or a variable temperature profile. Under a variable temperature profile the precursor may be heated at two or more different temperatures. The two or more different temperatures are preferably within the temperature ranges described herein.

In some embodiments, heating of the PAN precursor fibre during the pre-stabilisation step may occur by passing the precursor fibre through a single temperature zone. In such embodiments, the forced gas flow is ideally such that a substantially uniform temperature is maintained throughout the reaction chamber.

In some other embodiments, the reaction chamber may include two or more reaction zones.

Accordingly, heating of the PAN precursor fibre during the pre-stabilisation step may occur by passing the precursor through a plurality of reaction zones. In such embodiments, the PAN precursor fibre may pass through two, three, four, or more reaction zones. Each of the zones may be of the same temperature and/or have the same gas flow rate conditions. Alternatively, different temperature and/or gas flow rate conditions may be applied in two or more zones. In some embodiments, there are different conditions in each zone.

For example, at least one temperature zone (e.g. first temperature zone) may be at a first temperature while at least one temperature zone (e.g. second temperature zone) is at a second temperature that is different to the first temperature. Thus, the PAN precursor fibre may be heated under a variable temperature profile by passing the precursor fibre through a plurality of zones of different temperature.

In one set of embodiments, the PAN precursor fibre may initially be heated at a selected temperature, and then the temperature may increase as the pre-stabilisation step proceeds. As an example, the PAN precursor fibre may initially be heated at a temperature of about 285° C., with temperature increasing to about 295° C. during the pre-stabilisation step.

Often, once a temperature or temperatures and heating profile for heating the precursor in the substantially oxygen-free atmosphere is selected, the temperature parameters remain fixed and are not varied. For example, in a continuous carbon material (e.g. carbon fibre) manufacturing process that incorporates reactor of the present invention, it can be desirable for each temperature parameter employed to remain constant and fixed at a selected value for process stability and to enable stable, continuous operation.

In some embodiments, to ensure that the pre-stabilisation reactions are stable and continuous, the temperature of the process gas in any one zone is controlled so that it varies no more than ±3° C. along the length of the zone. In some embodiments, the temperature in any one zone is controlled so that it varies no more than ±2° C., preferably no more than ±1° C. along the length of the zone. That is, the reactor may be configured to permit control of the temperature (and gas flow) of the process gas in any one reaction zone.

In some embodiments, so as to heat one or more reaction zones of the reactor, the reactor includes a heating system in addition to the forced gas flow assembly. The heating system may minimise temperature variations along the length of each reaction zone of the reaction chamber. The heating system may comprise one or more heating elements for externally heating reaction zone(s) of the reaction chamber. The heating elements externally heat the reaction zone(s) of the reaction chamber in that the heating elements do not projecting into the space through which the precursor passes and the forced process gas flows. In some embodiments, so as to distribute the heat from the heating elements along the reaction zone(s), the heating elements are positioned within a heating jacket containing a heat transfer medium. Typically, the heating jacket will be an insulated heating jacket. The heating jacket can be configured to retain the heat transfer medium within it in a heat transfer relationship with the walls of the reaction chamber.

The heat transfer medium may be circulated within the heating jacket to transfer heat from the heating elements to the reaction zone(s) of the reactor. Accordingly, in some embodiments, the heating system comprises at least one return line (e.g. at least one return duct) arranged to receive heat transfer medium from the heating jacket and return heat transfer medium to the heating jacket to recirculate heat transfer medium through the heating jacket. In some embodiments, the heating system includes one or more medium inlets for providing heat transfer medium to the heating jacket; one or more medium outlets; and one or more return lines; wherein the or each medium outlet is for directing heat transfer medium to a return line, and the return line is fluidly connected to at least one medium inlet to recirculate the heat transfer medium in the heating jacket. In some embodiments, the heat transfer medium is air. In some embodiments, a fan is disposed along the return line to transfer the heat transfer medium along the return line so that it can be recirculated.

In some embodiments, each zone may be provided with a separate heating system to enable the zones to be heated to different temperatures. In some other embodiments, a single heating system may be used to heat two or more reaction zones.

Still other heat transfer media and heating system configurations useful for the reactor of the present invention will be apparent to those skilled in the art in view of the present disclosure.

In some embodiments, the temperature of the gas in each zone may be the same, but the gas flow rate may be different.

In addition to controlling the temperature of the precursor, the forced gas flow can be used to transport unwanted reaction products away from the fibres. In particular, the pre-stabilisation process of a PAN precursor generates hydrogen cyanide (HCN) gas. Hydrogen cyanide is toxic and its generation poses an inhalation hazard if allowed to escape from the reactor through either or each of the inlet and outlet.

The forced gas flow will transport reaction products towards the gas seal assembly of the reactor. The gas seal assembly is for sealing the reaction chamber to provide the substantially oxygen-free atmosphere therein and for limiting incidental gas flow out of the reactor through the inlet and the outlet. Thus, the gas seal assembly limits the emission of fugitive gases, including HCN gas, from the reactor. The gas seal assembly typically includes an exhaust sub-assembly for removing exhaust gases from the reactor. The exhaust gases may flow to a hazardous gas abatement system of the exhaust sub-assembly for decontaminating the exhaust gas stream.

It will be appreciated that, so as to seal the reaction chamber to provide the substantially oxygen-free atmosphere therein, the gas supplied to form the gas seal will be a substantially oxygen-free gas. In some embodiments, the gas seal assembly comprises: a gas curtain sub-assembly for providing a sealing gas curtain between the reaction chamber and each of the inlet and outlet; and an exhaust sub-assembly for extracting exhaust gases. The gas of the sealing gas curtain may have the same composition as the process gas or may be another suitable substantially oxygen-free gas. Often the sealing gas and the process gas will have the same composition and may be provided by the same gas source.

The sealing gas may be pre-heated so that it is emitted from the gas curtain sub-assembly to form a gas curtain at a desired temperature. The desired temperature may such that the gas curtain warms the precursor before it enters the reaction chamber, or cool the precursor as it exits the reaction chamber, to a suitable temperature. In some embodiments, the reactor may comprise a heater for heating the sealing gas before it is emitted from the gas curtain sub-assembly to form a gas curtain.

The hazardous gas abatement system of embodiments of the exhaust sub-assembly may include a burner for combusting the exhaust gases so as to destroy reaction by-products and produce hot combustion gasses. In some of those embodiments, the gas delivery system comprises a supply line fluidly connected to the source of substantially oxygen-free gas for supplying substantially oxygen-free gas; and the hazardous gas abatement system comprises a heat exchanger for transferring heat from the hot combustion gasses to the substantially oxygen-free gas supplied by the supply line so as to warm the substantially oxygen-free gas and cool the combustion gasses.

In some embodiments, there may be two or more supply lines. In some embodiments, a supply line may be for supplying gas to a process gas supply inlet. In some embodiments, a supply line may be for supplying gas to the gas curtain sub-assembly.

The heat exchanger of the hazardous gas abatement system may be configured to transfer heat from the hot combustion gasses to one or more of the supply lines to so as to warm the substantially oxygen-free gas supplied by said one or more supply lines and cool the combustion gasses. In some embodiments, the heat exchanger of the hazardous gas abatement system is configured to transfer heat from the hot combustion gasses to at least two of the supply lines to so as to warm the substantially oxygen-free gas supplied by said at least two supply lines and cool the combustion gasses. In some of those embodiments, the heat exchanger of the hazardous gas abatement system is configured to transfer different amounts of heat to each of the supply lines so as to warm the substantially oxygen-free gas supplied by each supply line to a different temperature. In some embodiments, the heat exchanger of the hazardous gas abatement system is configured to transfer more heat to the supply line for supplying gas to a process gas supply inlet than the supply line for supplying gas to the gas curtain sub-assembly so as to warm the substantially oxygen-free gas supplied to a process gas supply inlet more than the gas supplied to the gas curtain sub-assembly.

In some embodiments, the two or more supply lines may be secondary supply lines branched from a primary supply line fluidly connected to the source of substantially oxygen-free gas.

Typically, there will be a vestibule between the reaction chamber and the inlet. In addition, there will typically be a vestibule between the reaction chamber and the outlet. In some embodiments, there may be a single vestibule for the outlet and inlet. In other embodiments, there may be a separate vestibule for each of the inlet and outlet. The length of the vestibule between the reaction chamber and the outlet, irrespective of whether the vestibule is also for the inlet, can be selected so as to ensure that the precursor cools adequately prior to passing through the outlet. Typically, the precursor will be cooled such that it is below the reaction temperature prior to exiting the reactor so as to ensure that the precursor does not continue to react and, as such, evolve HCN once it is outside the reactor as this would pose a safety risk.

In general, the pre-stabilised precursor will be cooled to a temperature below the temperature at which the precursor is to be further treated in an oxygen-containing atmosphere in an oxidation reactor to form a stabilised precursor. This may be particularly desirable to limit the fire risk that may arise in circumstances where a pre-stabilised precursor is at a temperature that is higher than that of the oxygen containing atmosphere in the oxidation reactor In addition, as the air of the atmosphere surrounding the pre-stabilisation reactor constitutes an oxygen-containing atmosphere, the pre-stabilised precursor may be cooled to below the temperature for the oxidation reaction, otherwise the oxidation reaction will commence at an unacceptably high rate as soon as the pre-stabilised precursor leaves the substantially oxygen-free atmosphere within the pre-stabilisation reactor.

Similarly to the pre-stabilisation reaction, the oxidation step generates hydrogen cyanide (HCN) gas. Accordingly, it is desirable to cool the pre-stabilised precursor to slow the rate of reaction so that any HCN generation is reduced to an acceptable level. In practice, the acceptable level of HCN generation will be determined by the residence time of the pre-stabilised precursor in the atmosphere outside of the pre-stabilisation reactor. Thus, in some embodiments, as the pre-stabilised precursor will be rapidly transferred to an oxidation reactor, it may be acceptable to allow the pre-stabilised precursor to exit the pre-stabilisation reactor at a higher temperature than would be acceptable if the pre-stabilised precursor has a longer residence time in the atmosphere surrounding the pre-stabilisation reactor.

In embodiments where the pre-stabilisation reactor is used as part of a continuous process, the acceptable level of HCN generation outside the reactor will be evaluated on the basis of an acceptable level of continuous HCN generation.

In some embodiments, it is desirable to cool the precursor such that it is below the reaction temperature prior to exiting the reactor, but also to keep the precursor as warm as possible to minimise the heating required in the oxidation reactor to bring the precursor to the temperature for oxidation. This may enable efficient energy usage by avoiding unnecessary heating and cooling during the production of a stabilised precursor.

In some embodiments, the pre-stabilised precursor is cooled to a temperature at least below the temperature of initiation of exotherm observed using differential scanning calorimetry (DSC) under a oxygen atmosphere as this temperature corresponds to the initiation of the cyclization reaction in an oxygen-containing atmosphere.

In some embodiments, the pre-stabilised precursor may be cooled to a temperature selected from the group consisting of less than 240° C., less than 220° C., less than 140° C., and less than 100° C.

A temperature of less than 240° C. for the pre-stabilised precursor may be desirable for safety reasons, to at least limit or avoid a fire risk.

A temperature of less than 140° C. may be desirable to ensure the pre-stabilised precursor is below the exotherm of the pre-stabilised precursor as determined by differential scanning calorimetry (DSC). This can help to ensure that the pre-stabilised precursor does not undesirably react to a substantial extent before it enters the oxidation reactor.

A temperature of less than 100° C. for the pre-stabilised precursor may be desirable enable handling of the pre-stabilised precursor.

In embodiments in which the reactor comprises an inlet vestibule and an outlet vestibule, the length of the outlet vestibule may be longer than the length of the inlet vestibule so as to increase the residence time within the outlet vestibule and ensure that the precursor is suitably cooled prior to passing through the outlet.

In some embodiments, the reactor comprises a cooling section between the reaction chamber and the outlet for cooling the precursor. In some embodiments, the reactor is configured between the reaction chamber and the outlet to passively cool the precursor before the precursor exits the reactor. For example, a passive cooling section may cool a pre-stabilised precursor to a desired temperature by passing the pre-stabilised precursor though a void or space of a volume that facilitates the transfer of heat from the pre-stabilised precursor. Accordingly, in some embodiments, the reactor may comprise a cooling sub-chamber between the reaction chamber and the outlet, and the cooling sub-chamber may be configured to passively cool the precursor. In some embodiments, the outlet vestibule may be configured to passively cool the precursor.

In some embodiments, the reactor is configured between the reaction chamber and the outlet to actively cool the precursor before the precursor exits the reactor. In some embodiments, the reactor comprises a cooling section between the reaction chamber and the outlet for actively cooling the precursor.

In some embodiments, the cooling section includes a cooler for cooling the internal surfaces of the cooling section. The cooled internal surfaces of the cooler will in turn cool the atmosphere within the cooling section and this cooled atmosphere is used to cool the precursor. The cooler may use a coolant for cooling the internal surfaces of the cooling section. In some embodiments, the walls of the cooling section may comprise conduits for the coolant. In other embodiments, the coolant may be circulated within a cooling jacket to transfer heat from the walls of the section to the coolant. Typically, the cooling jacket will be an insulated cooling jacket. The cooling jacket can be configured to retain the coolant within it in a heat transfer relationship with the walls of the cooling section so as to cool the internal surfaces of the cooling section. In some embodiments, the coolant is water. Still other coolants and cooler configurations useful in the reactor of the present invention will be apparent to those skilled in the art in view of the present disclosure.

In some embodiments of the cooling section for actively cooling the precursor, a cooling gas may be used to cool the pre-stabilised precursor. For example, a flow of cool substantially oxygen-free gas, such as nitrogen gas, may be used to cool the pre-stabilised precursor. In such embodiments, active cooling of the pre-stabilised precursor may comprise flowing a substantially oxygen-free gas of an appropriate temperature over or around the pre-stabilised precursor at a flow rate or volume that facilitates the transfer of heat from the pre-stabilised precursor. Accordingly, in some embodiments, a cooling gas may be provided to the outlet vestibule to cool the precursor. In some embodiments of the cooling section, a cooling gas may be used in addition to a cooler configured to use a coolant. In some embodiments, the cooler may be configured to cool the cooling gas before it is used to cool the pre-stabilised precursor.

Typically, the cooling gas has substantially the same composition as the process gas and may be from the same gas source. In some embodiments, the cooling gas and/or cooler may be at a temperature in a range of from about 20° C. to about 240° C. However, it would be appreciated that this may depend on the temperature of the oxidation reactor, with the temperature of the cooling gas and/or cooler being selected such that it is relatively cooler than the precursor coming out of the reaction chamber. In some embodiments, the cooling gas may be cooled prior to supply to the reactor. In some embodiments, so as to achieve the desired degree of cooling, the cooling gas may be warmed so that the cooling gas is at a higher temperature than that of the supply of cooling gas, but still cooler than the precursor exiting the reaction chamber. Thus, the reactor may comprise a cooler for cooling the cooling gas, or a warmer for warming the cooling gas, to the desired cooling gas temperature.

This cooling gas may be provided by the sealing gas curtain. Accordingly, the gas curtain sub-assembly may be for providing a sealing gas curtain of cooling gas. Alternatively, or additionally, a separate flow of cooling gas may be provided to the outlet vestibule. In some embodiments, the cooling section may be configured to provide a cooling gas curtain or to provide cooling gas flow. Accordingly, the reactor may comprise a cooling gas inlet for providing cooling gas in the cooling section. The cooling gas inlet may comprise a cooling gas nozzle for producing a jet or jets of cooling gas. In some embodiments, the jets are directed perpendicular to the direction of the precursor's travel so that the gas jets impinge upon the precursor.

The heat transfer efficacy of the cooling gas is a function of: the initial temperature of the cooling gas; the flow rate of gas, the direction of the flow of gas, including the manner in which the cooling gas may impinges on the precursor; and the residence time of the precursor in the cooling gas. The cooling section, in particular the cooling gas inlet, may be design to deliver a predetermined direction and type of gas flow across a predetermined length. In use, degree of cooling may be controlled by adjusted one or more of the temperature of the cooling gas supplied to the inlet, the amount of gas supplied to the outlet and the speed at which the precursor passes through the cooling gas.

In some embodiments, the pre-stabilised precursor may be exposed to a suitable cooling gas at ambient room temperature for a predetermined time period in order to cool the pre-stabilised precursor prior its introduction to the oxidation reactor.

As will be explained in further detail below, the gas supply to the reactor and the extraction of exhaust gases are controlled to balance exhaust egress and gas ingress so that the gas seal assembly seals the reaction chamber to provide the substantially oxygen-free atmosphere therein and limits incidental gas flow out of the reactor through the inlet and the outlet. If used, a cooling gas will be factored into this balance of gas ingress and exhaust egress. The balance of gas flow may be such that at least a portion of the cooling gas may be drawn into the reaction chamber. In addition, a portion of the sealing gas may be drawn into the reaction chamber, even when gas curtain sub-assembly for providing the sealing gas curtain is not configured to provide some or all of the cooling gas.

Each of the sealing gas and cooling gas will be a substantially oxygen-free gas. Typically, the cooling gas and the sealing gas each have substantially the same composition as the process gas and each may be from the same gas source. Any cooling gas and any sealing gas drawn into the reaction chamber will form part of the flow of substantially oxygen-free gas in the reaction chamber. Thus, cooling gas and sealing gas drawn into the reaction chamber can constitute part of the process gas, which can be taken into account when selecting the composition of the sealing gas and cooling gas. Prior to being drawn into the reaction chamber, at the outlet end of the reactor, the sealing gas and cooling gas will have been warmed by the precursor exiting the reactor. In particular, as the cooling gas cools the precursor, it will be warmed. The subsequent use of gases warmed by the precursor exiting the reactor as process gas provides a mechanism for heat recovery from the precursor. This heat recovery may enhance the energy efficiency of the pre-stabilisation process using the reactor of the present invention.

As explained further below, in practice, the reactor may be operated at a slight positive pressure so that a proportion of the sealing gas in particular may leave the reactor via the inlet or outlet. Furthermore, a proportion of the sealing gas and cooling gas may be extracted as exhaust without being utilised as process gas. However, to minimise the consumption of substantially oxygen-free gas, it may be desirable to maximise the amount of gas that can be utilised as process gas, without unduly compromising the gas seal.

In some embodiments, the reactor may include two or more reaction chambers. Each reaction chamber may include one or more reaction zones as described above. Accordingly, each reaction chamber may have the same temperature and/or have the same gas flow rate conditions. Alternatively, different temperature and/or gas flow rate conditions may be applied in two or more chambers. In some embodiments, there are different conditions in each chamber, with different conditions in each reaction zone.

In these embodiments where the reactor includes two or more reaction chambers, the chambers may be stacked on top of one another.

In some embodiments where the reactor includes two or more reaction chambers, the rollers for conveying the precursor through each reaction chamber are external to the reactor. Accordingly, the precursor will exit the reactor through an outlet at an intermediate point in the pre-stabilisation reaction so that it can be transferred via a roller through the inlet leading to the next reaction chamber. The precursor is reactive in oxygen-containing atmospheres above certain temperatures before pre-stabilisation, and when pre-stabilisation has only been partially performed the precursor is at least partially activated for reaction in an oxygen containing atmosphere. Accordingly, the partially pre-stabilised precursor will be cooled before exiting the reactor so as to suitably limit any reaction with oxygen in the surrounding atmosphere.

The degree of limitation required to “suitably limit any reaction with oxygen in the surrounding atmosphere” will be determined in part by process safety requirements and, in part, determined by the desired properties of the pre-stabilised precursor. In some embodiments, the reaction with oxygen will have been suitably limited if there is no appreciable, or minimal appreciable, decrease in pre-stabilised precursor quality when compared to a pre-stabilised precursor prepared under the same process conditions without any intermediate exposure to an oxygen-containing atmosphere. In some embodiments, some appreciable difference in quality may be acceptable if the pre-stabilised precursor still meets the desired quality standard for the intended use of the pre-stabilised precursor.

The appropriate amount of cooling may be determined based on the residence time of the partially pre-stabilised precursor in the oxygen-containing atmosphere as it is being transferred from one reaction chamber to the next and the rate of reaction at certain temperatures.

In some embodiments, the partially pre-stabilised precursor is cooled to a temperature at least below the temperature of initiation of exotherm observed using differential scanning calorimetry (DSC) under a oxygen atmosphere as this temperature corresponds to the initiation of the cyclization reaction in an oxygen-containing atmosphere.

In some embodiments, the partially pre-stabilised precursor may be cooled to a temperature selected from the group consisting of less than 240° C., less than 220° C., less than 140° C., and less than 100° C.

The partially pre-stabilised precursor may be cooled in the same manner as described above for cooling the pre-stabilised precursor before it exits the reactor. For example, the reactor may comprise a cooling section between the reaction chamber and the outlet for cooling the partially pre-stabilised precursor to an appropriate temperature before it passes through the outlet.

In some other embodiments where the reactor includes two or more reaction chambers, the reactor will include one or more internal rollers, as necessary, to pass the precursor from one reaction chamber to another without the precursor leaving the substantially oxygen-free atmosphere. Each internal roller may be located within an intermediate chamber in the reactor that is supplied with process gas. Alternatively, the reaction chambers may share a common vestibule in which the internal roller(s) is located. In such an embodiment, the gas seal assembly will be adapted to ensure that a substantially oxygen-free atmosphere is maintained in the region in which the roller(s) is located.

In some embodiments, the or each internal roller may be a drive roller. Thus, in some embodiments, the reactor may include one or more internal drive stations. In some other embodiments, the or each internal roller may be a non-driven roller.

In embodiments where two or more internal rollers are used, a combination of one or more drive rollers and one or more non-driven rollers may be used.

As the precursor is being conveyed by each internal roller, it is important to match the roller speed with the speed of the precursor as it is being conveyed by upstream and downstream drive stations. If the speed of the internal roller is mismatched with the speed at which the precursor is otherwise being conveyed, this can lead to rubbing between the precursor and the roller or scuffing of the precursor by the roller, each of which can in turn damage the fibre. This may lead to fibre breakage and fibre wrap-arounds. For this reason, in some embodiments, a non-driven internal roller may be preferred.

The residence time within the reaction chamber is determined by the length of the chamber, the velocity of the precursor as it passes through the reaction chamber and the flow path of the precursor through the chamber.

Furthermore, the total residence time within the reactor is determined by the number of reaction chambers, the length of each chamber, the velocity of the precursor as it passes through each reaction chamber and the flow path of the precursor through each chamber.

As noted above, the or each reaction chamber may include two or more reaction zones.

The PAN precursor fibre may pass through a selected reaction zone once. For example, when a single zone or a plurality of zones at different temperatures is used, the precursor fibre may make a single pass through each zone.

Alternatively, the PAN precursor fibre may pass through the reaction chamber a plurality of times. For example, the precursor may pass through the reaction chamber two, three, four or more times.

In some embodiments where the reactor is configured to pass the precursor through the reaction chamber a plurality of times, the rollers for conveying the precursor through each pass are external to the reactor. Accordingly, the precursor will exit the reactor through an outlet at an intermediate point in the pre-stabilisation reaction so that it can be transferred via a roller through a inlet leading back into reaction chamber for the next pass. As noted above, the precursor is reactive in oxygen-containing atmospheres above certain temperatures before pre-stabilisation, and when pre-stabilisation has only been partially performed the precursor is at least partially activated for reaction in an oxygen containing atmosphere. Accordingly, the partially pre-stabilised precursor will be cooled before exiting the reactor so as to suitably limit any reaction with oxygen in the surrounding atmosphere.

The degree of limitation required to “suitably limit any reaction with oxygen in the surrounding atmosphere” will be determined, and the temperature to which the partially pre-stabilised precursor will be cooled is selected, as described above with reference to embodiments where the reactor includes two or more reaction chambers. Accordingly, the partially pre-stabilised precursor may be cooled in the same manner as described above for cooling the pre-stabilised precursor before it exits the reactor. For example, the reactor may comprise a cooling section between the reaction chamber and the outlet for cooling the partially pre-stabilised precursor to an appropriate temperature before it passes through the outlet. The cooled partially pre-stabilised precursor can then be transferred via the external roller back into the reaction chamber for a further pass through it.

In some embodiments, the partially pre-stabilised precursor may pass through the cooling section again as it passes between the inlet for the next pass and the reaction chamber. In some other embodiments, the cooling section will be configured so that the partially pre-stabilised precursor (or fully pre-stabilised precursor) passes through it only when travelling from the reaction chamber to an outlet. In some embodiments, the reactor will comprise one or more cooling sections. For example, a cooling section may be provided for each outlet of the reactor.

In some embodiments where the reactor is configured to pass the precursor through the reaction chamber a plurality of times, the reactor will include one or more internal rollers, as necessary, to pass the precursor through the reaction chamber two or more times without the precursor leaving the substantially oxygen-free atmosphere. Each internal roller may be located within an intermediate chamber in the reactor that is supplied with process gas. Alternatively, the internal roller(s) may be located in the vestibule(s). In such an embodiment, the gas seal assembly will be adapted to ensure that a substantially oxygen-free atmosphere is maintained in the region in which the roller(s) is located. For example, the vestibule may include a substantially oxygen-free sub-chamber.

In some embodiments, the or each internal roller may be a drive roller. Thus, in some embodiments, the reactor may include one or more internal drive stations. In some other embodiments, the or each internal roller may be a non-driven roller.

In embodiments where two or more internal rollers are used, a combination of one or more drive rollers and one or more non-driven rollers may be used.

As noted above, when the precursor is being conveyed by each internal roller, it is important to match the roller speed with the speed of the precursor as it is being conveyed by upstream and downstream drive stations. Thus, in some embodiments, a non-driven internal roller may be preferred.

So as not to disturb the uniformity of the flow of the substantially oxygen-free gas through the reaction chamber, rollers are not provided within the reaction chamber. Accordingly, the precursor will be suspended between material handling devices, such as drive rollers, external to the reaction chamber as it is conveyed through the reaction chamber. As a result, the length of the reaction chamber will be limited to by the maximum distance that the rollers can be separated while still conveying the precursor evenly through the reaction chamber at the desired tension. If the distance between the rollers is too great, the precursor may begin to sag as it travels towards the centre of the reaction chamber. In some embodiments, the reaction chamber is less than 20,000 mm long, for example less than 18,000 mm long.

In use, a substantially oxygen-free atmosphere is provided around the precursor in the reaction chamber by surrounding it with a flow of a substantially oxygen-free gas so as to limit the ingress of oxygen into the reaction chamber. In particular, the flow of gas will limit ingress of air from the surrounding atmosphere into the reaction chamber through the inlet and outlet. The reactor of the present invention comprises a gas delivery system for delivering substantially oxygen-free gas to the reaction chamber, the gas delivery system comprising a gas seal assembly for sealing the reaction chamber to provide the substantially oxygen-free atmosphere therein and for limiting incidental gas flow out of the reactor through the inlet and the outlet. In some embodiments, the gas seal assembly comprises: a gas curtain sub-assembly for providing a sealing gas curtain between the reaction chamber and each of the inlet and outlet; and an exhaust sub-assembly for removing exhaust gases from the reactor.

Suitable gas seal assemblies may include components typically used for conventional atmosphere-controlled furnaces to seal the furnace to provide the desired atmosphere therein and to limit incidental gas flow out of the furnace. In typical use, such gas seal assembly components are not required to provide sealing for a reactor having a forced gas flow therein. The forced gas flow provided, in use, by the forced gas flow assembly of the reactor of the present invention may be contrasted to the non-forced gas flow in a conventional atmosphere-controlled furnace such as that for carbon fibre carbonisation. In conventional atmosphere-controlled furnaces, such as carbonisation furnaces used to carbonise a stabilised precursor under conditions sufficient to form a carbon-based material, any gas flow is incidental to the exhaust draw and replacement process gas supply necessary to maintain the desired atmosphere composition. In contrast, the forced gas flow in the present invention is for first providing a flow of heated substantially oxygen-free gas in the reaction chamber to heat the precursor in the substantially oxygen-free atmosphere and then, when the released exothermic energy results in the precursor reaching a temperature that is higher than the temperature of the process gas, cooling and controlling the temperature of the precursor. In practice, a suitable forced gas flow will generally exceed the incidental flow rate induced by exhaust draw and replacement process gas supply.

A suitable forced gas flow may be produced by providing gas to the reactor and drawing exhaust from the reactor in sufficient quantities to induce the desired flow rate. However, this will lead to an excessive consumption of the substantially oxygen-free gas. Furthermore, as explained further below, excessive exhaust extraction rates can compromise the efficacy of the gas seal. Accordingly, in some embodiments, the bulk of the process gas is recirculated so as to provide the desired force gas flow rate, and this is described further below. In such embodiments, the exhaust draw will be determined primarily based on the desired exhaust draw based on the evolution of reaction by-products and the exhaust draw desirable for the function of the gas seal.

In a conventional carbonisation furnace, there is not any recirculation of gas.

A certain amount of gas from within the reactor will be removed as exhaust. In some embodiments, only a minor amount of exhaust will be removed. In some embodiments, the exhaust draw will be around 2% to 20% of the forced gas flow, with the remainder of the process gas being recirculated. In some embodiments the amount of gas removed as exhaust will be up to about 10% of the process gas.

The location and rate of extraction of draw of exhaust gasses can affect the efficacy of the gas seal assembly, and this is discussed further below. In addition, it is desirable to remove a portion of the process gas so that it may be replaced with fresh process gas. This can ensure that reaction by-products do not build up within the reactor and assist with maintaining pre-stabilisation process stability.

Process gas that is not removed by the exhaust sub-assembly can be recirculated. Accordingly, in some embodiments, the forced gas flow assembly comprises at least one return duct arranged to receive substantially oxygen-free gas from the reaction chamber and return substantially oxygen-free gas to the reaction chamber to recirculate substantially oxygen-free gas through the reaction chamber. In some embodiments, 80% to 98% of the process gas is recirculated. In some embodiments, at least 90% of the process gas is recirculated.

In some embodiments, the forced gas flow assembly comprises: one or more process gas inlets for providing heated substantially oxygen-free gas to the reaction chamber; one or more process gas outlets; and one or more return ducts; wherein the or each process gas outlet is for directing forced gas to a return duct, and the return duct is fluidly connected to at least one process gas inlet to recirculate the flow of heated substantially oxygen-free gas in the reaction chamber.

The forced gas flow assembly may comprise a heater for heating the substantially oxygen-free gas to the desired process gas temperature. The heater may be adjustable to allow the process gas temperature to be adjusted to the desired level. In embodiments where the forced gas flow assembly is configured to recirculate substantially oxygen-free gas through the reaction chamber, the heater may be for heating the recirculated gas so as to maintain the gas at the desired process gas temperature. In some embodiments, the forced gas flow assembly comprises one or more heating elements configured to heat gas passing through each return duct so that the recirculated flow substantially oxygen-free gas is heated to the desired process gas temperature.

In some embodiments, the gas seal assembly comprises: a gas curtain sub-assembly for providing a sealing gas curtain between the reaction chamber and each of the inlet and outlet; and an exhaust sub-assembly for extracting exhaust gases. The exhaust extraction rate, sealing gas flow rate and process gas flow rate (together with any other gas flow rate, such as cooling gas flow rate) may be balanced to seal the reaction chamber to provide the substantially oxygen-free atmosphere therein and limit incidental gas flow out of the reactor through the inlet and the outlet.

In one embodiment, the gas flow emitted by the gas curtain sub-assembly and the draw of the exhaust sub-assembly are controlled so as to effectively seal the reaction chamber, thus providing the substantially oxygen-free atmosphere within it, and to limit incidental gas flow out of the reactor through the inlet and outlet. Ideally, the gas flow emitted by the gas curtain sub-assembly and the draw of the exhaust sub-assembly are controlled so that there is no incidental gas flow out of the reactor through the inlet and outlet and so that there is no ingress of air from the surrounding atmosphere. However, in practice, the reactor may be operated at a slight positive pressure so that a minor amount of fugitive emissions are emitted from out the inlet.

Balancing the egress of exhaust with the ingress of sealing gas and process gas (and any other gas, such a cooling gas) is typically effected by altering the rate of extraction of exhaust gases and/or altering the flow rate of sealing gas and process gas. In one embodiment therefore, the exhaust sub-assembly draw is adjustable, for example by adjusting an exhaust fan revolution rate.

In another embodiment, the rate of supply of sealing gas is adjustable. In a further embodiment, the flow rate of supply of process gas is adjustable. Adjustment of supply flow rates of can be achievable by any means known to the skilled person including the use of a valve, constrictor, choke, diverter, altering pressure of the gas source, and the like.

Using the inlet end of the reactor as an example, if the point at which the sealing gas is supplied is located between the inlet and the point at which exhaust is extracted, an excessive rate of exhaust draw (or an inadequate supply of sealing gas relative to the exhaust draw) may draw air in through the inlet past the gas seal provided by the gas seal assembly. Additionally or alternatively, an excessive exhaust draw may draw large volumes of sealing gas towards the reaction chamber causing the sealing gas to mix with the supply of process gas. Often the sealing gas is cooler than the process gas, so drawing excessive amount of sealing gas into the process gas may cool the process gas and reduce reactor efficiency and reliability. This may be a particular problem at the outlet end of the reactor where it can be particularly desirable for the sealing gas to be cooler so as to cool the precursor before it exits the reactor. As described above, the sealing gas may be used to recover heat from the precursor as it exits the reactor. Thus, the draw of sealing gas into the process gas will ideally be selected to maximise the heat recovery from the precursor.

Once again using the inlet end of the reactor as an example, if the point at which the exhaust is extracted is located between the inlet and the point at which sealing gas is supplied, an excessive rate of exhaust draw may draw an excessive amount gas including toxic by-products from the reaction chamber towards the inlet, which may result in unacceptable levels of incidental gas flow out of the reactor.

In general, excessive exhaust draw rates are undesirable as they lead to excessive amounts of sealing gas and process gas being removed from the reactor as exhaust. This can unnecessarily waste the substantially oxygen-free gas.

An insufficient rate of exhaust draw may cause a build-up of gas inside the reactor, increasing pressure within the reactor. This may over-pressurise the reactor such that the performance of the gas seal provided by the gas seal assembly is impaired, resulting in unacceptable levels of incidental gas flow out of the reactor through the inlet or outlet. Similarly, an excessive supply of process gas may over-pressurise the reactor such that the performance of the gas seal provided by the gas seal assembly is impaired.

In some embodiments, the exhaust sub-assembly may comprise at least one exhaust outlet for removing exhaust gases from the reactor that is located in a vestibule between the inlet and/or outlet and the reaction chamber. For example, in some embodiments, the reactor comprises an inlet vestibule and an outlet vestibule, and the exhaust sub-assembly may comprise at least one exhaust outlet for removing exhaust gases from the reactor that is located the inlet vestibule and at least one exhaust outlet for removing exhaust gases from the reactor that is located the outlet vestibule.

In some embodiments, one or more return ducts may comprise one or more exhaust gas outlets. An exhaust gas outlet may be provided along a return duct in embodiments where it is desirable to remove larger percentages of exhaust gas, such that one or more exhaust gas outlets in addition to any outlet in a vestibule are required.

In some embodiments, the reactor comprises a gas curtain sub-assembly for providing a sealing gas curtain between the reaction chamber and each of the inlet and outlet. In some embodiments, at least the sealing gas curtain provided between the reaction chamber and the inlet by the gas curtain sub-assembly has gas flow characteristics adapted to disrupt atmospheric oxygen bound to a precursor passing through the sealing gas curtain. Accordingly, the sealing gas curtain can limit or prevent the ingress of oxygen, into the reaction chamber, along with the precursor.

In some embodiments, the gas curtain sub-assembly comprises at least one sealing gas curtain nozzle in the inlet vestibule and at least one sealing gas curtain nozzle in the outlet vestibule.

Suitable nozzles may be configured to direct and/or distribute sealing gas above and below the precursor, and across the full width of the precursor, as it passes through the reactor. In some embodiments, the or each sealing gas delivery nozzle may include upper and lower gas outlets located so as to be positioned above and below the precursor as it passes through the reactor. Each gas outlet will include one or more apertures for providing a jet or stream of sealing gas. In one embodiment, the nozzle comprises a slot-shaped opening that is at least as long as the width of the precursor. Accordingly the slot may extend across most or all of the width of the vestibule. In some other embodiments, the nozzle may comprise an array of apertures. In some embodiments, the nozzles may comprise a distributor for distributing and/or directing the flow of gas emitted from the one or more openings or apertures.

At least one sealing gas curtain nozzle in the inlet vestibule may be located between at least one exhaust outlet in the inlet vestibule and the reaction chamber. Alternatively, or additionally, at least one sealing gas curtain nozzle in the inlet vestibule may be located between at least one exhaust outlet in the inlet vestibule and inlet. Similarly, at least one sealing gas curtain nozzle in the outlet vestibule may be located between at least one exhaust outlet in the outlet vestibule and the reaction chamber. Alternatively, or additionally, at least one sealing gas curtain nozzle in the outlet vestibule may be located between at least one exhaust outlet in the outlet vestibule and outlet.

In one embodiment, the gas curtain sub-assembly comprises first and second plenums adapted to provide a gas curtain. Each of the first and second plenums comprises a plenum plate. The plenum plates of the first and second plenums may be arranged so that they are opposed and substantially parallel. The plenum plates are separated by a suitable distance to permit the precursor to travel between them and through the gas curtain formed by them.

Each plenum plate has a plurality of apertures to form the gas curtain. However, in some embodiments, the plate may be substituted for an array of nozzle tubes.

In these embodiments, the gas curtain sub-assembly is configured to provide jets of sealing gas through the apertures or the nozzle tubes. A positive gas pressure will be provided behind the plate. The pressure is typically less than about 1 kPa, with the gas being ejected at velocity through the apertures. Impingement velocity will vary, at least in part according to the fragility of the precursor, and is typically less than about 0.5 m/sec.

The apertures may be configured to direct the gas jets at high velocity onto a surface of the precursor. Preferably, apertures are configured to direct gas onto all surfaces of the precursor. Accordingly, as the precursor moves through the gas curtain located between the inlet and the reaction chamber, any oxygen bound to the surface of the precursor is substantially disrupted by the flow characteristics of the gas curtain. In one embodiment, the gas flow is directed substantially perpendicularly to the plane of the precursor. The flow through such jets should be selected to ensure no damage is caused to the precursor.

In some embodiments, the opening area defined by the perimeter of the aperture is about 0.5-20 mm². For example, the area may be 0.79 mm², 3.14 mm², 7.07 mm², 12.57 mm², or 19.63 mm², preferably about 7.07 mm². In some embodiments, the apertures are circular. Thus, the aperture diameter in some embodiments is about 1, 2, 3, 4, or 5 mm, and preferably about 3 mm. In some embodiments, the apertures are slots. The slots may be 0.5-20 mm long, for example 2-20 mm long, with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor. In other embodiments, the slots will be orientated so that they are perpendicular to the direction of travel of the precursor. In some embodiments, the slots will be orientated at an angle relative to the direction of travel of the precursor, such as 45°. Ideally, in all cases, the apertures are positioned to ensure that fibres across the width of the precursor experience the same level of impinging flow.

The plenum plate may be fabricated from stainless steel, of thickness about 10 mm.

The number of apertures, length of sealing gas curtain, and the flow rate of curtain gas determines the impingement velocity on the product. Control of impingement velocity may be required in order to customize the gas seal assembly for a particular precursor. For example, impingement velocity may be decreased to reduce agitation, flutter or movement of the precursor so as to avoid fibre damage, including fibre breakage.

Advantageously, in some embodiments, the plates are configured to be replaceable to facilitate customization and maintenance.

Another parameter that may be varied is the distance between the plenum plates. Accordingly, in one embodiment of the gas curtain sub-assembly, the plates are adjustable so as to allow variation in the distance between the plates. Adjustability of the gap between the plenum plates allows for optimization of this distance. A typical aim of the adjustment will be to provide the smallest workable gap allowing for the catenary formed by the precursor, together with the lowest inert gas consumption while maintaining the substantially oxygen-free atmosphere within the reaction chamber.

The plates may be adjusted in a perpendicular direction with reference to the precursor, with external gauges indicating the position of the internal plenum plates.

As noted above, components typically used in atmosphere-controlled furnaces may be suitable for use in the gas seal assembly of the reactor of the present invention. For example, International Patent Application Publication No. WO/2014/121331 (the contents of which are incorporated herein by reference) describes an apparatus configured to produce a gas curtain and components from this apparatus may be suitable for embodiments of the gas seal assembly of the reactor of the present invention. Accordingly, in one embodiment, the gas curtain sub-assembly comprises first and second plenums adapted to provide a gas curtain comprising two zones: the first zone having gas flow characteristics adapted to limit the ingress of air from the atmosphere surrounding the reactor, the second zone having gas flow characteristics adapted to disrupt and displace atmospheric oxygen on the precursor passing through the gas curtain.

Each of the first and second plenums comprises a plenum plate having at least two regions.

The plenum plates of the first and second plenums may be arranged so that they are opposed and substantially parallel. The plenum plates are separated by a suitable distance to permit the precursor to travel between them and through the gas curtain formed by them.

Each plate is devoid of apertures in a first region to form a non-turbulent, region of gas curtain in the first zone. The first region of the plate is disposed closest the inlet or outlet (i.e. immediately adjacent to the atmosphere), and the non-turbulent, region of gas curtain formed is configured to avoid turbulence and introduction of atmospheric oxygen. However, this non-turbulent, region of gas curtain may not be adapted to disrupting the oxygen bound to the precursor.

When the precursor enters the reactor through the inlet, the precursor passes through the first zone of the gas curtain. The flow in this zone is, in some embodiments, substantially laminar. As used herein with reference to the gas seal assembly of the reactor the term “substantially laminar” is intended to include the circumstance whereby the direction of flow is substantially coplanar with the walls of the chamber, vestibule and/or the precursor. This arrangement leads to the substantial inhibition of turbulence about the interface between the first curtain zone and the atmosphere surrounding the reactor which could lead to the ingress of oxygen. At this point, some oxygen may still be bound to the surface of the precursor.

Each plenum plate has a plurality of apertures in the second region to form the second, turbulent zone of the gas curtain. The apertures of the plenum plates of this embodiment may be as described above for plenum plates that do not comprise a first region devoid of apertures. Typically, the second region of each plate is of greater length than the first. The ratio of length of first region to second region may be about 3:1.

In these embodiments, the gas curtain sub-assembly is configured to provide jets of sealing gas through the apertures. A positive gas pressure will be provided behind the plate. The pressure is typically less than about 1 kPa, with the gas being ejected at velocity through the apertures. Impingement velocity will vary, at least in part according to the fragility of the precursor, and is typically less than about 0.5 msec.

The apertures may be configured to direct the gas jets at high velocity onto a surface of the precursor. Preferably, apertures are configured to direct gas onto all surfaces of the precursor. Accordingly, once the precursor has moved into the second zone, the bound oxygen is substantially disrupted by the substantially turbulent flow characteristics of gas in the second zone. In one embodiment, the gas flow in the second region is directed substantially perpendicularly to the plane of the precursor.

The number of apertures, length of sealing gas curtain, and the flow rate of curtain gas determines the impingement velocity on the product. Control of impingement velocity may be required in order to customize for a particular precursor and will be selected to avoid excessive agitation, flutter or movement of the precursor that may cause damage to the precursor.

Plenum plates in accordance with this embodiment may also be replaceable to facilitate customization and maintenance.

The distance between the plenum plates of this embodiment may be varied as described above.

The arrangements described above for embodiments of the sealing gas nozzle are also suitable arrangements for embodiments of the cooling gas inlet, if provided.

A substantially oxygen-free atmosphere is employed within the reaction chamber in use. The term “substantially oxygen-free atmosphere” means an atmosphere that is substantially free of oxygen atoms. The oxygen atoms may be part of an oxygen containing molecule, such as molecular oxygen (i.e. O₂) or water (i.e. H₂O), that is within the atmosphere. However, the term “substantially oxygen-free atmosphere” will permit oxygen atoms forming part of the molecular structure of a polymer in the precursor to be present.

It is preferable to limit the amount of oxygen atoms in the substantially oxygen free atmosphere as it is believed that oxygen atoms can adversely affect the rate of nitrile group cyclisation and thus the ability to achieve a requisite quantity of cyclised nitrile groups in the pre-stabilised precursor within a selected time period.

Accordingly, it is an important part of the process that pre-stabilisation and formation of a pre-stabilised precursor comprising at least 10% cyclised nitrile groups is carried out in a substantially oxygen-free atmosphere.

Furthermore, it is desired that water (e.g. in the form of steam or water vapour) not be present in the substantially oxygen-free atmosphere as water can result in cooling of the atmosphere. Accordingly, more energy will need to be consumed in order to maintain the substantially oxygen-free atmosphere at a desired temperature. Thus it is preferred that the substantially oxygen-free atmosphere employed for the pre-stabilisation step is at least substantially free of water, and in one preference, does not contain water.

As discussed above, the term “substantially oxygen-free atmosphere” is also used to indicate that the atmosphere is substantially free of molecular oxygen (i.e. 02), which is commonly referred to as “oxygen”. Minor amounts of oxygen (i.e. 02) may be present in the atmosphere to which the precursor fibre is exposed. A substantially oxygen-free atmosphere may contain not more than 1%, not more than 0.5%, not more than 0.1%, not more than 0.05%, not more than 0.01%, or not more than 0.005% by volume of oxygen (02). In some embodiments it is preferred that no oxygen be present, such that the atmosphere used during pre-stabilisation is oxygen-free.

It can be desirable to limit the amount of oxygen in the substantially oxygen-free atmosphere as the presence of oxygen may pose a fire risk at some operating temperatures employed for forming the pre-stabilised precursor.

In one set of embodiments, the substantially oxygen-free atmosphere comprises an inert gas. A suitable inert gas may be a noble gas, such as argon, helium, neon, krypton, xenon and radium. A suitable inert gas may be nitrogen. The substantially oxygen-free atmosphere may comprise mixtures of inert gases, such as a mixture of nitrogen and argon.

In one preference, the substantially oxygen-free gas is an inert gas. The substantially oxygen-free gas may comprise nitrogen or a noble gas, such as argon, helium, neon, krypton, xenon and radium, or mixtures thereof. As noted above, the substantially oxygen-free gas is also described herein as “process gas”.

In one embodiment, the process gas is nitrogen. The process gas may be nitrogen with 99.995% purity and a dewpoint lower than −30° C.

In some embodiments, the substantially oxygen-free gas may be medical grade nitrogen of at least 99.995% purity. Medical grade nitrogen is available from a number of commercial suppliers.

Preferably, the residence time of the precursor in the reaction chamber of the reactor is relatively short period of time, more preferably the residence time is only minutes. Accordingly, the reactor of the present invention may be used to rapidly form a pre-stabilised precursor.

One skilled in the art would appreciate that each embodiment of the pre-stabilisation reactor has a defined length. The total flow path length for the precursor will depend on the number and configuration of reaction chambers in the reactor. As noted above, the total residence time (dwell time) within the reactor is determined by the number of reaction chambers, the length of each chamber, the velocity of the precursor as it passes through each reaction chamber and the flow path of the precursor through each chamber. In turn, the dwell time can determine the time period in which the pre-stabilisation step is performed.

Additionally, the residence time of the precursor in a reaction chamber can be affected by the temperature within the or each reaction chamber and vice versa. For example, in embodiments where a higher temperature is used for pre-stabilisation, it may be desirable to shorten the residence time in the reaction chamber compared to embodiments where a lower temperature is used.

It can be desirable to heat a precursor in a substantially oxygen-free atmosphere for a short period of time as this can help confer downstream advantages that assist in improving the efficiency of precursor stabilisation and subsequently also carbon fibre manufacture, particularly in relation to processing time. In particular, it has been found that the pre-stabilisation described herein can assist with the high speed conversion of a precursor fibre to carbon fibre.

In one set of embodiments, the residence time of the precursor in the reactor is no more than about 5 minutes, no more than about 4 minutes, no more than about 3 minutes or no more than about 2 minutes.

In some embodiments, the speed at which the precursor is conveyed through a pre-stabilisation reactor is selected to match a line speed used in a carbon fibre production line. This can allow the pre-stabilisation reactor to be readily integrated into a carbon fibre manufacturing system. In some embodiments, the reactor may be integrated into an existing carbon fibre manufacturing system.

In particular embodiments, the precursor may be conveyed through the pre-stabilisation reactor at a speed in a range of from about 10 to 1,000 metres per hour. For example, the line speed may be up to 500 metres per hour (m/hr).

In commercial-scale operations, the velocity of the precursor as it passes through each reaction chamber may be in a range of from about 100 to 1,000 m/hr, for example, 120 to 900 m/hr. In some embodiments, the velocity may be in a range of from about 600 to 1,000 m/hr, for example, 700 to 800 m/hr.

To enable the PAN precursor to be treated for a short period of time using the reactor of the present invention, parameters such as the temperature at which the precursor is heated as well as the amount of tension applied to the PAN precursor during heating, may be selected to ensure that the desired time period for pre-stabilisation can be met.

For a given reactor, the temperature of the or each reaction chamber, as well as the speed at which the precursor is conveyed through each chamber and the flow path of the precursor through each chamber can be adjusted in order to achieve the desired dwell time.

Once a pre-stabilisation time period has been selected, the temperature at which the precursor is heated during pre-stabilisation may then be selected to allow the pre-stabilisation to be completed within that selected period of time. An example of a procedure for determining the heating temperature is described below.

In some particular embodiments, during pre-stabilisation, the precursor is heated in a substantially oxygen-free atmosphere at a temperature in a range of from about 250° C. to 400° C., or from about 280° C. to 320° C. Heating at a temperature within such ranges may occur for a time period selected from the group consisting of: no more than about 5 minutes; no more than about 4 minutes; no more than about 3 minutes; or no more than about 2 minutes.

Advantageously, a short pre-stabilisation time period may be achieved using the reactor of the present invention by adjustments to the heating temperature and the amount of tension applied to the PAN precursor fibre.

While the PAN precursor fibre is being heated in the substantially oxygen-free atmosphere, a predetermined amount of tension is also applied to the precursor fibre. In some embodiments of the process described herein, a substantially constant amount of tension is applied to the precursor fibre.

In one set of embodiments, the temperature at which the precursor fibre is heated and the amount of tension applied to the precursor fibre are each selected so as to enable the precursor to reside in the substantially oxygen-free atmosphere for a time period of no more than about 5 minutes, no more than about 4 minutes, no more than about 3 minutes, or no more than about 2 minutes.

It has been found by the inventors that tension can influence the extent of cyclisation of nitrile groups present in a PAN precursor. In this regard, when a PAN precursor is heated in a substantially oxygen-free atmosphere under pre-selected conditions of time and temperature, the amount of tension that is applied to the precursor can influence the extent of nitrile group cyclisation. That is, when time and temperature conditions are fixed, the application of different amounts of tension to the precursor under those fixed conditions can result in different quantities of cyclised nitrile groups being produced in the precursor fibre.

The present invention provides a system for pre-stabilising a precursor, the system comprising the reactor of the invention and tensioning devices located upstream and downstream of the reaction chamber, wherein the tensioning devices are adapted to pass the precursor through the reaction chamber under a predetermined tension. In some embodiments, the tensioning devices are material handling devices such as those known in the art and are separate components from the reactor. In some embodiments, the reactor will comprise one or more of the tensioning devices. In embodiments where the reactor comprises two or more reaction chambers, tensioning devices may be provides upstream and downstream of each reaction chamber so that the precursor is conveyed via a tensioning device as it passes from one reaction chamber to the next.

Rollers are used to convey the precursor through the reactor and will often include arrangements of rollers selected to apply a predetermined tension to the precursor. Accordingly, the tensioning devices can include combinations of rollers. Suitable combinations of rollers for applying a predetermined tension are known the art and include S-wrap, omega (Ω), 5-roller, 7-roller and nip-roller drive roller arrangements.

Selection of the drive roller arrangement can be influenced by: precursor type; the available space for rollers; the desired output of precursor, both in terms of the desired quantity and quality; and the tension to be applied to the precursor; as well as budgetary constraints. For example, S-wrap, omega and nip-roller arrangements are relatively compact arrangements and may be preferred in embodiments where space is limited. For example, such arrangements may be selected in circumstances where insufficient space is available for a 5-roller drive arrangement.

In some embodiments, the reactor is adapted to providing a pre-stabilised precursor for production of aerospace carbon fibre. In some of those embodiments, 5-roller or 7-roller drive arrangements may be preferred.

In some embodiments, so as to minimise the number of rollers required, S-wrap, omega and nip-roller arrangements may be preferred.

In some embodiments, 5-roller or 7-roller drive arrangements may be preferred as these arrangements may be able to apply a greater amount of tension to the precursor relative to other arrangements.

As noted above, in some embodiments, the reactor includes one or more internal rollers. The internal rollers may be used to convey a precursor through a reaction chamber two or more times. Alternatively or additionally, the internal rollers may be used to convey the precursor from one reaction chamber to another in the reactor. Often, the internal rollers are non-driven pass rollers. However, in some embodiments, the internal drive rollers may be one or more tensioning devices. Accordingly, there may be tensioning devices provided for each reaction chamber and/or each pass of the precursor through a reaction chamber. Thus, the tensioning devices may be used to apply a predetermined tension for each reaction chamber and/or each pass of the precursor through a reaction chamber, and these predetermined tensions may be the same (i.e. a substantially constant tension is applied) or different.

Without wishing to be limited by theory, it is believed that the cyclisation of a portion of the nitrile groups present in a precursor can assist in preparing the precursor for subsequent stabilisation treatment in an oxygen-containing environment. Thus, a benefit provided by pre-stabilisation is the ability to form a precursor having a desired amount of cyclised nitrile groups, which can readily undergo further reaction to form a stabilised precursor. Thus the pre-stabilisation step can allow a stabilised precursor to be formed in less time and with less energy

Pre-stabilisation of the PAN precursor involves the application of a predetermined amount of tension to a precursor fibre. It has been found that the applied tension can help promote the cyclisation of pendant nitrile groups that form part of the polyacrylonitrile chemical structure. The cyclisation of nitrile groups may be initiated by the heat applied to the precursor and thereafter promoted through an increase in the molecular alignment of polyacrylonitrile within the precursor fibre due to the applied tension. Cyclised nitrile groups can form fused hexagonal carbon-nitrogen rings in the precursor. The result is a precursor fibre that is at least partially stabilised and in which at least a portion of the PAN has been transformed into a ladder-type structure due to the cyclised nitrile groups.

The cyclisation of nitrile groups in a PAN precursor is exothermic and exothermic energy is released as nitrile groups undergo cyclisation. Exothermic behaviour can vary between different precursors. Accordingly, the heating temperature and the time period selected for heating the precursor, as well as the applied tension employed for pre-stabilisation of the precursor in the substantially oxygen-free atmosphere can be adapted for a given precursor so as to suitably pre-stabilise the precursor and manage its exothermic behaviour. Thus, the tensioning devices may be configured to permit such adaptation for specific precursors.

The temperature and time in which the precursor is heated in the substantially oxygen-free atmosphere and the tension applied to the precursor during the heat treatment are each selected to facilitate nitrile group cyclisation in the PAN precursor. Thus process conditions employed for the pre-stabilisation step can be set to promote the formation of a desired amount of cyclised nitrile groups in a pre-stabilised precursor.

In some embodiments of a pre-stabilisation step described herein, the temperature and time in which the precursor is heated in the substantially oxygen-free atmosphere and the tension applied to the precursor are each selected to control nitrile group cyclisation, such that a pre-stabilised precursor comprising a predetermined percentage of cyclised nitrile groups is formed. In particular, the temperature and time in which the precursor is heated in the substantially oxygen-free atmosphere and the tension applied to the precursor are each selected to control nitrile group cyclisation, such that a pre-stabilised precursor comprising at least 10% cyclised nitrile groups as determined by Fourier transform infrared (FT-IR) spectroscopy is formed.

The extent of nitrile group cyclisation (expressed as an extent of reaction (% EOR)) can be determined using Fourier Transform Infrared (FT-IR) spectroscopy according to methodology developed by Collins et al., Carbon, 26 (1988) 671-679. Under this methodology, the following formula can be used:

$$EOR ( \% ) = \frac{( 100 \times 0.29 \times Abs ( 1590 ) )}{( ( Abs ( 2242 ) + ( 0.29 \times Abs ( 1590 ) )}$$

where Abs (1590) and Abs (2242) are the absorbance of the peaks recorded at 1590 cm⁻¹ and 2242 cm⁻¹, which correspond to C═N groups and nitrile (—CN) groups, respectively. The nitrile groups (2242 cm⁻¹) are converted to C═N groups through cyclisation. The ratio of absorbance between peaks at 1590 cm⁻¹ and 2242 cm⁻¹ can therefore provide an indication on the proportion of nitrile groups that have undergone cyclisation.

Nitrile group cyclisation as described herein is most suitably determined by Fourier transform infrared (FT-IR) spectroscopy.

The process conditions selected for the pre-stabilisation step may be sufficient to form a pre-stabilised precursor having a predetermined % EOR, in particular a % EOR that is at least 10%. In some embodiments, process conditions selected for pre-stabilisation described herein are sufficient to form a pre-stabilised precursor having at least 15% or at least 20% cyclised nitrile groups.

It has been found that the quantity of cyclised nitrile groups (% EOR) in the pre-stabilised precursor can be varied through the selection of particular process parameters employed for the pre-stabilisation step using the reactor. For example, in some embodiments, it has been found that the degree of nitrile group cyclisation in a precursor can be varied by applying different amounts of tension to the precursor fibre when the precursor is heated in a substantially oxygen-free atmosphere at fixed conditions of temperature and time.

The temperature and time period in which the precursor is heated in the substantially oxygen-free atmosphere can also influence nitrile group cyclisation. However, without wishing to be limited by theory, it is believed that the amount of tension applied to the precursor can exert a greater influence on the formation of cyclic structures.

In particular, it has been found that tension applied to the precursor can control the extent of nitrile group cyclisation in the precursor. This may arise as tension applied to the precursor can influence the molecular alignment of polyacrylonitrile in the precursor.

As an example, pre-stabilisation of a PAN precursor can involve heating a precursor comprising polyacrylonitrile at a predetermined temperature in a substantially oxygen-free atmosphere for a predetermined time period while applying a substantially constant amount of tension to the precursor. In such embodiments involving predetermined heating temperature and time, the amount of tension applied can influence the extent of nitrile group cyclisation in the precursor. Accordingly, when time and temperature conditions for the pre-stabilisation step are fixed, the application of different substantially constant amounts of tension to the precursor under those fixed conditions can produce different quantities of cyclised nitrile groups in the precursor. The applied tension can thus control the extent of nitrile group cyclisation, allowing a pre-stabilised precursor comprising a predetermined percentage of cyclised nitrile groups to be formed.

In particular embodiments, the % EOR can be tuned by varying the amount of tension applied to the precursor during pre-stabilisation. Thus the amount of tension applied to the precursor in the pre-stabilisation step can be controlled to ensure formation of a desired quantity of cyclised nitrile groups. In turn, this can assist in the evolution of particular chemical and structural properties in the pre-stabilised fibre.

In one set of embodiments, the amount of tension applied to the PAN precursor during pre-stabilisation is selected to form a pre-stabilised precursor having at least 10%, at least 15%, or at least 20% cyclised nitrile groups, as determined by FT-1R spectroscopy.

In one preference, the amount of tension applied to the precursor promotes the formation of a high content of cyclised nitrile structures in the pre-stabilised precursor.

A high content of cyclised nitrile groups can assist in efficient processing of the precursor for formation of a stabilised precursor.

Additionally, a high quantity of cyclised nitrile groups may assist in rapid formation of a thermally stable, partially stabilised precursor.

Theoretically there is no upper limit on the amount of cyclised nitrile groups that may be present in the pre-stabilised precursor. However, in practice, it may be desirable for the pre-stabilised precursor to have no more than about 50%, no more than about 45% cyclised nitrile groups, or no more than about 35%.

In some embodiments, the pre-stabilised precursor may comprise from between about 10% to about 50%, from about 10% to about 45% cyclised nitrile groups, or from about 20% to about 30% cyclised nitrile groups, as determined by FT-IR spectroscopy.

In some embodiments, the temperature and time in which the precursor is heated in the substantially oxygen-free atmosphere and the amount of tension applied to the precursor are each selected to control nitrile group cyclisation, such that a pre-stabilised precursor having at least 15%, or at least 20%, cyclised nitrile groups as determined by Fourier transform infrared (FT-IR) spectroscopy is formed.

In other embodiments, the temperature and time in which the precursor is heated in the substantially oxygen-free atmosphere and the amount of tension applied to the precursor are each selected to control nitrile group cyclisation, such that a pre-stabilised precursor having 10% to 50%, 15% to 45%, or 20% to 30%, cyclised nitrile groups as determined by Fourier transform infrared (FT-IR) spectroscopy is formed.

Process conditions selected for pre-stabilisation can facilitate the formation of a pre-stabilised precursor suitable for high speed conversion to carbon fibre. That is, the temperature and time period for heating the precursor in the substantially oxygen-free atmosphere and the tension applied to the precursor can be selected and appropriately balanced with one another to enable the formation of a pre-stabilised precursor having desirable properties, which can subsequently be rapidly converted into carbon fibre.

For example, it would be appreciated that if lower or higher temperatures are desired for heating the precursor during the pre-stabilisation step, suitable adjustments can be made to the time period for heating the precursor and/or the tension applied to the precursor in view of the selected temperature. For example, if the temperature at which the precursor is heated in the substantially oxygen-free atmosphere is increased, then the time period for heating the precursor may be decreased to compensate for the increased temperature, and vice versa.

A number of indicators can be used to guide the selection of the process conditions (i.e. temperature, time and tension) used to convert a precursor into a pre-stabilised precursor.

One skilled in the art would appreciate that different PAN precursor feedstocks can have different properties. Accordingly, the indicators can facilitate the selection of appropriate time, temperature and tension conditions to be used in the pre-stabilisation step for a given precursor feedstock so that a pre-stabilised precursor having desired properties can be formed at the conclusion of the pre-stabilisation step. The indicators may be considered separately or in combination.

One indicator that may be used to guide the selection of pre-stabilisation process conditions is the extent of nitrile group cyclisation (expressed as an extent of reaction (% EOR)). The extent of reaction (% EOR) corresponds to the percentage of cyclised nitrile groups in the pre-stabilised precursor. A skilled person would understand that nitrile group cyclisation produces a conjugated C—N double bond structure in the precursor from the C—N triple bond.

The values of % EOR and percentage (%) cyclised nitrile groups therefore represents a proportion of available and cyclisable nitrile groups present in the polyacrylonitrile in the precursor that have in fact been cyclised.

In addition to % EOR, other indicators that may also assist in the selection of appropriate process conditions for use in the pre-stabilisation step include the colour, mechanical properties (including tensile properties such as tensile strength, tensile modulus and elongation), mass density and appearance of the precursor. Each of these other indicators is further discussed below.

Virgin (untreated) PAN precursor is typically white in colour. The PAN precursor undergoes a colour change during pre-stabilisation, which can be visually observed. The colour change has been observed to occur even after heating of the precursor in a substantially oxygen-free atmosphere for a short period of time.

The colour evolution that occurs is believed to be chemically induced due to the formation of cyclised nitrile groups in the precursor. A pre-stabilised precursor having at least 10% cyclised nitrile groups, for example, having about 20% cyclised nitrile groups, may have a colour ranging from dark yellow or orange to copper. A change in the colour of the PAN precursor may therefore assist one skilled in the art in selecting an appropriate temperature and time period for heating the precursor. However, for the purposes of production quality control, although a colour change may be observed, it may be desirable to measure the value of % EOR to ensure the process using the reactor is within tolerance. The temperature and time period in which the precursor is heated in the substantially oxygen-free atmosphere as well as the tension applied to the precursor may be selected to ensure that a precursor of a desired colour is achieved at the conclusion of pre-stabilisation. Preferably, the temperature and time period in which the precursor is heated in the substantially oxygen-free atmosphere is not so high or so long that the precursor becomes dark brown or black in colour.

In some embodiments, the precursor is heated in the substantially oxygen-free atmosphere at a temperature that is sufficient to at least initiate cyclisation of a portion of the nitrile groups present in the precursor such that a colour change is observed. In some embodiments, the heating of the precursor is performed within a selected period of time.

Visually, nitrile group cyclisation can be indicated by a change in the colour of the precursor from white to a colour ranging from dark yellow to copper. The colour change has been observed to occur even after heating of the precursor in a substantially oxygen-free atmosphere for a short period of time.

In one set of embodiments, the precursor fibre is heated in a substantially oxygen-free atmosphere at a temperature in a range of from about 250 to 400° C., preferably in a range of from about 280° C. to 320° C.

Another useful indicator that can help to guide the selection of process conditions for pre-stabilisation is the mechanical properties of the pre-stabilised precursor, in particular, its tensile properties.

It has been found that the mechanical properties of ultimate tensile strength and tensile modulus in the PAN precursor can decrease after the pre-stabilisation step. Furthermore, it has been found that elongation of the precursor can increase after the pre-stabilisation step.

In one form of the pre-stabilisation step, the temperature and time period in which the precursor is heated in the substantially oxygen-free atmosphere and the amount of tension applied to the precursor as it is heated in the atmosphere are selected so as to form a pre-stabilised precursor having an ultimate tensile strength that is lower than that of the virgin PAN precursor. In one set of embodiments, the pre-stabilised precursor produced using the reactor of the present invention may have an ultimate tensile strength that is up to 60% lower, for example from about 15% to about 60% lower than that of the initial virgin PAN precursor.

In one form of the pre-stabilisation step, the temperature and time period in which the precursor is heated in the substantially oxygen-free atmosphere and the amount of tension applied to the precursor as it is heated in the atmosphere are selected so as to form a pre-stabilised precursor having a tensile modulus that is lower than that of the virgin PAN precursor. In one set of embodiments, the pre-stabilised precursor has a tensile modulus that is up to 40% lower, for example from about 15% to about 40% lower than that of the initial virgin PAN precursor.

In one form of the pre-stabilisation step, the temperature and time period in which the precursor is heated in the substantially oxygen-free atmosphere and the amount of tension applied to the precursor as it is heated in the atmosphere are selected so as to form a pre-stabilised precursor having an elongation to break that is higher than that of the virgin PAN precursor. In one set of embodiments, the pre-stabilised precursor has an elongation to break that is up to 45% higher, for example from about 15% to about 45% higher than that of the initial virgin PAN precursor.

A further indicator to guide the selection of pre-stabilisation process conditions is the mass density of the PAN precursor. Precursor mass density can increase after treatment of the precursor in a pre-stabilisation step as described herein.

In one form of the pre-stabilisation step, the temperature and time period in which the precursor is heated in the substantially oxygen-free atmosphere and the amount of tension applied to the precursor as it is heated in the atmosphere are selected so as to form a pre-stabilised PAN precursor having a mass density in the range of from about 1.19 to 1.25 g/cm³, for example about 1.21 to 1.24 g/cm³.

As yet a further indicator, the appearance of the PAN precursor can also help to guide the selection of pre-stabilisation process conditions. PAN precursors that have been pre-stabilised are preferably substantially defect-free and have an acceptable appearance. It is considered that defects, including melting of the precursor or partial tow breakage, could lead to low mechanical properties (e.g. tensile properties) or even failure in a carbon material prepared with the precursor.

Process conditions for the pre-stabilisation step can be selected to ensure that the resultant pre-stabilised precursor has one or more properties selected from a colour, mechanical property (including a tensile property selected from ultimate tensile strength, tensile modulus and elongation at break), mass density and appearance within the parameters described above, in addition to having the desired % EOR.

In one form of the pre-stabilisation step, the temperature and time period in which the precursor is heated in the substantially oxygen-free atmosphere and the amount of tension applied to the precursor as it is heated in the atmosphere are each selected so as to form a pre-stabilised PAN precursor that is substantially defect-free.

The selected temperature and selected time period in which the PAN precursor is heated in the substantially oxygen-free atmosphere are sufficient to at least initiate and to promote the cyclisation of nitrile groups in the precursor and optionally to also promote the evolution of one or more of the indicators described above.

A person skilled in the relevant art would understand that tension is a force that is applied to the PAN precursor fibre. In accordance with the process described herein, the amount of tension applied to the precursor using the system of the claimed invention is a predetermined value. In accordance with some embodiments of the process described herein, the amount of tension applied to the precursor using the system of the claimed invention is maintained at a substantially constant value and is not varied while the precursor is heated in the substantially oxygen-free atmosphere. Thus once an amount of tension is selected for a given precursor, the tension may be maintained so that the precursor can be processed at a substantially constant amount of tension during pre-stabilisation in the reactor of the present invention.

In one set of embodiments, it is desirable that the tension applied to the PAN precursor is not sufficient to alter the dimensions (e.g. the shape or length) of the precursor to a significant extent. Rather, the tension is applied to promote desirable chemical reactions (i.e. nitrile group cyclisation) in the PAN precursor. The amount of tension that is applied may be dependent on a number of factors, such as for example the temperature and time period in which the precursor is heated in the substantially oxygen-free atmosphere, the composition of the PAN precursor and the size of the precursor tow. The applied tension can be adapted to enable optimised results to be achieved for a specific precursor and/or tow size and/or selected pre-stabilisation process conditions of time and temperature.

It is also recognised that there may be intrinsic tension effects in the precursor due to physical and/or chemical changes that may occur in the fibre as the pre-stabilisation step proceeds.

However, it is intended that the tension applied to the precursor in accordance with processes of embodiments described herein would encompass any intrinsic tension changes that may be generated in the precursor during the pre-stabilisation step. In some embodiments, the tension applied may make accommodation for changes in the intrinsic tension of the precursor due to changes that take place in the precursor during pre-stabilisation. In some embodiments, the tension applied to the precursor fibre is maintained at a substantially constant value during the pre-stabilisation step.

In particular, the amount of tension applied to the PAN precursor fibre should be sufficient to produce at least 10% cyclised nitrile groups, which is determined by FT-IR spectroscopy as described herein.

In one set of embodiments the amount of tension applied to the precursor fibre is sufficient to form a pre-stabilised precursor comprising at least 15% or at least 20% cyclised nitrile groups. The extent of nitrile group cyclisation is determined by Fourier transform infrared (FT-IR) spectroscopy as described herein. In some embodiments, insufficient cyclisation may occur if insufficient tension is applied to the precursor fibre.

In some embodiments, the amount of tension applied to the precursor is sufficient to form a pre-stabilised precursor comprising from between about 10% to about 50%, preferably from about 10% to about 45%, cyclised nitrile groups as determined by FT-IR spectroscopy.

For a selected PAN precursor fibre and selected heating time and temperature conditions for the pre-stabilisation step, the amount of tension applied to the precursor fibre should be such that the precursor fibre is not in a slack state. For practical considerations, the tension applied to the precursor will be sufficient to facilitate transport of the fibre through the reaction chamber used to perform the pre-stabilisation step whilst also avoiding contact with an internal surface of the chamber. However, the applied tension also should not be so high that the precursor fibre breaks under the applied tension.

The amount of tension to be applied is dependent upon the nature of the precursor. For example, the amount of tension that is applied may be dependent the composition of the precursor. In addition, precursors with larger tow counts and/or fibres of greater diameter may require greater tension to be applied than precursors with smaller tow counts and/or finer diameters. The applied tension can be adapted to enable optimised results to be achieved for a specific precursor and/or tow size and/or selected pre-stabilisation process conditions of time and temperature. The tensioning device of the system may permit the applied tension to be adapted to enable optimised results to be achieved for a specific precursor and/or tow size.

For a selected PAN precursor fibre, the amount of tension applied to the precursor fibre should be sufficient such that the precursor fibre is in a taut state (i.e. the precursor fibre is not slack), but is not so high that the precursor fibre breaks under the applied tension.

In one set of embodiments, the tensioning devices are adapted to apply an amount of tension to the PAN precursor is in a range of from about 50 cN to about 50,000 cN, depending on tow size. For example, a tension in a range of from about 50 cN to about 10,000 cN. For example, in some embodiments, a tension of up to 6,000 cN may be applied. In some embodiments, a tension of up to 4,000 cN may be applied.

Once a tension suitable for promoting a desired amount of nitrile group cyclisation in a given precursor is selected, in some embodiments the tension applied to the precursor remains substantially constant and fixed. Controls may be utilised to ensure that the tension is maintained within acceptable limits from the selected value, such that the precursor is processed at a substantially constant tension. This can be important to ensure tension is maintained to ensure stable precursor processing, which can facilitate continuous operation of the precursor stabilisation process and ensure consistent quality in the pre-stabilised precursor, stabilised precursor and subsequently, also in the carbon fibre

If necessary, the system may include a tension controller for controlling the tension applied by each tensioning device in order to enable the predetermined amount of tension to be applied to the PAN precursor fibre.

The amount of tension applied may be monitored by the use of a tensiometer or load cells (e.g. piezoelectric load cells). For example, each tensioning device may comprise a load cell attached to the support bearings of the fibre transport roller to sense the amount of tension being applied to the precursor.

It may be beneficial to monitor the tension as changes in the amount of tension applied over time can be indicative of pre-stabilisation process instability. In practice, applying a substantially constant amount of tension will include minor amounts of fluctuation in the tension applied. Minor amounts of fluctuation includes changes in tension of no more than 5% over a six hour period of operation of the pre-stabilisation reactor, preferably changes of no more than 2%, more preferably changes of no more than 1%. In addition, minor amounts of fluctuation do not include circumstances in which there is a persistent overall trend of change in the tension applied. For example, an overall trend of a decrease in tension that persists for six hours or more can be indicative of the precursor reaching a temperature that is too high. In particular, an overall trend of a decrease in tension of 5% or more that persists for six hours or more can be indicative of the precursor reaching a temperature that is too high such that the process is unstable and process parameters need to be altered to prevent a process failure such as precursor breakage. As decreases in tension can be indicative of the precursor reaching a temperature that is too high, it may be necessary to reduce the temperature of the process gas in the reaction chamber and/or to alter the flow rate to improve the heat transfer efficiency of the process gas flow. Alternatively or additionally, decreases in tension can be indicative of the precursor spending too long in the reactor. Accordingly, it may be necessary to adjust the rate at which the precursor passes through the reactor.

The amount of tension applied to the PAN precursor during pre-stabilisation is predetermined, and in some embodiments the applied tension is selected to maximise the extent of nitrile group cyclisation in the precursor.

In some embodiments it can be desirable for the amount of tension applied to the PAN precursor fibre to be such that the highest quantity of cyclised nitrile groups is generated in the pre-stabilised precursor fibre. This tension may be referred to as an “optimised tension” value. The optimised tension value is discussed further below. Accordingly, the extent of reaction (% EOR) of nitrile groups achievable in the PAN precursor under the substantially oxygen-free atmosphere is highest at about the optimised tension value.

It has been found that as the amount of tension applied to a given precursor fibre increases (while pre-selected conditions of temperature and dwell time in the substantially oxygen-free atmosphere remain constant), the degree of nitrile cyclisation (% EOR) as measured by FT-IR spectroscopy increases until a maxima is reached. The maxima corresponds to the highest quantity of cyclise nitrile groups produced in the precursor fibre under the pre-stabilisation conditions employed. Following the maxima, the degree of quantity of cyclised nitrile groups decrease, even as the amount of applied tension increases. The tension value at which the extent of cyclisation is at a maximum is the optimised tension for that PAN precursor.

In one set of embodiments, during the pre-stabilisation step the precursor is heated in a substantially oxygen-free atmosphere at a predetermined temperature for a predetermined time period while a substantially constant amount of tension is applied to the precursor, the tension being sufficient to form a pre-stabilised precursor having a maximum extent of nitrile cyclisation (max % EOR) as determined by FT-IR spectroscopy.

In particular embodiments the predetermined time period in which the precursor is heated to obtain a maximum extent of nitrile cyclisation (max % EOR) may be selected from no more than about 5 minutes, no more than about 4 minutes, no more than about 3 minutes or no more than about 2 minutes.

In particular embodiments, the predetermined temperature in which the precursor is heated to obtain a maximum extent of nitrile cyclisation (max % EOR) may be in a range of from about 250° C. to 400° C., or from about 280° C. to 320° C.

In particular embodiments, the tension applied to the precursor to obtain a maximum extent of nitrile cyclisation (max % EOR) may be in the range of from about 50 cN to about 50,000 cN. For example, a tension in a range of from about 50 cN to about 10,000 cN.

In one set of embodiments, pre-stabilisation using the reactor of the present invention involves heating a precursor comprising polyacrylonitrile in a substantially oxygen-free atmosphere for a time period of no more than 5 minutes while applying a substantially constant amount of tension to the precursor, the temperature at which the precursor is heated in the atmosphere and the tension applied to the precursor being sufficient to form a pre-stabilised precursor comprising at least 10% cyclised nitrile groups as determined by Fourier transform infrared (FT-IR) spectroscopy.

In a particular set of embodiments, pre-stabilisation of a PAN precursor involves heating a precursor comprising polyacrylonitrile at a temperature in a range of from about 250° C. to 400° C. in a substantially oxygen-free atmosphere for a time period of no more than 5 minutes while applying a substantially constant amount of tension to the precursor, the tension being sufficient to form a pre-stabilised precursor comprising at least 10% cyclised nitrile groups as determined by Fourier transform infrared (FT-IR) spectroscopy.

In some embodiments, the precursor comprising polyacrylonitrile is heated in the substantially oxygen-free atmosphere for a time period no more than 4 minutes, no more than 3 minutes, or no more than 2 minutes.

In some embodiments, the precursor comprising polyacrylonitrile is heated in the substantially oxygen-free atmosphere at a temperature in a range of from about 280° C. to 320° C.

In another set of embodiments, during the pre-stabilisation step the precursor is heated in a substantially oxygen-free atmosphere at a predetermined temperature for a predetermined time period while a substantially constant amount of tension is applied to the precursor, the amount of tension applied to the precursor being sufficient so as to form a pre-stabilised precursor comprising an optimum quantity of cyclised nitrile groups as determined by FT-IR spectroscopy.

In a particular embodiment, pre-stabilisation of a PAN precursor involves heating a precursor comprising polyacrylonitrile at a temperature in a range of from about 250° C. to 400° C. in a substantially oxygen-free atmosphere for a time period of no more than 5 minutes while applying a substantially constant amount of tension to the precursor, the amount of tension being selected to form a pre-stabilised precursor comprising an optimum quantity of cyclised nitrile groups as determined by Fourier transform infrared (FT-IR) spectroscopy.

As discussed herein, an optimum quantity of cyclised nitrile groups may be an amount that is up to 80%, up to 70%, up to 60, up to 50%, up to 40%, up to 30%, or up to 20% below the maximum quantity of cyclised nitrile groups that is attainable in the precursor.

In particular embodiments, the predetermined time period in which the precursor is heated to obtain an optimum quantity of nitrile group cyclisation may be selected from no more than about 5 minutes, no more than about 4 minutes, no more than about 3 minutes or no more than about 2 minutes.

In particular embodiments, the predetermined temperature in which the precursor is heated to obtain an optimum quantity of nitrile group cyclisation may be in a range of from about 250° C. to 400° C., or from about 280° C. to 320° C.

In particular embodiments, the tension applied to the precursor to obtain an optimum quantity of nitrile group cyclisation may be in the range of from about 50 cN to about 50,000 cN, or in the range of from about 50 cN to about 10,000 cN.

The amount of tension applied during pre-stabilisation facilitates rapid formation of the requisite quantity of cyclised nitrile groups in the PAN precursor fibre.

In some embodiments it may be beneficial to apply the optimised tension value to the precursor for an economical process for producing carbon material such as carbon fibre.

The tension of the precursor may be affected by a number of factors, including: the relative temperature and humidity of the precursor prior to entry to the reactor; the catenary effect, which is affected by the distance between material handling devices (e.g. rollers); the degree of shrinkage experienced by the precursor due to chemical changes occurring in the precursor; and other intrinsic material property changes that occur as the precursor is pre-stabilised.

In some embodiments, in order to apply a substantially constant amount of tension to the precursor, the draw ratio applied by the tensioning devices will be adjusted as necessary. Accordingly, in practice, for the same precursor at a given temperature and residence time in the pre-stabilisation reactor, the draw ratio applied by the tensioning devices may be varied or adjusted to account for the factors that affect the tension of the precursor so as to ensure that the desired, predetermined substantially constant tension is applied to the precursor. For example, a different draw ratio may be applied for a reactor with a relatively short distance between rollers compared to a reactor with a longer length so that the same desired predetermined substantially constant amount of tension can be applied to the precursor in each reactor.

The draw ratio is determined by the transfer speed of the tensioning device upstream of the pre-stabilisation reactor (i.e. at the inlet side) compared to the transfer speed of the tensioning device downstream (i.e. at the outlet side). When the downstream transfer speed is higher than the upstream speed, the draw ratio is positive and an elongating load is being applied to the precursor to increase the tension applied. Conversely, where the upstream speed is higher than the downstream speed, the draw ratio is negative and a compressive load is applied to the precursor to reduce the tension applied. In some embodiments, the degree of shrinkage and other intrinsic material property changes may be such that a negative draw ratio is used so as to apply the desired predetermined substantially constant tension to the precursor. In other embodiments, a positive draw ratio may be used.

In some other embodiments, the transfer speeds are selected such that a 0% draw ratio is used. Accordingly, in some embodiments, the tensioning devices located upstream and downstream of the pre-stabilisation reactor may be operated in a manner that ensures that a desired amount of tension can be applied to the precursor fibre suspended without stretching the precursor fibre. For example, drive rollers in tensioning devices located upstream and downstream of a pre-stabilisation reaction chamber may be operated at the same rotational speed to ensure the precursor fibre suspended there-between is not stretched as it travels through the reactor.

In some embodiments the tension applied to the precursor during the pre-stabilisation step is such that elongation spread (standard deviation), as determined by single filament tensile testing, is as low as possible. A small standard deviation and thus a small elongation spread can help determine whether the precursor fibres are being processed homogeneously. In one preference, the tension applied is such that the elongation spread for the pre-stabilisation step is as close possible to that of untreated (virgin) PAN precursor.

The mechanical properties of single fibre samples can be tested on a Textechno Favimat+single-filament tensile tester fitted with a ‘Robot 2’ sample loader. This instrument automatically records the linear density and force extension data for individual fibres loaded into a magazine (25 samples) with a pretension weight of (˜80-150 mg) attached to the bottom of each fibre.

In some embodiments, when determining the process conditions (i.e. temperature, time and tension) to be used for the pre-stabilisation step it can be useful to initially ascertain a baseline tension that is sufficient to facilitate transport of the precursor at a selected speed through a reaction chamber employed to perform the pre-stabilisation step. The speed at which the precursor is transported may determine the residence time of the precursor in the reaction chamber. Once the baseline tension and residence time period in the reaction chamber are determined, a temperature for heating the precursor may then be selected.

The temperature for heating the precursor in the pre-stabilisation step is sufficient to initiate or promote the cyclisation of a portion of the nitrile groups present in the precursor, but is not so high as to cause degradation of the precursor. As discussed above, the cyclisation of nitrile groups may be visually indicated as a change in the colour of the precursor from white to a colour ranging from dark yellow or orange to copper. Thus a change in the colour of the precursor provides an indication of when nitrile group cyclisation can be initiated and may be used as a visual cue for selecting the heating temperature.

In practice, to select a heating temperature, the precursor may be heated at a variety of different temperatures while the baseline tension applied to the precursor and residence time of the precursor in a reaction chamber each remain fixed. Changes in the colour of the precursor is then visually determined. The temperature at which an initial colour change in a precursor is observed may be regarded as the minimum temperature that can be used for pre-stabilising that precursor.

In one preference, the precursor is heated at a temperature that is not more than 30° C. below the degradation temperature. It has been found that when a PAN precursor is heated at a high temperature that is within 30° C. of the degradation temperature of the precursor, a colour change can occur in the precursor in a short period of time (e.g. within about 2 minutes). The colour change can be visually discerned and can be indicative of chemical changes (such as cyclisation and aromatisation reactions) occurring in the precursor.

In some embodiments, the precursor may be heated within the substantially oxygen-free atmosphere at a high temperature that is in proximity to the degradation temperature of the precursor. It is believed that heating of the PAN precursor at a high temperature that is in proximity to the precursor degradation temperature when in the substantially oxygen-free atmosphere can facilitate formation of a pre-stabilised precursor having at least 10%, and preferably between 20% to 30%, cyclised nitrile groups in a time period of less than about 5 minutes, less than about 4 minutes, less than about 3 minutes, or less than about 2 minutes.

In some embodiments, heating of the precursor at a temperature which is in proximity of the degradation temperature of the precursor can facilitate rapid formation of a pre-stabilised precursor.

Once the heating temperature is determined, the amount of tension applied to the precursor is then adjusted (e.g. increased) from the baseline value until a tension value that promotes the desired level of nitrile group cyclisation (% EOR) in the precursor under the selected heating temperature and time conditions is identified. As discussed above, the % EOR can be determined by FT-IR spectroscopy.

Once a tension value giving a desired % EOR in the precursor has been identified, tests may be performed on the resultant pre-stabilised precursor to ascertain whether the precursor has properties, such as mechanical properties (e.g. tensile properties), mass density and appearance within desired parameters. If necessary, further adjustments may be made in order to fine tune the tensioning parameters so that the amount of tension applied to the precursor is sufficient to not only form a pre-stabilised precursor having a desired level of nitrile group cyclisation (% EOR), but also a desired colour, mechanical properties, mass density and/or appearance.

In some embodiments, the precursor has the potential to attain a maximum quantity of cyclised nitrile groups and it can be desirable for the amount of tension applied to the PAN precursor fibre to be selected to promote formation of the maximum quantity of cyclised nitrile groups in the pre-stabilised precursor fibre. This tension may be referred to as an “optimised tension” value. Accordingly, the extent of reaction (% EOR) of nitrile groups achievable in the PAN precursor under the substantially oxygen-free atmosphere is highest at about the optimised tension value.

The optimised tension value may be determined by applying different quantities of substantially constant tension to the precursor fibre while pre-selected conditions of temperature and time in the substantially oxygen-free atmosphere remain constant. It has been found that as the amount of tension applied to a given precursor fibre increases, the degree of nitrile group cyclisation (% EOR) as measured by FT-IR spectroscopy increases until a maximum value is reached. The maximum % EOR corresponds to the highest quantity of cyclised nitrile groups produced in the precursor fibre under the pre-stabilisation conditions employed. Following the maximum value, the degree or quantity of cyclised nitrile groups decrease, even as the amount of applied tension increases. Thus a “bell-shaped” % EOR versus tension curve can be formed. The bell-shaped curve will generally comprise a peak % EOR, which would correspond to the maximum % EOR that is attainable for that given precursor. The tension value providing the highest extent of nitrile group cyclisation (i.e. the maximum % EOR) under the pre-selected temperature and time parameters is thus the optimised tension for that PAN precursor.

In some embodiments it may be desirable for the pre-stabilised precursor to have a maximum amount of cyclised nitrile groups to enable a stabilised precursor to be formed with improved efficiency.

The precursor may have a potential to attain a maximum amount of nitrile group cyclisation and, in some embodiments of the invention, tensioning devices are configured such that the amount of tension applied to the precursor is selected to promote maximum nitrile group cyclisation in the precursor. In such embodiments, an optimised amount of tension may thus be applied to the precursor as the precursor is heated at a selected temperature and for a selected time period in a substantially oxygen-free atmosphere so as to form a pre-stabilised precursor having a maximum quantity of cyclised nitrile groups. The optimised tension would generate at least 10% cyclised nitrile groups in the precursor, and may and preferably will, generate more than 10% cyclised nitrile groups in the precursor.

It would be appreciated that due to the slightly differing polymer compositions of PAN precursors from different commercial suppliers, a different maximum % EOR achievable for a PAN precursor and the optimised tension that can promote maximised nitrile group cyclisation can differ for different precursors. For example, PAN precursors can differ in a range of parameters, such as composition and tow size. Accordingly, it would be understood that the optimised tension and the maximum quantity of cyclised nitrile groups attainable in a precursor can vary with different precursor feedstocks. For example, for some precursor feedstocks, a potential maximum of 40% cyclised nitrile groups may be attained, while for other precursor feedstocks, a maximum of 20% cyclised nitrile groups may only be possible.

In some embodiments, there may be an acceptable operating window for the tension parameter, such that a pre-stabilised precursor having a quantity of cyclised nitrile groups which is more than 10% but less than the maximum quantity of cyclised nitrile groups attainable for that precursor, can be formed. That is, it is possible that the pre-stabilised precursor may have an intermediate quantity of cyclised nitrile groups that varies from the maximum % EOR and which is less than the maximum % EOR—but remains greater than 10%. In some embodiments, the pre-stabilised precursor may have an optimum quantity of cyclised nitrile groups, where the optimum quantity includes the maximum quantity of cyclised nitrile groups (maximum % EOR), as well as an acceptable variation thereof. Thus an “optimum quantity” may include the maximum % EOR that is attainable for a given precursor, which is obtained at an optimised tension, as well as acceptable sub-maximum values of % EOR obtained at tensions above or below the optimised tension. In the context of a % EOR versus tension curve, an “optimum quantity” of cyclised nitrile groups is a quantity within an acceptable operating window provided by a region surrounding the peak representing the maximum % EOR in a % EOR versus tension curve and which encompasses acceptable values of % EOR below the maximum % EOR.

While being at less than maximum, an optimum quantity of cyclised nitrile groups may nevertheless still facilitate efficient formation of a pre-stabilised and stabilised precursor.

The amount of variation from the maximum % EOR that qualifies as an optimum quantity of cyclised nitrile groups and which is deemed acceptable for efficient precursor processing may depend on the precursor and the value of the maximum % EOR. A skilled person would appreciate that larger variations from the maximum % EOR may be acceptable where higher values of maximum % EOR can be attained in a precursor, whereas when smaller values of maximum % EOR, are attainable, then only smaller variations from the maximum % EOR may be acceptable.

For a precursor that has a potential to attain a maximum amount of cyclised nitrile groups, in some embodiments the amount of tension applied to the precursor is selected to promote up to 80% less than the maximum attainable nitrile group cyclisation in the pre-stabilised precursor. In some embodiments, the amount of tension applied to the precursor can be selected to promote up to 70% less, up to 60% less, up to 50% less, up to 40% less, up to 30% less, or up to 20% less than the maximum attainable nitrile group cyclisation in the pre-stabilised precursor. Each of the afore-mentioned ranges may independently represent a window within which an optimum quantity of cyclised nitrile groups can be formed in a given precursor.

In one illustrative example, where the maximum amount of cyclised nitrile groups that can be achieved in a precursor is 50%, the tension applied to that precursor may be selected so as to form a pre-stabilised precursor having an amount of cyclised nitrile groups that is in a range from between 10% to 50%. Accordingly, in this example, there may be an acceptable operating range in % EOR of up to 40%. Furthermore, in this example, the amount of 10% represents the minimum quantity of cyclised nitrile that is acceptable for the pre-stabilised precursor. This value of 10% also represents an amount that is about 80% of the maximum attainable nitrile group cyclisation (i.e. 80% of 50%). An amount of cyclised nitrile groups representing an optimum quantity may be selected from those within the range of from 10-50% and a tension promoting a quantity of cyclised nitrile groups in this % EOR range may be selected in some preferences.

In another illustrative example, where the maximum amount of cyclised nitrile groups that can be achieved in a precursor is 30%, the tension applied to that precursor may be selected so as to form a pre-stabilised precursor having an amount of cyclised nitrile groups that is in a range from between 10% to 30%. Accordingly, in this example, there may be an acceptable operating range in % EOR of up to 20%. The minimum value of 10% cyclised nitrile groups therefore represents an amount that is at about 67% of the maximum attainable nitrile group cyclisation (i.e. 67% of 30%). Similar to the above illustrative example, an amount of cyclised nitrile groups representing an optimum quantity may thus be selected from those within the range of from 10-30% and a tension promoting a quantity of cyclised nitrile groups within this % EOR range may be selected in some preferences.

In yet another illustrative example, where the maximum amount of cyclised nitrile groups that can be achieved in a precursor is 20%, 80% less than the maximum attainable nitrile group cyclisation represents 4% cyclised nitrile groups. However, it would be appreciated that the value of 4% is below the minimum threshold of at least 10% cyclised nitrile groups required for the pre-stabilised precursor in accordance with the invention. In such circumstances, the acceptable operating window would therefore be restricted by the lower threshold of 10% cyclised nitrile groups, such that the tension that is applied to that precursor may only be selected to form an amount of cyclised nitrile groups that is in a range from between 10% to 20%. Thus in this example, an operating window providing only up to 50% of the maximum attainable nitrile group cyclisation (i.e. 50% of 20%) is acceptable. Thus an amount of cyclised nitrile groups in the range of from 10-20% can represent an optimum amount of cyclised nitrile groups and a tension promoting a quantity of cyclised nitrile groups within this % EOR range may be selected in some preferences.

In some embodiments, the pre-stabilised precursor may have at least 15% or at least 20%, cyclised nitrile groups as a lower threshold (or minimum) quantity of cyclised nitrile groups. In such embodiments, the amount of acceptable variation from the maximum % EOR may be within a smaller window. For example, where the maximum amount of cyclised nitrile groups that can be achieved in a precursor is 50% and a minimum of 15% nitrile group cyclisation is required in the pre-stabilised precursor formed, the tension applied to that precursor may be selected so as to form an amount of cyclised nitrile groups that is in a range from between 15% to 50%. Accordingly, in this example, there may be an acceptable operating range in % EOR of up to 35%. Thus the minimum extent of nitrile cyclisation of 15% represents an amount that is at about 70% of maximum nitrile group cyclisation (i.e. 70% of 50%).

In embodiments where a desired amount of cyclised nitrile groups, which is greater than 10% but less than the potential maximum amount of cyclised nitrile groups attainable in a precursor is desired in the pre-stabilised precursor, the amount of tension that is applied to the precursor can vary from the optimised tension value for that precursor in order to promote formation of the desired quantity of cyclised groups. A variation from optimised tension may be a tension value that is above or below the optimised tension value which promotes maximum nitrile group cyclisation.

In one set of embodiments, an amount of tension varying by up to 20% from the optimised tension can be applied to the precursor when it is heated in a substantially oxygen-free atmosphere at a selected temperature and for a selected time period, to form a pre-stabilised precursor having at least 10% cyclised nitrile groups. In other embodiments, an amount of tension varying by up to 15%, or by up to 10%, from the optimised tension can be applied to the precursor to form a pre-stabilised precursor having at least 10% cyclised nitrile groups.

Use of the reactor of the present invention may comprise a step of determining a tension parameter for a precursor prior to forming the pre-stabilised precursor, wherein determining the tension parameter for the precursor comprises:
selecting a temperature and time period for heating a precursor in a substantially oxygen-free atmosphere;
applying a range of different substantially constant amounts of tension to the precursor while heating the precursor in the substantially oxygen-free atmosphere at the selected temperature and for the selected time period;
determining by Fourier transform infrared (FT-IR) spectroscopy the amount of cyclised nitrile groups formed in the precursor for each substantially constant amount of tension applied to the precursor;
calculating a trend of extent of nitrile group cyclisation (% EOR) versus tension;
identifying, from the calculated trend, the amounts of tension providing at least 10% nitrile group cyclisation and maximum nitrile group cyclisation; and
selecting an amount of tension giving rise to at least 10% nitrile group cyclisation to pre-stabilise the precursor.

Determination of a tension parameter is ideally performed for a precursor prior to carrying a stabilisation process (including a pre-stabilisation process conducted using the reactor of the invention) in relation to that precursor. Suitably, the determination of the tension parameter will be performed prior to forming a pre-stabilised precursor from that precursor.

The determination of the tension parameter will facilitate the identification and selection of an appropriate amount of tension to promote a desired extent of nitrile group cyclisation in a given precursor under selected temperature and time period conditions. This can enable a pre-stabilised precursor having a desired amount of cyclised nitrile groups to be formed when the precursor is heated in a substantially oxygen-free atmosphere under the selected temperature and time period as part of the stabilisation process using the reactor of the present invention.

The determination of a tension parameter may facilitate identification of an amount of tension that can promote formation of (i) of at least 10% cyclised nitrile groups in a given precursor, (ii) the maximum attainable amount of cyclised nitrile groups in the precursor, and (iii) intermediate quantities of cyclised nitrile groups that occur in between 10% and the maximum amount attainable, in a precursor when the precursor is heated in a substantially oxygen-free atmosphere under selected temperature and time parameters.

Thus the above tension parameter determination steps may be employed to assist in screening for an amount of tension that will achieve a desired extent of nitrile group cyclisation (% EOR) in a pre-stabilised precursor that is to be generated from the precursor being assessed.

Determination of a tension parameter for a precursor involves applying a range of different substantially constant amounts of tension to the precursor as it is heated in the substantially oxygen-free atmosphere at the selected temperature and for the selected time period. Accordingly, the temperature and time period for heating the precursor each remain fixed at the selected value during this assessment.

Determination of the tension parameter involves the application of different amounts of substantially constant tension to the precursor fibre while the selected conditions of temperature and time for heating the precursor in the substantially oxygen-free atmosphere each remain fixed at the selected values. In practice, it is useful to apply an initial tension to the precursor, which may be a baseline tension. As discussed above, a baseline tension is one that is sufficient to facilitate conveyance of the precursor through the pre-stabilisation reactor. The amount of tension applied to the precursor can then be incrementally increased from the initial (e.g. baseline) value. The amount of cyclised nitrile groups (% EOR) formed in the precursor as a range of different substantially constant amounts of tension are applied to the precursor is then determined by FT-IR spectroscopy.

Once data relating to the amounts of cyclised nitrile groups (% EOR) formed at different applied amounts of tension is collected, a trend of extent of nitrile group cyclisation (% EOR) versus tension may then be calculated. In some embodiments, calculation of a trend of extent of nitrile group cyclisation (% EOR) versus tension can involve generation of a graph illustrating a % EOR versus tension curve.

From the calculated trend of extent of nitrile group cyclisation (% EOR) versus tension, it is then possible to identify the amounts of tension that promote (i) at least 10% nitrile group cyclisation, (ii) maximum nitrile group cyclisation, and (iii) intermediate quantities of nitrile cyclisation in between 10% and the maximum attainable, in the precursor. For example, in some embodiments, it is possible to identify from the calculated trend an amount of tension that may promotes formation of between from 20% to 30% cyclised nitrile groups in the precursor.

Once an amount of tension that gives rise to, or promotes formation of, a desired, selected % EOR in the precursor under a selected temperature and time period been identified from the calculated trend, that amount of tension may be selected for use in pre-stabilisation of the precursor.

In general, an amount of tension promoting at least 10% nitrile group cyclisation is selected to pre-stabilise the precursor in the pre-stabilisation step described herein.

In some embodiments, an amount of tension promoting from 10% to 50%, from 15% to 45%, or from 20% to 30%, nitrile group cyclisation is selected to pre-stabilise the precursor in the pre-stabilisation step using the reactor described herein.

In yet other embodiments, an amount of tension promoting up to 80%, up to 70%, up to 60%, up to 50%, up to 40%, up to 30%, or up to 20% less than the maximum nitrile group cyclisation attainable in the precursor is selected to pre-stabilise the precursor in the pre-stabilisation step using the reactor described herein.

In other embodiments, an amount of tension promoting maximum nitrile cyclisation is selected to pre-stabilise the precursor in the pre-stabilisation step described herein.

In addition to the selected tension parameter (which has been determined in accordance with the steps above) being employed when pre-stabilising a precursor using the reactor, the temperature and time period utilised when determining the tension parameter would also be employed for pre-stabilisation of the precursor using the reactor. This is because a desired tension parameter for suitably forming a pre-stabilised precursor having a requisite quantity of cyclised nitrile groups can vary if different temperature and/or time period conditions are used for pre-stabilisation of a given precursor.

In one set of embodiments, pre-stabilisation of a PAN precursor involves heating a precursor comprising polyacrylonitrile in a substantially oxygen-free atmosphere for a time period of no more than 5 minutes while applying a substantially constant amount of tension to the precursor, the temperature at which the precursor is heated in the substantially oxygen-free atmosphere and the amount of tension applied to the precursor being sufficient to form a pre-stabilised precursor comprising at least 10% cyclised nitrile groups as determined by Fourier transform infrared (FT-IR) spectroscopy.

As discussed above, tension applied to the precursor can control the extent of nitrile group cyclisation in the precursor and thus enable a desired quantity of cyclised nitrile groups to be achieved. In some embodiments of the pre-stabilisation process described herein, the tension applied to the precursor is sufficient to form a pre-stabilised precursor having at least 15%, and preferably from between 20-30%, cyclised nitrile groups as determined by FT-IR spectroscopy.

In one set of embodiments, during the pre-stabilisation step the precursor is heated in a substantially oxygen-free atmosphere at a predetermined temperature for a predetermined time period while a substantially constant amount of tension is applied to the precursor, the amount of tension being sufficient to form a pre-stabilised precursor having at least 10% cyclised nitrile groups as determined by FT-IR spectroscopy. A skilled person would appreciate that the value of 10% represents the minimum amount of cyclised nitrile groups in the pre-stabilised precursor and that higher amounts of cyclised nitrile groups may be formed in the pre-stabilised precursor. For example, the pre-stabilised precursor may have from 20-30% cyclised nitrile groups. In some embodiments, the pre-stabilised precursor may have from 10-50%, from 15-40%, or from 20-30% cyclised nitrile groups, as determined by FT-IR spectroscopy.

In some embodiments, the apparatus or system of the present invention may comprise an in-line reflectance FT-IR spectrometer that is disposed downstream of the outlet of the pre-stabilisation reactor so as to monitor the percentage of cyclised nitrile groups in the pre-stabilised precursor that is output from the reactor. The in-line reflectance FT-IR spectrometer may be disposed so that measurements can be taken as the pre-stabilised precursor travels between the outlet and the first roller downstream of the outlet. Accordingly, an in-line FT-IR reflectance spectrometer may be upstream of a tensioning device or materials handling device located downstream of the pre-stabilisation reactor.

The FT-IR spectroscopy data may be provided to a control unit. Alternatively or additionally, temperature measurements from any thermocouples and/or gas velocity measurements from any gas velocity sensors may be provided to the control unit. Furthermore, tension measurements from any tensiometer or load cells of the tensioning devices may be provided to the control unit. In addition, data from any other sensors included in the reactor can be provided to the control unit. Such sensors may include gas sensors, such as HCN gas and/or oxygen sensors that may be provided to sense the efficacy of the gas seals of the reactor.

Software-based algorithms may be used to analyse the data provided to the control unit. Thus, the control unit may be used to automatically assess whether one or more parameters should be adjusted, including any one or more of the following: the temperature of one or more of the process gas, sealing gas and cooling gas; the temperature of any heating elements in the reactor; the flow rate of the process gas through the reaction chamber; the amount of exhaust extracted from the reactor; the supply rate of process gas, sealing gas and cooling gas to any inlet; the speed at which the precursor is conveyed through the reactor; and the tension applied to the precursor. Software may direct automatic adjustment of the aforementioned parameters to optimise operation of the reactor. The control system may run continuously during the pre-stabilisation process thereby ensuring that optimal conditions are maintained.

If desired, the pre-stabilised precursor fibre may optionally be collected prior to being exposed to an oxygen-containing atmosphere. For example, the pre-stabilised precursor fibre may be collected on spools.

However, it is believed that the pre-stabilised precursor is activated for the oxidative treatment step due at least in part, to partial cyclisation of the PAN precursor during pre-stabilisation. Because of this activation, the pre-stabilised precursor may be chemically unstable and susceptible to further reaction when in an oxygen-containing environment (such as air). For instance, it is believed that dihydropyridine structures that can be produced in an inert atmosphere can be prone to reaction through free radical auto-oxidation when exposed to oxygen. Due to this instability, it may therefore be advantageous to expose the pre-stabilised precursor to an oxygen-containing atmosphere under suitable conditions for stabilisation immediately or shortly after its formation, rather than storing the pre-stabilised precursor. If storage of the pre-stabilised precursor is desired, it can be beneficial for storage to be effected in a substantially oxygen-free atmosphere, such as an atmosphere comprising an inert gas.

Pre-stabilised precursors obtained from the pre-stabilisation step are believed to be more thermally stable than virgin PAN precursors, and may have lower exothermicity as determined by differential scanning calorimetry (DSC). It is believed that the decrease in exothermic behaviour for the pre-stabilised precursor is at least partially due to the presence of cyclised nitrile groups in the pre-stabilised precursor. Translated to a carbon fibre manufacturing process, the reduction of energy released during processing of the PAN precursor would allow better control of further oxidative exothermic reactions, thus enhancing the safety of carbon fibre manufacture.

The present invention provides an apparatus and system in which a pre-stabilised precursor produced using the reactor can be exposed to an oxygen-containing atmosphere under conditions that are sufficient to form a stabilised precursor. Thus, by using the stabilisation apparatus and system of the present invention, the pre-stabilised precursor can be converted into a stabilised precursor. This step of the processes described herein may also be referred to herein as an “oxidation” or “oxidising” step.

In the present invention, the apparatus and system may comprise an oxidation reactor downstream from the reactor, the oxidation reactor comprising at least one oxidation chamber adapted to stabilise the pre-stabilised precursor in an oxygen-containing atmosphere as the pre-stabilised precursor is passed through the oxidation chamber(s).

During the oxidation step, pendant nitrile groups in the PAN that had not cyclised during the pre-stabilisation step can now undergo cyclisation. The oxidation step therefore increases the quantity of cyclised nitrile groups (and hence the quantity of hexagonal carbon-nitrogen rings) relative to that of the pre-stabilised precursor fibre, leading to a higher proportion of ladder-type structures in the precursor. By increasing the quantity of cyclised nitrile groups, the precursor acquires increased thermal stability and is suitably prepared for the subsequent carbonisation process described herein which can be used to form a carbon-based material such as carbon fibre.

A stabilised precursor comprising a high proportion of cyclised nitrile groups can be beneficial to enable the formation of a high quality carbon material with desirable physical and mechanical properties, including tensile properties. In some embodiments, the stabilised precursor may comprise at least 50% cyclised nitrile groups, preferably at least 60% cyclised nitrile groups. The stabilised precursor may comprise up to about 85% cyclised nitrile groups. In particular embodiments, the stabilised precursor may comprise from about 65% to 75% cyclised nitrile groups.

Through the use of the reactor of the present invention to form a pre-stabilised precursor comprising at least 10% cyclised nitrile groups, it may be possible to obtain a desired quantity of cyclised nitrile groups in the stabilised precursor in less time and with concomitant lower energy consumption and cost.

A skilled person would understand that during the oxidising step, additional chemical reactions, such as dehydrogenation and oxidation reactions and intermolecular crosslinking reactions might also occur. Dehydrogenation reactions along the polymer backbone can lead to the formation of conjugated electron systems and condensed ring structures, while oxidation reactions can result in the formation of carbonyl and hydroxyl functionalities.

The oxygen-containing atmosphere to which the pre-stabilised precursor is exposed to during the oxidation step comprises a suitable amount of oxygen.

The oxygen-containing atmosphere may comprise only oxygen (i.e. molecular oxygen or O₂) or it may comprise oxygen in combination with one or more gases in admixture. In some embodiments, the oxygen concentration of the oxygen-containing atmosphere is 5% to 30% by volume.

In one embodiment, the oxygen-containing atmosphere is air. A skilled person would understand that the oxygen content of air is approximately 21% by volume.

In one set of embodiments a flow of an oxygen containing gas, such as air, may be used to establish the oxygen containing atmosphere.

The exposure of the pre-stabilised precursor to an oxygen-containing atmosphere may proceed for a desired period of time and at a desired temperature sufficient to form a stabilised precursor. Additionally, in some embodiments tension may also be applied to the pre-stabilised precursor during the oxidation step.

Similarly to the pre-stabilisation step, a number of indicators can be used to guide the selection of the process conditions (i.e. temperature, time and tension) used during the oxidation step to convert a pre-stabilised precursor to a stabilised precursor. The indicators may be considered separately or in combination. The oxidation process conditions can be selected to aid in the formation of a stabilised precursor fibre having desirable properties.

The choice of oxidation process conditions used for converting the pre-stabilised precursor into a stabilised precursor may in some embodiments depend on outcomes desired in relation to one or more of the following indicators produced in the fully stabilised precursor: mechanical properties of the precursor (including tensile properties of ultimate tensile strength, tensile modulus, and elongation to break), precursor fibre diameter, mass density of the precursor, the extent of nitrile group cyclisation (% EOR), and precursor appearance (e.g. formation of a skin-core morphology). The process conditions employed during oxidation can be adjusted in order to promote the evolution of one or more of the above indicators to achieve desirable outcomes in the stabilised precursor produced at the conclusion of the oxidation step.

In some embodiments it can be desirable for process conditions employed in the oxidation reactor during the oxidation step to be selected to produce a stabilised precursor having desirable tensile properties.

For instance, in some embodiments, it can be desirable for process conditions employed in the oxidation reactor during the oxidation step to be selected so as to produce a minimum value of ultimate tensile strength and/or tensile modulus in the stabilised precursor generated from the oxidation step, as low tensile strength and tensile modulus can provide an indication of a high extent of precursor stabilisation.

Further, in some embodiments it can be desirable for process conditions employed during oxidation to be selected to produce a maximum elongation to break value in the stabilised precursor generated from the oxidation.

The oxidation reactor may be configured to enable oxidation process conditions (i.e. temperature, time period and tension) employed to convert a pre-stabilised precursor in to a stabilised precursor to be selected to suitably promote chemical reactions, including nitrile group cyclisation and dehydrogenation, during the oxidation step that assist with formation of a stabilised precursor having desired tensile properties.

As an example, it has been found that under fixed temperature and time conditions during the oxidation step, the properties of ultimate tensile strength and tensile modulus of a PAN precursor can each decrease as increasing amounts of tension are applied to a pre-stabilised precursor. The decreases in ultimate tensile strength and tensile modulus continue until a minimum value for each property is reached. Thereafter, further increases in the amount of tension applied to the precursor results in an increase in ultimate tensile strength and tensile modulus.

Similarly, at fixed temperature and time conditions during the oxidation step, elongation to break of the stabilised PAN precursor can increase as increasing amounts of tension applied to the pre-stabilised precursor during oxidation, until a maximum elongation to break value is achieved. Above the maximum value, elongation to break will start to decrease with respect to a corresponding increase in applied tension. In some embodiments it can be desirable for process conditions employed during the oxidation step to be selected so as to produce a maximum elongation to break value in the stabilised precursor formed from the oxidation step.

Precursor fibre diameter can also decrease as a result of the oxidation step. The decrease of the fibre diameter is the result of a combination of weight loss and fibre shrinkage induced by chemical reactions. In some embodiments the diameter of the fibre can be influenced by tension applied to the precursor during the oxidation step.

With the progress of stabilisation and evolution of ladder-like structures during the oxidation step, the mass density of the precursor increases during oxidation and can follow a linear trend. Thus, the mass density of a fully stabilised precursor may be used as an indicator to help guide the selection of process conditions for the oxidation step.

In some embodiments, process conditions selected for the oxidation step are sufficient to from a stabilised precursor having a mass density in the range of from about 1.30 g/cm³ and 1.40 g/cm³. A stabilised precursor having a mass density in such ranges may be suitable for the manufacture of high performance carbon fibre.

Another indicator that may be used for the selection of oxidation process conditions is the extent of nitrile group cyclisation (% EOR) in the stabilised precursor. The extent of reaction (% EOR) provides a measurement of the proportion of cyclic structures in the stabilised precursor. Together with knowledge of the % EOR produced during the pre-stabilisation step, this indicator can allow one to determine how much cyclisation occurred during the oxidative stabilisation process.

In some embodiments, process conditions selected for the oxidation step are sufficient to form a stabilised precursor having at least 50% cyclised nitrile groups, preferably at least 60% cyclised nitrile groups. A stabilised precursor may have up to about 85% cyclised nitrile groups. In one set of embodiments, process conditions selected for the oxidation step are sufficient to form a stabilised precursor having from about 65% to 75% cyclised nitrile groups. The extent of nitrile group cyclisation in the stabilised precursor is determined using FT-IR spectroscopy in accordance with procedures described herein.

It is one advantage of the process using the reactor of the present invention that a stabilised precursor having at least 60%, preferably at least 65%, cyclised nitrile groups can be rapidly formed in a shorter period of time, compared to alternative stabilisation processes

In some embodiments, low density stabilised precursors can be formed by a stabilisation process using the reactor of the invention, such as the stabilisation apparatus or system described herein. It has been found that a low density, stabilised precursor can be formed by subjecting pre-stabilised precursors as described herein to the oxidative stabilisation conditions described herein. Such low density stabilised precursors can have at least 60%, at least 65%, or at least 70%, cyclised nitrile groups and a mass density in the range of from about 1.30 g/cm³ and 1.33 g/cm³. It has been found that such low density stabilised precursors are sufficiently thermally stable and can be carbonised and converted into a carbon-based material, such as carbon fibre, having acceptable properties. It is believed that a stabilisation process, using the reactor of the invention to perform a pre-stabilisation step, may produce unique low density stabilised precursors.

A further indicator that may be used to help guide the selection of oxidation process conditions is the appearance of the fully stabilised precursor. For instance, it can be desirable to select process conditions to limit or avoid the formation of a skin-core cross-sectional morphology in the stabilised precursor, as skin-core formation is a result of non-homogeneous stabilisation from the skin of the precursor to its core. However, in some embodiments, fully stabilised precursors formed in accordance with the process described herein may have skin-core cross-sectional morphology. Furthermore, fully stabilised PAN precursors prepared in accordance with embodiments described herein are preferably substantially defect-free and have an acceptable appearance. It is considered that defects, including melting of the precursor or partial tow breakage, could lead to low mechanical properties or even failure in a carbon material prepared with the stabilised precursor.

Stabilised precursors formed in accordance with the stabilisation process described herein are thermally stable and are resistant to combustion when exposed to a naked flame. The stabilised precursors are moreover capable of being carbonised for conversion into a carbon-based material such as carbon fibre.

The oxidation step may be performed at room temperature (approximately 20° C.), but preferably is performed at elevated temperature.

For a precursor fibre that has been subjected to pre-stabilisation, the oxidation step can be carried out at a lower temperature than that conventionally used for the production of a stabilised precursor.

In some embodiments of the precursor stabilisation process described herein, the oxidation step for forming a stabilised precursor can be performed at a temperature that is at least 20° C. lower than that used in a conventional or alternative stabilising process that does not utilise a pre-stabilisation step.

The ability to perform the oxidation step at lower temperature can be advantageous as it can help to reduce risks associated with uncontrolled heat evolution and thermal runaway, which can be produced due to chemical reactions occurring during precursor stabilisation. Moreover, by lowering the temperature at which oxidation step is performed, the amount of energy required to stabilise a precursor may also be reduced.

For instance, it is believed that pre-stabilised precursors are sensitive to oxygen and are under an “activated state”, whereby it is reactive to oxygen. Thus, this may shorten the time period required for precursor stabilisation, which would result in significant energy savings and manufacturing cost reduction.

In particular, when a pre-stabilised precursor with a high content of cyclised nitrile groups is exposed to an oxygen containing atmosphere, it has been found that oxidative reactions leading to full stabilisation of the precursor can be completed within a shorter time period. Thus by initially forming a pre-stabilised precursor having at least 10%, at least 15%, or at least 20%, cyclised nitrile group, the rate of oxidative stabilisation reactions and further nitrile group cyclisation in the precursor can be increased when the pre-stabilised precursor is exposed to an oxygen containing atmosphere, thus enabling the time period required for formation of the stabilised precursor to be reduced.

In some embodiments, the oxidation step is performed at an elevated temperature.

The temperature the precursor is subjected to during the pre-stabilisation and oxidation steps, as well as the tension applied to the precursor during these steps can also facilitate the rapid formation of a stabilised precursor that is suitable for use in the manufacture of a carbon material, such as carbon fibre.

In one set of embodiments, the pre-stabilised precursor is exposed to an oxygen containing atmosphere at a predetermined temperature for a predetermined period of time.

The predetermined temperature may be a temperature in a range from room temperature (about 20° C.) up to about 300° C., preferably a temperature in a range of from about 200° C. to 300° C.

The predetermined time period may be selected from the group consisting of no more than about 120 minutes, no more than about 90 minutes, no more than about 60 minutes, no more than about 45 minutes, no more than about 30 minutes, and no more than about 20 minutes.

When the pre-stabilised precursor is exposed to an oxygen containing atmosphere at a predetermined temperature for a predetermined period of time, tension may be applied to the pre-stabilised precursor while in the oxygen containing atmosphere in order to promote the evolution of one or more of the indicators described above and thus help form a stabilised precursor having desirable properties suitable for carbon fibre manufacture.

In one embodiment, the apparatus of the present invention includes an oxidation reactor for heating the pre-stabilised precursor in an oxygen-containing atmosphere when performing the oxidation step. In one preference, the oxygen containing atmosphere comprises at least 10% oxygen by volume. The oxygen-containing atmosphere may comprise a suitable amount of oxygen. In one embodiment, the oxygen-containing atmosphere is air.

One skilled in the art would appreciate that oxidative stabilisation reactions occurring during the oxidation step may consume oxygen atoms. As a result, the content of oxygen in the oxygen containing atmosphere may be less than the oxygen content in the gas employed to establish the oxygen containing atmosphere.

In some embodiments, there may be a supplementary gas inlet to provide more oxidation gas as necessary to compensate for the consumption of oxygen in the oxidation process. Alternatively, the supplementary gas inlet may be used to add gas of a different composition to the oxidation gas to provide the desired gas composition within the oxidation chamber. For example, in some embodiments, a gas mixture rich in oxygen may be introduced to compensate for higher than anticipated levels of oxygen consumption. In some embodiments, the forced gas flow assembly of the oxidation reactor may comprise at least one return duct arranged to receive oxygen-containing gas from the oxidation chamber and return oxygen-containing gas to the oxidation chamber to recirculate oxygen-containing gas through the oxidization chamber. In those embodiments, the supplementary gas inlet may be for providing gas to the return duct. In such embodiments, the supplementary gas can flow into the oxidation reactor with the recirculating flow of oxygen-containing gas. In some embodiments, there may be a supplementary gas inlet, controlled by a valve or damper, to provide more oxidation gas as necessary to compensate for the consumption of oxygen in the oxidation process.

In one preference, the pre-stabilised precursor is heated in air using an oxidation reactor in order to form a stabilised precursor.

The oxidation step may be performed at a temperature that is higher or lower than that of pre-stabilisation step. Alternatively, the oxidation step may be performed at a temperature that is approximately the same as that employed for the pre-stabilisation step.

In a specific embodiment, the pre-stabilised precursor is heated in the oxygen-containing atmosphere at a temperature that is lower temperature than that of the substantially oxygen-free atmosphere in the reactor. That is, the oxidation step may be performed at a temperature that is lower than that of the pre-stabilisation step.

In one form, the oxidation step is performed at a temperature that is above ambient room temperature and is below the temperature employed in the pre-stabilisation step.

In some embodiments, the pre-stabilised precursor may be heated in the oxygen-containing atmosphere at a temperature that is at least 20° C. lower temperature than that used in the pre-stabilising step.

In one preference, the pre-stabilised precursor fibre is heated in the oxygen-containing atmosphere at a temperature in a range of from about 200 to 300° C.

When the oxidation step is performed at an elevated temperature, the pre-stabilised precursor may be heated under a substantially constant temperature profile or a variable temperature profile.

In one set of embodiments, the pre-stabilised precursor is heated under a variable temperature profile. For example, the pre-stabilised precursor may initially be heated at a selected temperature, and then the temperature may increase as the oxidation step proceeds.

As an example, the pre-stabilised precursor may initially be heated at a temperature of about 230° C., with temperature increasing to about 285° C. during the oxidation step.

The heating of the pre-stabilised precursor may take place in a suitably heated oxidation reactor.

In some embodiments, suitable oxidation reactors include conventional oxidation reactors such as those well known in the art. In these embodiments, the operating parameters of the oxidation reactor will be adjusted as described above to oxidise the pre-stabilised precursor. Thus, in some embodiments, the pre-stabilisation reactor will form part of a carbon fibre production system that is otherwise made of conventional components.

An exemplary oxidation reactor may be a furnace or oven that is adapted to contain an oxygen-containing atmosphere such as air.

As explained in further detail below, a flow of an oxygen-containing gas may be used to establish the oxygen-containing atmosphere in the oxidation chamber.

Known carbon fibre production systems typically include several oxidation chambers in order to provide the reaction time for conventional stabilisation of the precursor. As noted above, conventional stabilisation can take a number of hours to complete and, as a result, precursor stabilisation can be a time and energy intensive step in carbon fibre manufacture. However, the pre-stabilised precursor produced using the reactor of the present invention may be activated for the oxidation step due to the partial cyclisation of nitrile groups in the PAN precursor fibre during the pre-stabilisation step. Thus, pre-stabilisation can enable a stabilised precursor to be formed more rapidly. Accordingly, by using the reactor of the present invention, less oxidation chambers may be required for the production system.

In some embodiments, the pre-stabilisation reactor will be retrofit to an existing carbon fibre production system. Through the addition of the reactor of the present invention, the efficiency and capacity of the carbon fibre production system may be improved.

In order to be retrofit to an existing carbon fibre production system, the reactor is located between the source of virgin precursor and the existing oxidation chambers. Typically, the space between the precursor source and the oxidation chambers is limited. In order to provide a suitable reactor for locating in a limited space, the present invention provides, in some embodiments, a vertical reactor. By orientating the reactor vertically, the footprint of the reactor can be minimised so that is can be located in the limited space between the precursor source and the oxidation chambers.

In commercial scale systems, the space between the precursor source and the oxidation chambers is such that the footprint of the reactor is about 1,500 mm to 2,000 mm long, with the width of the reactor corresponding to the width of the existing oxidation chambers so that a consistent width of precursor can be treated throughout the system.

For smaller scale systems, the footprint of the reactor may be less than 1,000 mm long. In some embodiments, the footprint may be as low as 600 mm long. The width of the reactor may be as low as 1,000 mm.

In some embodiments, the vertical reactor includes one or more internal rollers so as to provide the desired flow path for the precursor. Arrangements of internal rollers as described above may be used in the vertical reactor. For example, in some embodiments of the vertical reactor, the inlet and the outlet are located at the lower end of the reactor, the reactor further comprising a roller for passing the precursor from the inlet to the outlet and through the reaction chamber, wherein the roller is located at an upper end of the reactor and is for being disposed in the substantially oxygen-free atmosphere. That is, in some embodiments, the reaction chamber is vertically-orientated; the reactor has a lower end and an upper end; the inlet and the outlet are located at the lower end of the reactor; and the reactor further comprises a roller for passing the precursor through the reaction chamber from the inlet to the outlet, wherein the roller is located at the upper end of the reactor and is for being disposed in the substantially oxygen-free atmosphere.

In some embodiments, there may be provided a vertical reactor (i.e. a reactor in which the reaction chamber(s) is vertically-orientated) for which the inlet is located at one end of the reactor and the outlet is located at the other end of the reactor. In these embodiments, the vertical reactor may not be provided with an internal roller at the upper end of the reactor as the reactor length may be sufficient to provide the desired residence time. Typically, such embodiments are limited to an effective heated length of 10,000 mm due to the ceiling heights of production facilities.

In some embodiments, the vertical reactor may have a height of up to 17,000 mm. However, in general, vertical embodiments are often limited to a height of 10,000 mm due to the ceiling heights of production facilities. Furthermore, as the vertical reactor becomes taller, additional support must be provided to ensure stability of the reactor, particularly due to the small footprint of the reactor.

It will be appreciated that vertical reactors are not limited to being retrofit to existing carbon fibre production systems.

The present invention also provides an apparatus for stabilising a precursor for a carbon fibre, the apparatus comprising: a reactor for producing a pre-stabilised precursor according to the present invention; and an oxidation reactor downstream from the reactor, the oxidation reactor comprising at least one oxidation chamber adapted to stabilise the pre-stabilised precursor in an oxygen-containing atmosphere as the pre-stabilised precursor is passed through the oxidation chamber(s). This oxidation reactor may be adapted for use in combination with the reactor of the present invention.

As described above, the residence time for pre-stabilisation is typically shorter than the residence time for oxidation. In a system for the continuous production of a stabilised precursor, including a system for the continuous production of carbon fibre, the precursor will be fed throughout the system at a common feed rate. In practice, that system line speed will be selected so as to deliver the desired production rate of stabilised precursor and/or carbon fibre.

As the precursor is passing through the reactor for pre-stabilisation at the same rate as it passes through the oxidation reactor, the greater residence time for oxidation is provided by increasing the distance along which the precursor travels through an oxidation reactor relative to the distance the precursor travels through the pre-stabilisation reactor. This may be achieved by adjusting one or more of the length of the oxidation chamber relative to the reaction chamber for pre-stabilisation, adjusting the number of oxidation chambers, adjusting the number of passes through each oxidation chamber, and adjusting the number of oxidation reactors. For example, in some embodiments the system may have a single reaction chamber and a single oxidation chamber, but the oxidation chamber will be longer than the reaction chamber so as to provide the longer residence time for oxidation. In some other embodiments the oxidation reactor will include plural oxidation chambers in order to provide the desired residence time.

In some embodiments, the present invention provides an embodiment of the apparatus in which the pre-stabilisation reactor and the oxidation reactor are stacked. In some embodiments, the pre-stabilisation reactor may be located beneath the oxidation reactor. In other embodiments, the pre-stabilisation reactor may be located above the oxidation reactor.

Such a stacked arrangement may provide a stabilisation apparatus that is relatively more compact than the oxidation chambers used in conventional carbon fibre production systems. In some embodiments, the stabilisation apparatus may be configured to fit within a standard 40-foot shipping container. As used herein, “standard 40-foot shipping container” is taken to include in particular 40-foot containers of the type used in large numbers for transport of goods by sea. The containers in question are the subject of International Standards Organisation (ISO) standards and are available in the following size: length: 40 feet (12,192 mm); width 8 feet (2,438 mm); height 8 feet 6 inches (2,591 mm) or 9 feet 6 inches (2,896 mm). Accordingly, in some embodiments, the stabilisation apparatus may have a volume less than a volume 12,056 mm (length)×2,347 mm (width)×2,684 mm (height). Such an apparatus may be suitable for production volumes of up to 1,500 tonne per year.

An apparatus with a compact size may advantageously simplify transport logistics and the ease of construction of a production facility.

In addition, the apparatus of the present invention may have a smaller footprint than the conventional oxidation chamber(s) required to stabilise a precursor at the same production volume. Accordingly, production volumes that may be achieved per unit area of a production facility may be increased through use of the present invention. Thus, the size requirements for a production facility may be reduced.

As noted above, the residence time in the oxidation reactor is typically longer than the residence time in the pre-stabilisation reactor. In embodiments with stacked arrangements, it is desirable to use a consistent precursor velocity throughout the stabilisation apparatus. Also, in embodiments with stacked arrangements, the overall length of the oxidation reactor may be limited to the length of the pre-stabilisation reactor. Thus, in some embodiments, the flow path of the precursor through the oxidation reactor will be selected so as to provide the desired longer residence times. In practice, the precursor will pass through the one or more oxidation chambers so that there are more passes though the oxidation reactor than the pre-stabilisation reactor.

The ratio of pre-stabilisation passes to oxidation passes will reflect the relative residence times for pre-stabilisation and oxidation. This ratio will vary subject to the precursor type, as well as the process conditions used for each of the pre-stabilisation and oxidation steps. In some embodiments, the ratio of passes may be about 1:8.

In general, the oxidation chamber of the oxidation reactor suitable for use with the reactor of the present invention is adapted to stabilise the precursor in an oxygen-containing atmosphere as the precursor is passed through the oxidation chamber. The precursor will enter the oxidation reactor via an inlet before typically passing through an inlet vestibule and then entering the oxidation chamber. After passing through the oxidation chamber the precursor will typically pass through an outlet vestibule, before exiting via the outlet.

The heating of the pre-stabilised precursor fibre in the oxygen-containing atmosphere may proceed for a desired amount of time and at a desired temperature. The desired residence time in the oxidation chamber can be affected by the temperature within the chamber and vice versa. For example, in embodiments where a higher temperature is used, it may be desirable to shorten the residence time in the oxidation chamber compared to embodiments where a lower temperature is used.

The oxidation reactor of the present invention typically comprises an oxidation gas delivery system for delivering oxygen-containing gas to the oxidation chamber, the gas delivery system including a forced gas flow assembly for providing a flow of heated oxygen-containing gas in the or each oxidation chamber to heat the pre-stabilised precursor in the oxygen-containing atmosphere.

Similarly to the forced gas flow in the reactor, the flow of heated oxygen-containing gas is used to bring the pre-stabilised precursor up to reaction temperature. The oxygen-containing gas may also be referred to herein as an “oxidation gas”.

During oxidation, exothermic energy will still be released as nitrile groups in the precursor that did not cyclise during the pre-stabilisation step now undergo cyclisation. If unmanaged, the amount of exothermic energy released can cause the temperature of the pre-stabilised precursor to increase significantly, damaging the pre-stabilised precursor and posing a fire-risk. To avoid thermal runaway, the temperature and flow rate of the heated oxidation gas is selected to maintain the temperature of the pre-stabilised precursor within acceptable limits. Accordingly, the gas flow can be used to control the temperature of the precursor as it passes through the oxidation chamber. A heated gas flow may further assist to promote oxygen diffusion through the pre-stabilised precursor and also help with carrying away toxic gases emitted as a result of the chemical reactions occurring in the precursor during the oxidation step.

Typically, the gas flow rate will be such that the temperature measured adjacent to the precursor is within 60° C. of the temperature of the oxidation gas, preferably within 50° C. of the temperature of the oxidation gas. As used herein, “adjacent to the precursor” means within 10 mm of the precursor, preferably within 3 mm of the precursor, more preferably within 1 mm of the precursor. In some embodiments, the gas flow rate may be such that the actual precursor temperature is within 60° C. of the temperature of the oxidation gas, preferably within 50° C. of the temperature of the gas.

The temperature of the oxidation gas is the temperature of the gas flow measured at least 30 mm away from the precursor, preferably at least 40 mm away from the precursor, more preferably at least 50 mm away from the precursor.

The temperature of the oxidation gas may be monitored using thermocouples suitably positioned in the oxidation chamber. That is, the oxidation reactor may comprise suitably positioned thermocouples. In some embodiments, the oxidation reactor comprises thermocouples proximal each end of each oxidation zone. In some embodiments, the or each thermocouple may be configured to permit continuous monitoring of the oxidation gas temperature.

In some embodiments, the oxidation reactor is configured to permit a thermocouple to be periodically positioned adjacent to the precursor to enable the temperature adjacent to the precursor to be measured. In some embodiments, the oxidation reactor may include an infra-red temperature sensor suitable for monitoring the actual surface temperature of the precursor as it passes through the oxidation chamber.

The flow rate of the forced gas will be high enough that there will be turbulent gas flow around the pre-stabilised precursor. Similarly to the pre-stabilisation reactor, in the oxidation reactor, this localised turbulent flow in the vicinity of the precursor will induce some fibre agitation and shaking that facilitates effective removal of the reaction by-products, as well as aiding in the management of the exothermic behaviour of the pre-stabilised precursor during oxidation. Agitation of the fibres in the gas flow can facilitate heat transfer from the precursor to the flow of oxidation gas so as to ensure that the temperature of the fibre remains within an acceptable limit.

Furthermore, agitation of the pre-stabilised precursor within the oxidation gas can aid in effectively contacting the precursor with oxygen so that the oxidation process is efficient and effective.

The flow rate of the forced gas will be controlled so that it is not too high. The flow rate of the forced gas will not be so high that the precursor is excessively agitated as this can lead to fibre damage, including fibre breakage. Furthermore, an excessive flow rate can over-pressurise the oxidation reactor such that the performance of the gas seal provided by the gas seal assembly is impaired. For example, over-pressurizing may result in unacceptable levels of incidental gas flow out of the reactor through the inlet and the outlet.

It will be appreciated that this localised turbulent gas flow is a turbulent boundary layer. The thickness of this boundary layer may be less than the height of the reaction chamber such that, except for the localised turbulent gas flow in the vicinity of the pre-stabilised precursor, the bulk of the gas flow through the oxidation chamber is substantially laminar. Such embodiments may include reactors where the oxidation chamber height is large relative to the length of the oxidation chamber. Oxidation chambers with large height to length ratio may have smaller production capacities and may be part of oxidation reactors suited to research and development applications. It is nevertheless desirable to provide the oxidation gas with a flow that it is as uniform as possible in order to control the temperature of the pre-stabilised precursor evenly. Regions of low gas flow may lead to the formation of “hot spots” in the oxidation chamber, and this may lead to localised overheating damaging the pre-stabilised precursor. The gas flow uniformity may be such that there is only a 1% to 10% variation in gas flow across each of the width, height, and length of the oxidation chamber. The velocity of the oxidation gas flow may be 0.5 to 4.5 m/s, for example it may be 2 to 4 m/s.

In some other embodiments, the thickness of this boundary layer compared to the height of the oxidation chamber is such that the flow through the oxidation chamber is predominantly turbulent. Such flow may be in oxidation chambers with smaller height to length ratios.

These reactors where the oxidation chamber height is small relative to the length of the oxidation chamber may have larger production capacities and may be part of oxidation reactors suited to commercial applications.

In one embodiment, it is desirable for the bulk of the gas flow through the oxidation chamber to be substantially turbulent, to enhance heat transfer from the pre-stabilised precursor to the forced gas flow of oxidation gas. The greater region of turbulent flow can facilitate heat transfer from the precursor by convection. It remains desirable to provide the process gas with a flow that it is as uniform as possible in order to control the temperature of the pre-stabilised precursor evenly. Regions of low gas flow may lead to the formation of “hot spots” in the reaction chamber, and this may lead to localised overheating damaging the precursor. The gas flow uniformity may be such that there is only a 1% to 10% variation in gas velocity across each of the width, height, and length of the oxidation chamber. The velocity of the process gas flow may be 0.5 to 4.5 m/s, for example it may be 2 to 4 m/s. To ensure a suitably turbulent flow, the oxidation gas flow should be such that the Reynolds number of the flow is above 100,000 when calculated at points further than 1.0 m from the main oxidation gas inlet along the direction of the gas flow.

In some embodiments, the oxidation reactor may comprise one or more gas velocity sensors, in the form of anemometers or manometers, for monitoring the velocity of the forced oxidation gas flow. So as to measure the gas flow velocity of the oxidation gas, the gas velocity sensors may be located such that the velocity of the gas flow is measured at least 30 mm away from the pre-stabilised precursor, preferably at least 40 mm away from the precursor, more preferably at least 50 mm away from the precursor.

In some embodiments, the oxidation reactor comprises gas velocity sensors proximal each end of each zone of the oxidation oven. In some embodiments, the or each gas velocity sensor may be configured to permit continuous monitoring of the process gas temperature.

In embodiments where the oxidation reactor comprises one or more thermocouples, the one or more gas velocity sensors may each be co-located with a thermocouple.

Often, so as to provide the oxidation gas with good flow uniformity as it flows through the oxidation chamber, the forced oxidation gas flow assembly will be adapted to supply the oxidation gas so that it flows largely parallel to the passage of the pre-stabilised precursor through the oxidation chamber. For example, the forced gas flow assembly may be adapted to supply a centre-to-ends flow of oxidation gas. For example, U.S. Pat. No. 4,515,561 discloses an oven in which a heated air flow is circulated around a carbon fibre precursor and contacts the precursor in a direction parallel to the direction of travel.

Other arrangements for providing the oxidation gas to an oxidation chamber are known and can include providing a cross-flow of the oxidation gas, relative to the passage of the pre-stabilised precursor. In these embodiments, the forced gas flow assembly may be adapted to provide a flow of gas travelling from one side of the chamber across to the other. Alternatively, the forced gas flow assembly may be adapted to provide oxidation gas vertically. For example, the forced gas flow assembly may be adapted to provide a flow of oxidation gas down from the top of the oxidation chamber towards the floor, or vice versa. U.S. Pat. No. 6,776,611 describes an oxidation reactor in which the oxidation gas is circulated around a carbon fibre precursor and contacts the precursor in a direction perpendicular to the direction of travel.

With these alternative arrangements it can be more difficult to achieve the desired uniformity in gas flow. For example, with a vertical flow of oxidation gas, the gas must pass through the pre-stabilised precursor which may lead to a venturi effect as it passes between tows of the pre-stabilised precursor. Accordingly, a forced gas flow assembly adapted to provide a centre-to-ends flow of oxidation gas is typically preferred.

Substantially the same arrangements as described above for the forced gas flow assembly of the reactor may be used in embodiments of the forced gas flow assembly of the oxidation reactor.

Exothermic behaviour can vary between pre-stabilised precursors. Accordingly, the temperature and gas flow within the oxidation reactor will be adapted to each pre-stabilised precursor so as to suitably complete stabilisation of the precursor and manage the exothermic behaviour during oxidation.

In some embodiments, the stabilised precursor is heated in an oxygen-containing atmosphere with an oxidation gas temperature in a range of from about 200 to 300° C. For example, from about 210 to 285° C., and in some embodiments preferably in a range of from about 230 to 280° C. The temperature of the oxidation gas may be controlled so that the fluctuation in the temperature away from the desired oxidation gas temperature is such that the oxidation gas is either at the desired oxidation gas temperature or below. In some embodiments, the temperature of the oxidation gas may be controlled so that the temperature is kept to within 5° C. less than the desired oxidation gas temperature.

The pre-stabilised precursor may be heated under a substantially constant temperature profile or a variable temperature profile during oxidation. As the oxidation step may be exothermic, it can be desirable to perform the oxidising step at a controlled rate. This may be achieved through a variety of methods, for example by passing the pre-stabilised precursor through a series of temperature zones with progressively increasing temperatures in the desired temperature range.

In some embodiments, heating of the pre-stabilised precursor during oxidation may occur by passing the stabilised precursor through a single temperature zone. In such embodiments, the forced oxidation gas flow is ideally such that a substantially uniform temperature is maintained throughout the oxidation chamber.

In other embodiments, heating of the pre-stabilised precursor during the oxidation step may occur by passing the pre-stabilised precursor through a plurality of temperature zones. That is, in some embodiments, the oxidation chamber may include two or more oxidation zones. Accordingly, heating of the pre-stabilised precursor during the oxidation step may occur by passing the pre-stabilised precursor through a plurality of oxidation zones. In such embodiments, the pre-stabilised precursor may pass through two, three, four, or more oxidation zones. Each of the zones may be of the same temperature and/or have the same gas flow rate conditions. Alternatively, different temperature and/or gas flow rate conditions may be applied in two or more zones. In some embodiments, there are different conditions in each zone.

For example, at least one temperature zone (e.g. first temperature zone) may be at a first temperature while at least one temperature zone (e.g. second temperature zone) is at a second temperature that is different to the first temperature.

In one set of embodiments, the pre-stabilised precursor fibre may initially be heated at a selected temperature, and then the temperature may increase as the oxidation step proceeds. As an example, the PAN stabilised precursor fibre may initially be heated at a temperature of about 230° C., with temperature increasing to about 280° C. during the oxidation step.

In some embodiments, the temperature of the gas in each zone may be the same, but the gas flow rate may be different.

In addition to controlling the temperature of the pre-stabilised precursor, the forced gas flow can be used to transport unwanted reaction products away from the fibres. In particular, the oxidation step generates hydrogen cyanide (HCN) gas. Hydrogen cyanide is toxic and its generation poses an inhalation hazard if allowed to escape from the oxidation reactor through either or each of the inlet and outlet.

The forced gas flow will transport reaction products towards the gas seal assembly of the oxidation reactor. The gas seal assembly is for sealing the oxidation chamber to provide the oxygen-containing atmosphere therein and for limiting incidental gas flow out of the reactor through the inlet and the outlet. Thus, the gas seal assembly limits the emission of fugitive gases, including HCN gas, from the reactor. The gas seal assembly typically includes an exhaust sub-assembly for removing exhaust gases from the reactor. The exhaust gases may flow to a hazardous gas abatement system for decontaminating the exhaust gas stream.

The oxidation step may be performed in a single oxidation reactor or a plurality of oxidation reactors. In one embodiment, the oxidation step is performed in an oven, or a plurality of ovens.

When a plurality of oxidation reactors is used, they may be arranged in series. In such embodiments, the pre-stabilised precursor may be conveyed via suitable transport means between the oxidation reactors. The suitable transport means may include drive rollers, possibly in combination with non-driven rollers. Suitable transport means include material handling devices, such as those well known in the art (e.g. a tension stand having a plurality of rollers).

In some embodiments, the reactor may include two or more oxidation chambers. For example, three chambers, four chambers, or more. The pre-stabilised precursor may be conveyed via suitable transport means between the oxidation chambers. The suitable transport means may include drive rollers, possibly in combination with non-driven rollers, such as known material handling devices.

Each oxidation chamber may include one or more oxidation zones as described above. Accordingly, each oxidation chamber may have the same temperature and/or have the same gas flow rate conditions. Alternatively, different temperature and/or gas flow rate conditions may be applied in two or more chambers. In some embodiments, there are different conditions in each chamber, with different conditions in each reaction zone.

In these embodiments where the oxidation reactor includes two or more oxidation chambers, the chambers may be stacked on top of one another.

As discussed above, the pre-stabilised precursor may be activated for the oxidation step due to the partial cyclisation of nitrile groups in the PAN precursor fibre during the pre-stabilisation step. In particular, it has been found that activation of the precursor through the pre-stabilisation step can enable a stabilised precursor to be formed more rapidly.

In one set of embodiments the pre-stabilised precursor is exposed to the oxygen-containing atmosphere for a time period selected from the group consisting of no more than about 120 minutes, no more than about 90 minutes, no more than about 60 minutes, no more than about 45 minutes, no more than about 30 minutes, and no more than about 20 minutes.

The present invention can provide a system or apparatus for rapidly preparing a stabilised precursor fibre capable of being carbonised to form a carbon fibre, wherein the line speed is such that the process (including the pre-stabilisation and oxidation steps) is performed for a time period selected from the group consisting of: no more than about 60 minutes, no more than about 45 minutes, no more than about 30 minutes, no more than about 25 minutes, and no more than about 20 minutes.

Thus a stabilised precursor fibre suitable for carbon fibre manufacture can be formed within a time period selected from the group consisting of: no more than about 60 minutes, no more than about 45 minutes, no more than about 30 minutes, no more than about 25 minutes, and no more than about 20 minutes.

The ability to rapidly form a stabilised precursor that is capable of being carbonised can provide significant time, energy and cost savings in the manufacture of carbon-based materials such as carbon fibre. For example, a stabilised precursor having a desired quantity of cyclised nitrile groups can be formed at least 25%, at least 30%, at least 40%, at least 50%, at least 60%, at least 70%, or at least 80% faster than comparative stabilisation process designed to form a similarly stabilised precursor, but which does not include the pre-stabilisation step described herein.

Advantageously, the oxidation step employed for precursor stabilisation may proceed at high speed. This can reduce the impact of the oxidation step on carbon fibre production processing time and energy demands, thus reducing costs associated with the precursor stabilisation step in carbon fibre manufacture.

The residence time within the oxidation chamber is determined by the length of the chamber, the velocity of the stabilised precursor as it passes through the oxidation chamber and the flow path of the stabilised precursor through the chamber.

As noted above, the oxidation chamber may include two or more oxidation zones.

The pre-stabilised precursor may make a single pass or multiple passes through a particular temperature zone. For example, when a single or a plurality of zones at different temperatures is used, the stabilised precursor fibre may make a single pass through each zone.

The precursor may pass through the oxidation chamber a plurality of times. For example, the precursor may pass through the oxidation chamber twice, three times, four times, five times, six times, seven times, eight times or more. Rollers will be arranged at each end of the reactor in order to pass the precursor through chamber the desired number of times. In some embodiments, one or more non-driven rollers are arranged at one end and one or more driven rollers are arranged at the other end in order to convey the precursor through the chamber for the desired number of passes.

So as not to disturb the uniformity of the flow of gas through the oxidation chamber, rollers are not provided within the oxidation chamber. Accordingly, the pre-stabilised precursor will be suspended between material handling devices, such as rollers, external to the oxidation chamber as it is conveyed through the oxidation chamber. As a result, the length of the oxidation chamber will be limited to by the maximum distance that the rollers can be separated while still conveying the stabilised precursor evenly through the oxidation chamber at the desired tension. If the distance between the rollers is too great, the stabilised precursor may begin to sag as it travels towards the centre of the oxidation chamber. In some embodiments, the oxidation chamber is less than 20,000 mm long, for example less than 18,000 mm long.

In one set of embodiments, material handling devices include tensioning devices for applying tension to the pre-stabilised precursor as it passes through the oxidation reactor.

As described above with respect to the pre-stabilisation reactor, rollers used to convey the precursor will often include arrangements of rollers selected to apply a predetermined tension to the precursor. Accordingly, the tensioning devices can include combinations of rollers. Suitable combinations of rollers for applying a predetermined tension are known the art and include S-wrap, omega (Ω), 5-roller, 7-roller and nip-roller drive roller arrangements.

Selection of the drive roller arrangement can be influenced by: precursor type; the available space for rollers; the desired output of precursor, both in terms of the desired quantity and quality; and the tension to be applied to the precursor; as well as budgetary constraints. For example, S-wrap, omega and nip-roller arrangements are relatively compact arrangements and may be preferred in embodiments where space is limited.

In some embodiments, the oxidation reactor is adapted to providing a stabilised precursor for production of aerospace carbon fibre. In some of those embodiments, 5-roller or 7-roller drive arrangements may be preferred.

In some embodiments, so as to minimise the number of rollers required, S-wrap, omega and nip-roller arrangements may be preferred.

In some embodiments, 5-roller or 7-roller drive arrangements may be preferred as these arrangements may be able to apply a greater amount of tension to the pre-stabilised precursor relative to other arrangements.

As noted above, in some embodiments, the pre-stabilised precursor may be conveyed a through an oxidation chamber two or more times. Alternatively or additionally, the oxidation reactor may include two or more oxidation chambers. In some embodiments, there may be tensioning devices provided for each oxidation chamber and/or each pass of the precursor through an oxidation chamber. Thus, the tensioning devices may be used to apply a predetermined tension for each oxidation chamber and/or each pass of the pre-stabilised precursor through an oxidation chamber, and these predetermined tensions may be the same (i.e. a substantially constant tension is applied) or different.

Tensioning devices may be controlled by a tension controller in order to enable a predetermined amount of tension to be applied to the pre-stabilised precursor fibre.

The amount of tension applied may be monitored by the use of a tensiometer or load cells (e.g. piezoelectric load cells). For example, each tensioning device may comprise a load cell attached to the support bearings of the fibre transport roller to sense the level of tension being applied to the precursor.

Using the tensioning devices, a predetermined amount of tension may be applied to the pre-stabilised precursor during oxidation. Tension applied during the oxidation step can help to promote chemical reactions occurring during stabilisation, enhance the molecular alignment of polyacrylonitrile, and allow the formation of a more highly ordered structure in the precursor.

In one set of embodiments, tension in the range of from about 50 cN to 50,000 cN, e.g. from about 50 cN to 10,000 cN, is applied to the pre-stabilised precursor during the oxidising step.

Similar to pre-stabilisation, once the processing parameters of temperature, time and tension are selected for the oxidation of the pre-stabilised precursor in the oxidization reactor, the parameters may remain fixed and unchanged while the oxidation step is performed. Furthermore, controls may be utilised to ensure that the process parameters are adequately maintained within acceptable limits for the selected values. This can help to ensure that consistent and stable precursor stabilisation can be achieved.

In some embodiments, temperature measurements from any thermocouples and/or gas velocity measurements from any gas velocity sensors may be provided to a control unit. Furthermore, tension measurements from any tensiometer or load cells of the tensioning devices may be provided to the control unit. This control unit may be the same control unit as the reactor or a separate control unit for the oxidation oven. In addition, data from any other sensors included in the oxidation reactor can be provided to the control unit. Such sensors may include gas sensors, such as HCN gas and/or oxygen sensors that may be provided to sense the efficacy of the gas seals of the oxidation reactor.

Software-based algorithms may be used to analyse the data provided to the control unit. Thus, the control unit may be used to automatically assess whether one or more parameters should be adjusted, including any one or more of the following: the temperature of the oxidation gas; the temperature of any heating elements in the oxidation reactor; the flow rate of the oxidation gas through the oxidation chamber; the amount of exhaust extracted from the oxidation reactor; the supply rate of oxidation gas to any inlet; the speed at which the pre-stabilised precursor is conveyed through the oxidation reactor; and the tension applied to the pre-stabilised precursor. Software may direct automatic adjustment of the aforementioned parameters to optimise operation of the oxidation reactor. The control system may run continuously during the oxidation process thereby ensuring that optimal conditions are maintained.

By using the reactor of the present invention, a PAN precursor fibre may be stabilised in a shorter time period than that often employed for conventional precursor stabilisation processes. The faster stabilisation time can be achieved by subjecting the PAN precursor to an initial pre-stabilisation step in the reactor of the invention for a very short period of time (e.g. a time period of no more than about 5 minutes, no more than about 4 minutes, no more than about 3 minutes or no more than about 2 minutes) and subsequently, to an oxidation step that completes the stabilisation process and results in the formation of a stabilised precursor fibre.

Thus, use of the reactor of the present invention may advantageously enable oxidation to be carried out for a shorter time period and/or at a lower temperature and energy than that of conventional oxidative stabilisation processes.

The pre-stabilisation step may therefore markedly reduce the overall stabilisation time and upon additional treatment of the stabilised precursor, carbon-based materials, such as carbon fibres, with excellent properties may be produced. Thus fast oxidative stabilisation of a PAN precursor suitable for the manufacture of carbon fibre can be achieved.

The reactor, apparatus and system described herein can further be configured to a range of precursors of varying morphology and composition, to enable formation a stabilised precursor.

In one set of embodiments, there is provided a system for preparing a stabilised precursor. Accordingly, the present invention provides a system for stabilising a precursor, the system comprising:
a reactor for producing a pre-stabilised precursor in accordance with the invention;
tensioning devices located upstream and downstream of the reaction chamber, wherein the tensioning devices are adapted to pass the precursor through the reaction chamber under a predetermined tension; and
an oxidation reactor downstream from the reactor, the oxidation reactor comprising
   at least one oxidation chamber adapted to stabilise the pre-stabilised precursor in an oxygen-containing atmosphere as the pre-stabilised precursor is passed through the oxidation chamber(s).

In such embodiments, pre-stabilisation and oxidation steps may be performed in a continuous manner. That is, the oxidation step is performed immediately after the pre-stabilisation step. Accordingly, in some embodiments, the speed at which the precursor is conveyed through an oxidation reactor is selected to match a line speed used during the pre-stabilisation reactor. This can allow the pre-stabilised precursor formed to be fed directly to the downstream oxidation reactor. Accordingly, this can avoid the need to collect the pre-stabilised precursor.

In some embodiments, the reactor and oxidation reactor will form part of a single apparatus that is included in the system. In some other embodiments, the reactor and oxidation reactor may be provided as distinct and separate apparatuses.

A stabilised precursor prepared using the apparatus and system of the present invention may have a density of between 1.30 g/cm³ and 1.40 g/cm³, for example between 1.34 g/cm³ and 1.39 g/cm³.

A stabilised PAN precursor prepared using the reactor, apparatus or system described herein may exhibit a range of properties that differ from stabilised precursors formed using conventional stabilisation processes.

For instance, relative to a stabilised PAN precursor formed by a comparative stabilisation process, a stabilised PAN precursor prepared using the present invention may have a different crystal structure, and can exhibit a smaller apparent crystallite size (Lc (002)). In some embodiments, the Lc (002) may be at least 20% smaller than that observed for a comparative stabilised precursor formed using a comparative stabilisation process that does not include a pre-stabilisation step using the reactor of the present invention.

Furthermore, stabilised PAN precursors prepared using the invention may have higher thermal conversion and be formed with lower exothermic energy being generated, as measured by DSC. This highlights the possibility of the use the invention potentially enhancing the safety of carbon fibre manufacture.

Stabilised precursors prepared using the reactor, apparatus or system the invention may also be observed to have a higher dehydrogenation index (CH/CH₂ ratio) compared to a stabilised precursor formed using a comparative process that does not include a pre-stabilisation step. In some embodiments, the dehydrogenation index may be at least 5%, or at least 10% higher than that of a comparative stabilised precursor. The higher dehydrogenation index is believed to reflect a higher extent of oxidative chemical reactions or a higher chemical conversion of the PAN precursor during the oxidation step.

As discussed above, use of the stabilisation apparatus or system of the invention, which comprises a pre-stabilisation reactor as described herein, may enables a stabilised precursor that is sufficiently thermally stable for carbonisation to be formed in a rapid manner.

The term “rapid” as used in relation to a process described herein is intended to indicate that the process is performed more quickly (i.e. in a shorter period of time) than a reference process that is designed to achieve the same result, but which does not include the pre-stabilisation step as a part of the process. Use of the present invention to perform processes comprising a pre-stabilisation treatment can therefore provide a time saving, compared to the reference process. As an example, a conventional reference stabilisation process may form a stabilised PAN precursor having from 65% to 70% of cyclised nitrile groups in a time period of about 70 minutes. In comparison, some embodiments of the present invention may be used to prepare a stabilised precursor having an equivalent amount of cyclised nitrile groups in a time period that is as little as about 15 minutes. Thus, use of the reactor of the present invention may achieve a time saving of about 55 minutes (or about 78%) over the reference process.

Advantageously, using the reactor, apparatus or system the invention may enable a stabilised precursor to be formed in less time and with lower cost.

In some embodiments, using the reactor, apparatus or system the invention may enable performance of a stabilisation process that is at least 30%, at least 40%, at least 50%, at least 60%, at least 70% or at least 80% faster than a reference process that is designed to achieve an equivalent extent of nitrile group cyclisation in a stabilised precursor but which does not comprise the pre-stabilisation step.

The ability to rapidly stabilise a PAN precursor also enables energy savings to be achieved as less energy is consumed when performing the stabilisation process. This in turn can provide flow-on cost savings for processes such as carbon fibre manufacture. For example, a stabilisation process using the reactor of the invention may consume on average from about 1.1 to 2.6 kWh/kg. This compares to a conventional stabilisation process, which has an average energy consumption of from about 3.7 to 8.9 kWh/kg.

In another aspect, the reactor of the present invention may be used to provide a low density stabilised precursor comprising polyacrylonitrile having at least 60% cyclised nitrile groups and a mass density in a range of from about 1.30 g/cm³ to 1.33 g/cm³. In some embodiments, the low density stabilised precursor has at least 65%, or at least 70%, cyclised nitrile groups. The low density stabilised PAN precursor is thermally stable and can be converted into a carbon material such as fibre with acceptable properties. Conversion to a carbon material such as carbon fibre can be achieved despite the relatively low density of the stabilised precursor.

A low density stabilised PAN precursor as described herein is also light-weight and may advantageously be used in a variety of applications where a light weight stabilised precursor is desired. For example, the low density stabilised precursor may suitably be incorporated into fabrics.

If desired, the stabilised precursor produced using the invention may be collected and stored in preparation for further use. For example, the stabilised precursor may be collected on a spool.

A stabilised precursor prepared in accordance with the invention can undergo carbonisation to form a carbon-based material or product, such as a carbon fibre. In particular embodiments, a stabilised precursor prepared in accordance with processes described herein may be suitable use in the manufacture of high performance carbon fibre. In some embodiments, the precursor stabilisation system described herein can be incorporated into a system for preparing a carbon fibre, to provide an improve carbon fibre manufacturing system.

Thus, in another aspect, the present invention provides a system for preparing a carbon-based material, the system comprising:
a reactor for producing a pre-stabilised precursor in accordance with the present invention;
tensioning devices located upstream and downstream of the reaction chamber,
wherein the tensioning devices are adapted to pass the precursor through the reaction chamber under a predetermined tension; and
an oxidation reactor downstream from the reactor, the oxidation reactor comprising
   at least one oxidation chamber adapted to stabilise the pre-stabilised precursor in an oxygen-containing atmosphere as the pre-stabilised precursor is passed through the oxidation chamber(s); and
a carbonisation unit for carbonising the stabilised precursor to form the carbon-based material. An embodiment of such a system is shown in FIG. 12 in the form of a block diagram. In some embodiments, the present invention provides a system for continuously manufacturing carbon fibre.

The carbon-based material may be in a range of forms, including fibre, yarn, web, film, fabric, weave and mat forms. Mats may be woven or non-woven mats.

In one preference, the carbon-based material is a carbon fibre. In order to produce a carbon fibre, the stabilised precursor may be in the form of fibre, preferably a continuous length of fibre.

It will be convenient to describe carbonisation by reference to the formation of a carbon fibre from a stabilised precursor fibre. However, a skilled person would appreciate that the system can be adapted so as to be suitable for carbonising stabilised precursors in other forms, such that carbon-based materials in a range of different forms, including in forms other than fibre, can be prepared.

In carbonising a stabilised precursor, a range of suitable conditions may be employed. The choice of process conditions for the carbonisation step can be selected to facilitate formation of a carbon material having desired properties and/or structure. In some embodiments, carbonisation process conditions are selected to enable the formation of a high performance carbon material, such as high performance carbon fibre. Suitable process conditions may include conventional carbonisation conditions known to a person skilled in the art. Accordingly, the carbonisation unit may be a conventional carbonisation unit known to a person skilled in the art.

During carbonisation, ladder-like molecular structures that formed in the stabilisation step become bonded to each other and modified into graphite-like structures, thereby forming the carbon-based structure of the carbon fibre. Additionally, during carbonisation, the volatilisation of elements other than carbon also occurs.

In one set of embodiments, the stabilised precursor fibre is heated in a substantially oxygen-free atmosphere during the carbonising step.

In some embodiments carbonisation involves heating the stabilised precursor fibre at a temperature in the range of from about 350 to 3,000° C., preferably from about 450 to 1,800° C., in the substantially oxygen-free atmosphere.

In one set of embodiments, carbonisation may comprise low temperature carbonisation and high temperature carbonisation.

Low temperature carbonisation can involve heating the stabilised precursor fibre at a temperature in a range of from about 350° C. to about 1,000° C.

High temperature carbonisation can involve heating the stabilised precursor fibre at a temperature in a range of from about 1,000° C. and 1,800° C.

With some embodiments of the carbonisation unit, low temperature carbonisation may be performed before high temperature carbonisation.

The carbonisation unit can comprise one or more suitable carbonisation reactors. For example, the unit may comprise two or more carbonisation reactors. Carbonisation reactors are adapted to carbonise the stabilised precursor in a substantially oxygen-free atmosphere and can include an inlet for allowing the stabilised precursor to enter the carbonisation reactor, an outlet for allowing the stabilised precursor to exit the carbonisation reactor, and a gas delivery system for delivering a substantially oxygen-free gas to the carbonisation reactor to help establish the substantially oxygen-free atmosphere. In one set of embodiments, the substantially oxygen-free gas comprises nitrogen.

The carbonisation reactor may also comprise heating elements for heating the carbonisation reactor. The heating elements may heat a substantially oxygen-free gas that is delivered to the interior of the carbonisation reactor. The carbonisation reactor may be configured to provide a single temperature zone or a plurality of temperature zones for heating the stabilised precursor that passes within.

Exemplary carbonisation reactors may be ovens or furnaces that are adapted to contain a substantially oxygen-free atmosphere and can withstand the high temperature conditions generally employed for carbon fibre formation. As noted above, the unit can include conventional reactors, such as furnaces well known in the art, and can use operating parameters known in the art so as to perform carbonisation of a stabilised precursor.

When more than one carbonisation reactor is used, the separate carbonisation reactors may be arranged in series in the carbonisation unit, with the precursor making only a single pass through each reactor. For example, a carbonisation unit may comprise a low-temperature (LT) furnace and a high-temperature (HT) furnace. The high temperature furnace will generally be located downstream of the low temperature furnace.

Within the carbonisation unit, the stabilised precursor fibre may be heated under a variable temperature profile to form a carbon fibre. For example, the temperature may be varied within the defined range of temperature employed for low temperature and/or high temperature carbonisation.

A variable temperature profile for carbonisation step may be achieved by passing the stabilised precursor fibre through a plurality of temperature zones arranged in series, with each temperature zone being at a different temperature. The carbonisation unit may be adapted to provide a variable temperature profile by having plural carbonisation reactors.

Alternatively or additionally, the carbonisation reactor(s) may include two or more carbonisation temperature zones arranged along the length of the reactor. Accordingly, heating of the stabilised precursor fibre during carbonisation may occur by passing the stabilised precursor fibre through a plurality of carbonisation reactors and/or zones. In such embodiments, the stabilised precursor may pass through two, three, four, or more reactors and/or zones.

Carbonisation is performed in a substantially oxygen-free atmosphere, which may comprise an inert gas. A suitable inert gas may be a noble gas, such as argon, helium, neon, krypton, xenon and radium. Furthermore, a suitable inert gas may be nitrogen. The substantially oxygen-free atmosphere may comprise a mixture of inert gases, such as a mixture of nitrogen and argon.

One skilled in the art would appreciate that a carbonisation unit would have a defined length established by the heated length of the or each reactor, and the stabilised precursor may pass through the carbonisation unit at a predetermined speed. The length of the carbonisation unit and the speed at which the precursor is conveyed through the carbonisation unit can influence the total residence (dwell) time of the precursor in the unit. In turn, the dwell time can determine the time period in which the carbonisation step is performed.

Carbonisation may be performed for a period of time suitable for producing a carbon fibre. In some embodiments, the carbonisation step may be performed for a time period selected from up to 20 minutes, up to 15 minutes, up to 10 minutes and up to 5 minutes. For example, in one set of embodiments, the dwell time of the stabilised precursor in the carbonisation unit is no more than about 20 minutes, no more than about 15 minutes, no more than about 10 minutes or no more than about 5 minutes.

The temperature of the one or more carbonisation reactors in the carbonisation unit, as well as the speed at which the precursor is conveyed through the carbonisation unit can be adjusted in order to achieve a carbon material in the desired time.

In some embodiments, the stabilised precursor may be conveyed through a carbonisation unit at a speed in a range of from about 10 to 1,000 metres/hour.

In some embodiments, the speed at which the precursor is conveyed through a carbonisation unit is selected to match a line speed used in the pre-stabilisation and oxidation steps described herein. This can facilitate the continuous manufacture of a carbon material such as carbon fibre.

In order to readily convey the stabilised precursor through the carbonisation unit, the precursor will typically have some tension applied to it to ensure that it does not sag or drag as it passes through the carbonisation reactor. In addition, tension applied during the carbonising step can help to inhibit or control shrinkage of the carbon material as well as promote the formation of a more highly ordered structure in the carbon material.

Tension values used in conventional carbonisation processes for forming carbon material, such as carbon fibre, can be used in the carbonisation step of processes described herein.

The desired amount of tension may be applied by tensioning devices located upstream and downstream of the unit or each carbonisation reactor employed for carbonising the precursor. The precursor is suspended between the tensioning devices, which are adapted to convey the precursor through a carbonisation chamber.

The choice of tension to be applied the stabilised precursor during the carbonisation step may in some embodiments depend on outcomes desired in relation to one or more mechanical properties of the carbon fibre formed from the precursor. Mechanical properties desired for the carbon fibre may include tensile properties such as ultimate tensile strength, tensile modulus and elongation to break. Tension applied to the precursor during carbonisation can be adjusted in order to promote the evolution of one or more of the above properties to achieve a desired outcome in the carbon fibre.

Typically, material handling devices such as those known in the art include tensioning devices. Thus, the carbonisation may include one or more materials handing devices including tensioning devices. Tensioning devices will typically include arrangements of driven rollers, optionally in combination with non-driven rollers, to apply a predetermined tension to the stabilised precursor. Suitable combinations of rollers for applying a predetermined tension are known the art and include S-wrap, omega (a), 5-roller, 7-roller and nip-roller drive roller arrangements.

In some embodiments, the carbonisation unit will comprise one or more material handling devices. In embodiments where the carbonisation unit comprises two or more carbonisation reactors, material handling devices may be provided upstream and downstream of each carbonisation reactor so that the precursor is conveyed via a tensioning device as it passes from one carbonisation reactor to the next.

Continuous production of a carbon-based material, in particular a carbon fibre, can be performed using the system of the present invention with operating conditions for pre-stabilisation, oxidation and carbonisation as described herein above.

When carrying out a continuous process for forming a carbon fibre, the precursor and pre-stabilised precursor are preferably fed to the pre-stabilisation reactor and the oxidation reactor at substantially the same rate or speed. That is, a common rate or speed is preferably used. Consequently, the precursor is continuously conveyed from one reactor to the next without the need to collect the precursor between reactors. Furthermore, the stabilised precursor is preferably fed to the carbonisation unit at substantially the same rate or speed, so that the stabilised precursor can be conveyed to the unit without collecting the precursor between the oxidation reactor and the carbonisation unit. Thus, the precursor is preferably continuously conveyed throughout the system.

In some embodiments, the line speed may be as low as 10 metre per hour (m/hr). In some other embodiments, the line speed may be up to 500 m/hr. The line speed may be up to as high as 1,000 m/hr. For an industrial carbon fibre manufacturing process, the line speed may in a range of from about 100 to 1,000 m/hr, for example, 120 to 900 m/hr. In some embodiments, the line speed may in a range of from about 600 to 1,000 m/hr, for example, 700 to 800 m/hr.

The line speed on a production line may be selected such that the PAN precursor fibre and pre-stabilised precursor fibre are fed at a rate that enables the precursor and pre-stabilised precursor to have a desired residence time in the pre-stabilisation reactor and the oxidation reactor, respectively.

In one set of embodiments, the line speed is such that the PAN precursor fibre has a residence time (i.e. dwell time) in the pre-stabilisation reactor of no more than about 5 minutes, no more than about 4 minutes, no more than about 3 minutes, or no more than about 2 minutes.

In one set of embodiments, the line speed is such that the pre-stabilised precursor fibre has a residence time (i.e. dwell time) in the oxidation reactor of no more than about 60 minutes, no more than about 45 minutes, no more than about 30 minutes, or no more than about 20 minutes.

In one set of embodiments, conditions are selected that the stabilisation process (including the pre-stabilisation and oxidation steps) using the apparatus or system of the present invention is complete in a time period selected from the group consisting of: no more than about 60 minutes, no more than about 45 minutes, no more than about 30 minutes, no more than about 25 minutes, and no more than about 20 minutes. Thus a fully stabilised precursor is formed within the aforementioned time periods.

The temperature the precursor is subjected to during pre-stabilisation and oxidation, as well as the tension applied to the precursor during the time that the precursor resides in the pre-stabilisation and oxidation reactors can also facilitate the rapid formation of a stabilised precursor that is suitable for use in the manufacture of a carbon material, such as carbon fibre.

Embodiments of the invention described herein may provide reactors, apparatuses and systems that allow a stabilised precursor suitable for carbon fibre manufacture to be formed in a shorter period of time, compared to that of conventional PAN precursor stabilisation processes. A short residence time for the precursor in the pre-stabilisation and oxidation reactors may only be required.

The ability to rapidly form a stabilised precursor can provide downstream advantages for carbon fibre manufacture, particularly in relation to the time required to form a carbon fibre. Thus the rate of carbon fibre production for a production system can be increased due to the rapid stabilisation process performed using the reactor of the invention, leading to the ability to produce carbon fibre at faster rates and/or in higher volumes, compared to conventional carbon fibre manufacturing processes known in the art. Furthermore, reactors, apparatuses and systems described herein may also enable high volumes of carbon fibre to be produced more rapidly on an industrial scale. Thus manufacturing costs associated with carbon fibre manufacture may be reduced.

In some embodiments, carbon fibre prepared using the reactor, apparatus or system described herein may be formed in a time period of no more than about 70 minutes, no more than about 65 minutes, no more than about 60 minutes, no more than about 45 minutes, or no more than about 30 minutes.

In particular embodiments, system may be adapted to feed the stabilised precursor fibre to a carbonisation reactor at a rate that corresponds with the rate of production of the stabilised precursor. Therefore, when using the embodiments of the system of the present invention, the stabilised precursor fibre exiting the oxidation reactor can be fed directly and continuously to the carbonisation reactor.

While reactors, apparatuses and systems disclosed herein have been described with reference to the production of carbon fibre, a skilled person would understand that the described reactors, apparatuses and systems can be used to prepare carbon-based material in non-fibre form. That is, when the precursor is in non-fibre form (e.g. yarn, web, film, fabric, weave or mat forms), the carbon-based material formed after carbonisation of the stabilised precursor may be in these other forms.

Advantageously, carbon fibre produced in reactors, apparatuses and systems of embodiments of the invention described herein may exhibit mechanical properties (e.g. tensile properties) that are at least equivalent to those produced by conventional carbon fibre manufacturing processes employed in industry.

### BRIEF DESCRIPTION OF THE DRAWINGS

Various embodiments of the invention will now be described, by way of example only, with reference to the accompanying drawings in which:

FIG. 1a shows a schematic top view of a first embodiment of a reactor in accordance with the present invention.

FIG. 1b shows a schematic top view of a second embodiment of a reactor in accordance with the present invention.

FIG. 1c shows a schematic top view of a third embodiment of a reactor in accordance with the present invention.

FIG. 1d shows a schematic top view of a fourth embodiment of a reactor in accordance with the present invention.

FIG. 1e shows an expanded schematic cross-section view of the outlet end of the fourth embodiment of a reactor in accordance with the present invention.

FIG. 2a shows a schematic top view similar to FIG. 1a and is annotated to show the gas flow paths in the reactor.

FIG. 2b shows a schematic top view similar to FIG. 1b and is annotated to show the gas flow paths in the reactor.

FIG. 2c shows a schematic top view similar to FIG. 1c and is annotated to show the gas flow paths in the reactor.

FIG. 2d shows a schematic top view similar to FIG. 1d and is annotated to show the gas flow paths in the reactor.

FIG. 3a shows a schematic front view of a first embodiment of a vertical reactor in accordance with the present invention.

FIG. 3b shows a schematic side view of the first embodiment of a vertical reactor in accordance with the present invention.

FIG. 3c shows a schematic front view of a second embodiment of a vertical reactor in accordance with the present invention.

FIG. 3d shows a schematic front view of a third embodiment of a vertical reactor in accordance with the present invention.

FIG. 4a shows a schematic front view similar to FIG. 3a and is annotated to show the gas flow paths in the reactor.

FIG. 4b shows a schematic front view similar to FIG. 3c and is annotated to show the gas flow paths in the reactor.

FIG. 4c shows a schematic front view similar to FIG. 3d and is annotated to show the gas flow paths in the reactor.

FIG. 5 shows a partial view of a system including the embodiment of a vertical reactor in accordance with the present invention.

FIG. 6 shows a schematic top view of an oxidation reactor suitable for use with a reactor in accordance with the present invention.

FIG. 7 shows a schematic top view similar to FIG. 6 and is annotated to show the gas flow paths in the oxidation reactor.

FIG. 8a shows a front view of a first embodiment of an apparatus in accordance with the present invention.

FIG. 8b shows a schematic front view of the passage of the precursor through the interior of the first embodiment of an apparatus in accordance with the present invention.

FIG. 8c shows a rear view of the exterior of the first embodiment of an apparatus.

FIG. 8d shows a rear view of the exterior of a second embodiment of an apparatus.

FIG. 8e shows plenum plates suitable for use in the reactor of embodiments of the apparatus.

FIG. 9 shows a schematic front view of the passage of the precursor through a system for producing a stabilised precursor in accordance with the present invention.

FIG. 10 shows an alternative front view of the system for producing a stabilised precursor in accordance with the present invention.

FIG. 11 shows a carbon fibre production system in accordance with the present invention.

FIG. 12 shows a block diagram of a carbon fibre production system having a reactor according to the present invention.

### DETAILED DESCRIPTION OF CERTAIN EMBODIMENTS

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

As used herein, the singular forms “a,” “an,” and “the” designate both the singular and the plural, unless expressly stated to designate the singular only.

The term “about” and the use of ranges in general, whether or not qualified by the term about, means that the number comprehended is not limited to the exact number set forth herein, and is intended to refer to ranges substantially within the quoted range while not departing from the scope of the invention. As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

Percentages (%) referred to herein are based on weight percent (w/w or w/v) unless otherwise indicated.

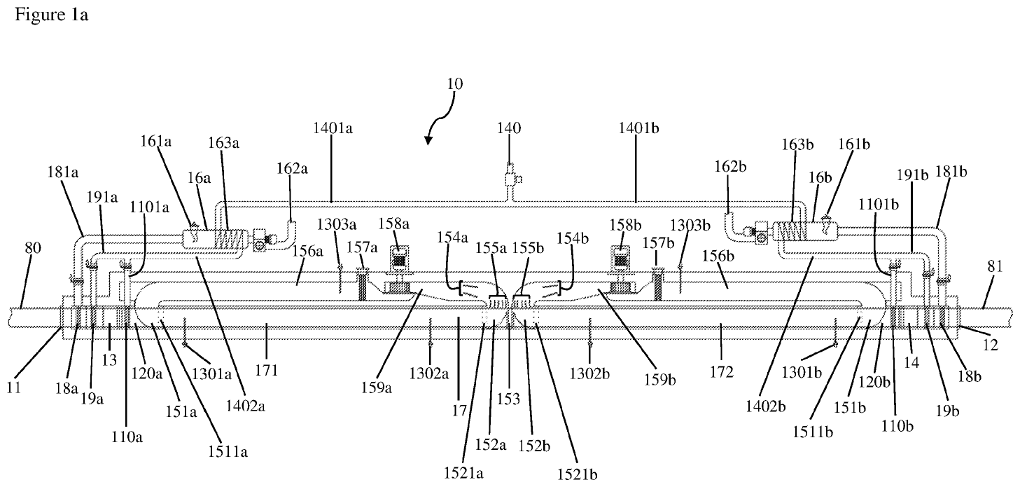

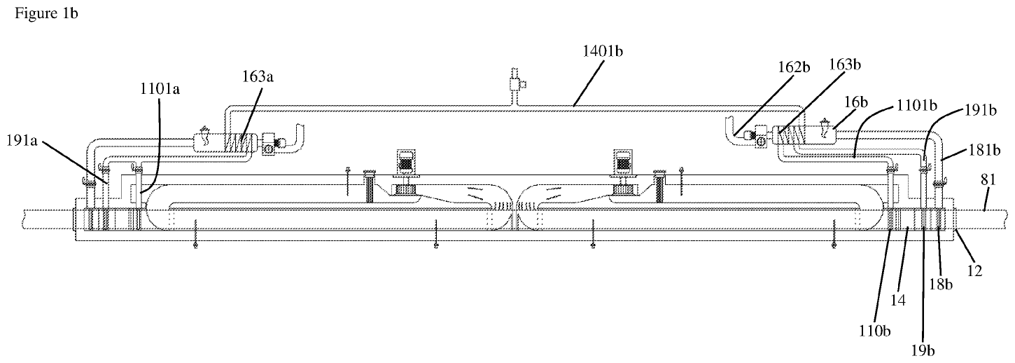

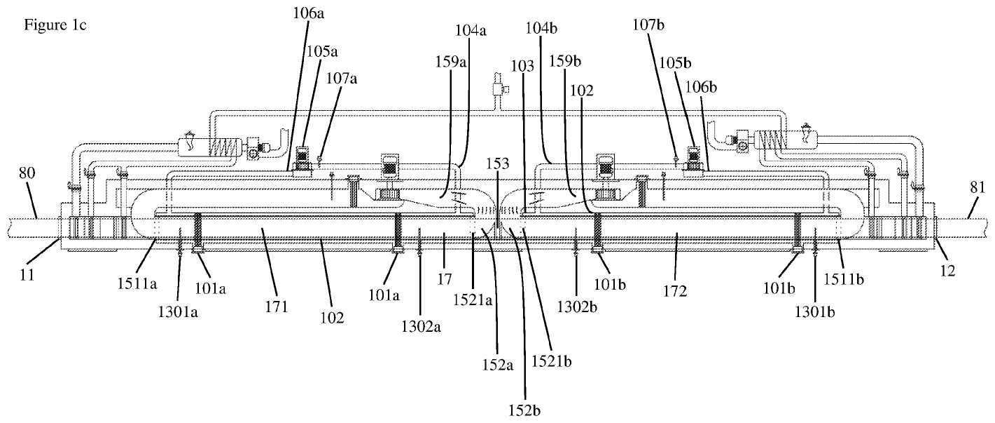

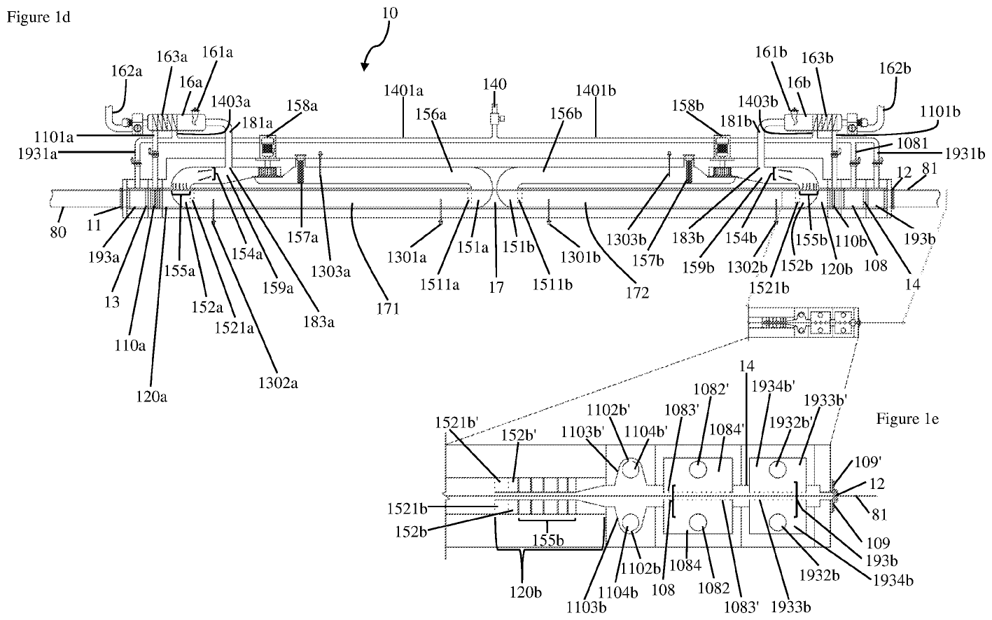

In FIGS. 1 to 11, various embodiments of the reactor of the present invention are illustrated. It will be appreciated that, in FIGS. 1 to 11, the precursor is shown schematically so as not to obscure the relevant details of the illustrated embodiment of the invention.

In one embodiment of the reactor of the present invention, the precursor is passed through the reaction chamber via rollers. FIG. 1a provides a schematic view of a first embodiment of the reactor 10. In this embodiment, conveying rollers (not shown) are positioned outside the reactor 10 and do not form part of the reactor 10. In some other embodiments, the reactor may include externally located drive rollers that co-operate with the components of the system to pass the precursor 80 through the reactor 10 and provide it to downstream components of the system.

In use, the interior of the reactor 10 may be too hot for conventional rollers. Accordingly, there is an inlet 11 and an outlet 12 to allow the precursor 80 to pass between the rollers and the interior of the reactor to produce a pre-stabilised precursor 81. As can be seen from FIG. 1a, the precursor moves through the reactor 10 by passing through an inlet vestibule 13, through the transition area 120a, through the reaction chamber 17, through another transition area 120b, and through an outlet vestibule 14, before exiting via the outlet 12.

The ability to pass the fibres freely between the rollers and the interior of the reactor 10 must be balanced with the need to maintain substantially oxygen-free atmosphere within the reaction chamber and the need to limit the emission of fugitive gases from the reactor. For convenience, the following description refers to nitrogen as the substantially oxygen-free gas. However, it would be appreciated that other substantially oxygen-free gases described above can be used.

The inlet vestibule 13 includes exhaust nozzles (only one shown) 18a located adjacent to the inlet. The exhaust nozzles 18a draw exhaust gases from above and below the precursor 80 as it passes through the reactor.

A sealing gas supply nozzle 19a is located next to the exhaust nozzles in the inlet vestibule 13. The sealing gas supply nozzle 19a is adapted to provide a gas curtain of process gas across the vestibule 13. The gas curtain acts to limit the ingress of air from the atmosphere surrounding the reactor through the inlet 11. In addition, the gas curtain limits the egress of gas out of the reaction chamber 17.

The gas flow rates through the sealing gas supply nozzles 19a, 19b and the exhaust nozzles 18a, 18b are controlled so as to effectively seal the reaction chamber 17, thus providing the substantially oxygen-free atmosphere within it, and to limit incidental gas flow out of the reactor through the inlet 11. Ideally, the gas flows through the sealing gas supply nozzle 19a and the exhaust nozzles 18a are controlled so that there is no incidental gas flow out of the reactor 10 through the inlet 11 and so that there is no ingress of air from the surrounding atmosphere past the exhaust nozzle 18a. However, in practice, the reactor 10 will be operated at a slight positive pressure so that a minor amount of fugitive emissions are emitted from out the inlet 11. The makeup of the fugitive emissions will be primarily nitrogen, with the HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Sensors are located at the inlet 11 in order to monitor the composition of the emissions to ensure operator safety. Furthermore, there is monitoring of the oxygen levels within the vestibule 13 to ensure that a substantially oxygen-free atmosphere is maintained within the reaction chamber 17. In practice, operating the reactor 10 with a slight over pressure, helps ensure that none of the air from the atmosphere surrounding the reactor can get into the reaction chamber 17.

In some embodiments, the reactor 10 may be fitted with a secondary external exhaust management system in order to collect any fugitive emissions and direct them to an exhaust abatement system. This secondary external exhaust management system can provide additional operator safety.

At the end of the vestibule 13, there is an internal inlet slot and a process gas delivery nozzle 110a. The precursor passes through the internal inlet, past the process gas delivery nozzle 110a and into a transitional region 120a, where the return nozzle 151a for the first zone 171 of the reaction chamber 17 is located, before entering the main portion of the main first zone 171 of the reaction chamber 17.

The length of the vestibule 13 and the temperature of the gas blown into the reactor 10 are selected so that the precursor is not brought up to reaction temperature until it is located within the substantially oxygen-free atmosphere. The precursor then passes through the two zones 171, 172 of the reaction chamber 17 before reaching the transitional zone 120b at the second reaction zone return nozzle 151b. At the end of the transitional zone 120b, another process gas delivery nozzle 110b is located and beyond that there is an outlet vestibule 14.

In some embodiments, the exhaust gas stream exits the reactor 10 through pipes 181a, 181b at a temperature of 150-200° C. and a pressure of −30 to −2 millibar, for example −10 to −6 millibar. The sealing gas may be emitted at a temperature of 200-250° C. at a pressure of 20.68 to 344.7 kPa (3 to 50 psi) through lines 191a, 191b. In general, it is preferred to keep the pressure of the flow of sealing gas as low as possible, while still ensuring that an effective gas curtain is produced, in order to minimise disturbance of the fibres.

The process gas can be emitted from the process gas delivery nozzles 110a, 110b using lines 1101a, 1101b at a temperature of 250-310° C. e.g. 290-310° C. The gas may be emitted at a velocity of 0.1 to 1.5 m/s, for example the velocity may be 0.5 to 0.75 m/s.

As shown in FIG. 1a, the outlet vestibule 14 has an arrangement of process gas delivery nozzle 110b, sealing gas supply nozzle 19b, and exhaust nozzles 18b (only one shown) that generally mirrors the arrangement shown for the inlet vestibule 13. Once again, the flow rate of the exhaust gasses through the exhaust nozzles 18b and the flow rate of process gas used to provide a gas curtain across the outlet vestibule 14 are ideally controlled to ensure that a substantially oxygen-free atmosphere is provided within the reaction chamber 17 and to ensure that there is no incidental gas flow out of the outlet from the reactor 10. However, as described above with reference to the inlet 11, typically in practice the reactor 10 will be operated slightly over pressure so that there will be a minor amount of fugitive emissions. These emissions will be predominantly nitrogen (i.e., the process gas) and outside the outlet there will be monitoring HCN so as to ensure that the fugitive emissions have a HCN content that does not exceed 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm.

Also similarly to the inlet vestibule 13, at the outlet vestibule 14 there is also oxygen monitoring so as to ensure that a substantially oxygen-free atmosphere is still being maintained towards the outlet end of the reaction chamber 17.

In some embodiments, the reactor 10 will include a secondary external exhaust management system at the outlet 12 for the same reasons that a secondary external exhaust management system may be positioned at the inlet 11.

The temperature of the gas provided by the sealing gas supply nozzle 19b to the outlet vestibule 14 and the length of the outlet vestibule 14 is selected so as to ensure that the precursor cools prior to passing through the outlet 12. The precursor will be cooled such that it is below the reaction temperature prior to exiting the reactor 10 so as to ensure that the precursor does not continue to react and, as such, evolve HCN once it is outside the reactor as this would pose a safety risk.

In some embodiments, the positions of the exhaust nozzles 18a, 18b and the sealing gas supply nozzles 19a, 19b can be reversed so that the sealing gas supply nozzles 19a, 19b are located closest to the inlet 11 and outlet 12, respectively, with the exhaust nozzles 18a, 18b being located inwardly adjacent to each sealing gas supply nozzle 19a, 19b.

In some embodiments, the reactor 10 will include at least one sensor at each end for monitoring whether the atmosphere immediately external to the inlet 11 or outlet 12 has an oxygen content that does not fall lower than 20.9%.

The reactor 10 illustrated in FIG. 1a has two reaction zones 171, 172, each generally provided with its own forced gas flow assembly. However, it can be seen that at the centre of the reaction chamber 17 a common midpoint process gas delivery nozzle 153 is provided so as to ensure the flow of gas is supplied along the entire length of the reaction chamber 17.

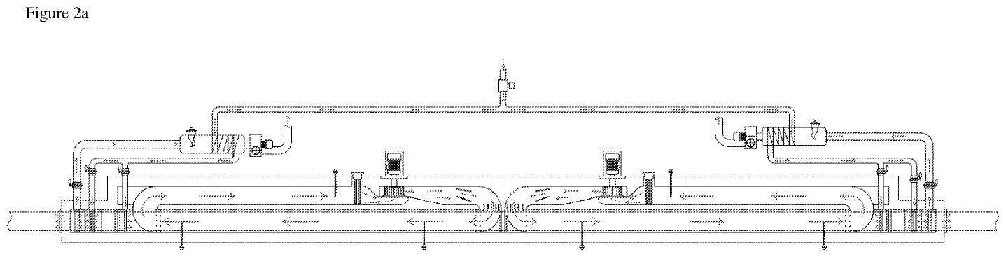

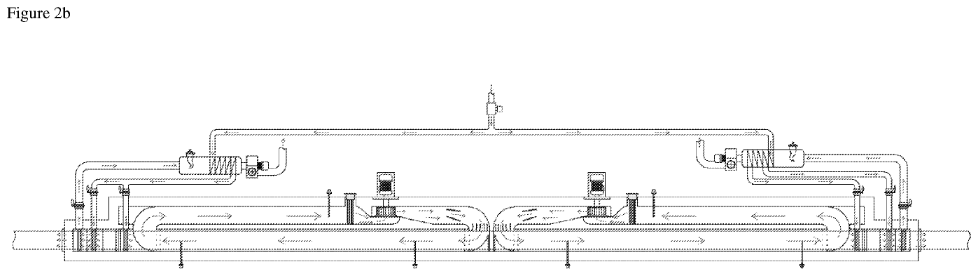

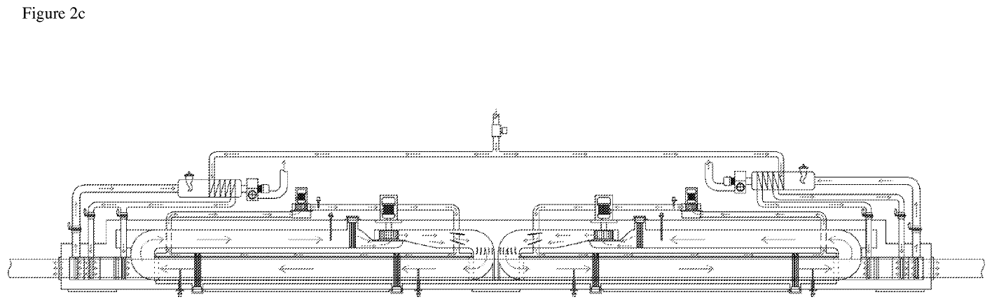

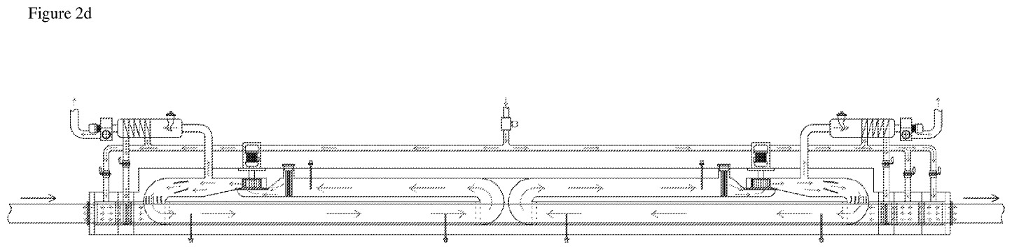

FIG. 2a is annotated with arrows illustrating the flow of gasses through this embodiment of the reactor 10.

The structures of the forced gas flow assemblies for the two reaction zones 171, 172 are mirrored. The assemblies are adapted to predominantly supply process gas to the reaction chamber 17 from the centre to the ends. That is, most of the hot process gas supplied to the reaction chamber 17 is supplied from the centre of the chamber through the main process gas delivery nozzles 152a, 152b and flows towards the ends of the chamber 17. A smaller proportion of process gas is delivered by the process gas delivery nozzles 110a, 110b located towards the inlet 11 and outlet 12.

The process gas delivery nozzles 110a, 110b towards the inlet 11 and outlet 12 are connected to the source of process gas 140 and are for supplying fresh process gas to the chamber 17. The bulk of the process gas in the reactor 10 is recirculated by the forced gas flow assemblies during operation of the reactor 10. That is, the supply of fresh process gas is provided to compensate for losses through the exhaust nozzles 18a, 18b.

In some embodiments, either or each of the process gas delivery nozzles 110a, 110b and/or either or each of the sealing gas supply nozzles 19a, 19b may include upper and lower output tubes located so as to be positioned above and below the precursor, with each output tube having a slot shaped aperture for directing gas towards the precursor. In some embodiments, either or each of the process gas delivery nozzles 110a, 110b and/or either or each of the sealing gas supply nozzles 19a, 19b may include upper and lower output tubes located so as to be positioned above and below the precursor, with each output tube having a slot shaped aperture for directing process gas towards a distributor. The distributor is for directing and distributing the flow of gas across the width of the precursor. An example of such a nozzle configuration is illustrated in FIG. 1e for process gas nozzle 110b of the fourth illustrated embodiment of the reactor 10.

Typically, so as to provide the process gas with good flow uniformity as it flows through the reaction chamber 17, the forced gas flow assembly will be such that the process gas flows largely parallel to the passage of the precursor through the reactor 10.

A centre-to-end supply of the process gas, as illustrated in FIG. 2a, can be preferred as it provides good uniformity to the process gas flow throughout the reaction chamber 17. With this arrangement, the majority of the gas is flowing parallel to the precursor. The gas flow uniformity may be such that there is only a 1% to 10% variation in gas flow across each of the width, height, and length of the reaction chamber 17.

It will be appreciated from FIG. 2a that in the first reaction zone 171 the gas flow is provided on a counter-flow basis to the passage of the precursor through the reaction chamber 17. In the second reaction zone 172, the gas flow is provided as a co-flow with the passage of the precursor.

Typically, the gas flow rate will be such that the temperature measured adjacent to the precursor is within 40° C. of the temperature of the process gas, preferably within 30° C. of the temperature of the process gas. In some embodiments, the gas flow rate may be such that the actual precursor temperature is within 50° C. of the temperature of the process gas, preferably within 40° C. of the temperature of the gas, more preferably within 30° C. of the temperature of the gas. The velocity of the process gas flow may be 0.5 to 4.5 m/s, for example it may be 2 to 4 m/s.

In this embodiment, the process gas flow used should be such that the Reynolds number of the flow is above 100,000 when calculated at points further than 1.0 m, along the direction of the gas flow, from the feed element 1521a, 1521b of the main process gas delivery nozzles 152a, 152b.

As discussed above, other arrangements for providing the process gas to the reaction chamber can be used. However, a forced gas flow assembly adapted to provide a centre-to-ends flow of process gas or ends-to-centre flow of process gas is typically preferred. An embodiment of the reactor with an ends-to-centre flow of process gas is described below with reference to FIGS. 1d, 1e and 2d.

The reaction chamber 17 may have an effective heated length of 2,000-17,000 mm. The reaction chamber 17 height may be 100-1,600 mm. The reaction chamber 17 width may be 100-3,500 mm. The size of the reaction chamber 17 may be selected on the basis of the desired throughput volume of the precursor. Reactors 10 with dimensions towards the lower ends of the ranges noted above may be suited to research and development applications, with production volumes of around 1 tonne per year. Reactors 10 with dimensions towards the higher ends of the ranges noted above may be suited to use in commercial applications, with production volumes of up to 2,500 tonne per year. For example, production volumes up to 2,000 tonne per year or up to 1,500 tonne per year.

Subject to the size of the reaction chamber 17, the exhaust volume may be 25 Nm³/min to 3,000 Nm₃/min, with an associated consumption of process gas of 100 l/min to 5,000 l/min.

Each forced gas flow assembly is provided with a gas return duct 156a, 156b along which a heater 157a, 157b is disposed. Downstream from the heater 157a, 157b is a fan 158a, 158b that is used to draw the process gas through the heater 157a, 157b, thus bringing it up to the process temperature. The gas is then blown by the fan 158a, 158b through the inlet plenum 159a, 159b and out the main process gas delivery nozzle 152a, 152b. As noted above, a portion of the process gas from each inlet plenum 159a, 159b is also directed through the midpoint process gas delivery nozzle 153. In order to achieve this, the rear walls of the nozzle ducts include an array of nozzle apertures to direct the portion of process gas to the midpoint process gas delivery nozzle 153. However, the majority of the process gas from the inlet plenum 159a, 159b is directed through the nozzle duct out the main process gas delivery nozzle 152a, 152b.

The main process gas delivery nozzles 152a, 152b are located above and below the precursor and each nozzle includes a feed element 1521a, 1521b. In this embodiment, each feed element 1521a, 1521b comprises an array of feed nozzle tubes (not shown).

Each process gas inlet plenum 159a, 159b has primary gas flow distribution baffles 154a, 154b and secondary gas flow distribution baffles 155a, 155b to assist in assist in providing a uniform gas flow through the nozzle 152a, 152b. Once the process gas has passed along the reaction chamber 17, it is then directed through the return nozzle 151a, 151b back into the return duct 156a, 156b. However, a portion of the process gas will flow out of the reaction chamber 17 into either the inlet or outlet vestibule 13, 14, carrying with it reaction by-products that are ultimately removed from the reactor 10 via the exhaust nozzles 18a, 18b.

Each return nozzle 151a, 151b includes an exit element 1511a, 1511b. In this embodiment, each exit element 1511a, 1511b terminates with a perforated sheet defining the array of exit nozzle apertures. However, in some other embodiments, each exit element 1511a, 1511b comprises an array of exit nozzle tubes.

The process gas flowing through the reaction chamber 17 may be from 200-400° C. Accordingly, the surface temperature of the heater 157a, 157b typically will not exceed 450° C.

In this illustrated embodiment, the reaction chamber 17 has thermocouples 1301a, 1301b, 1302a, 1302b for monitoring the temperature of the process gas located in each reaction zone 171, 172 near the main process gas delivery nozzle 152a, 152b and then towards the other end of the reaction zone 171, 172 nearer to the inlet 11 or outlet 12, respectively. So as to monitor the temperature of the process gas, thermocouples 1301a, 1301b, 1302a, 1302b are located so as to measure the temperature of the gas flow at least 30 mm away from the precursor, preferably at least 40 mm away from the precursor, more preferably at least 50 mm away from the precursor.

The reactor also includes a thermocouple 1303a, 1303b in each return duct 156a, 156b for monitoring the temperature of the gas prior to it being drawn through the heater 157a, 157b.

In this embodiment, and in the other illustrated embodiments described herein, the reactor may comprise gas velocity sensors, in the form of anemometers or manometers, to monitor the velocity of the forced gas flow through the reactor. If provided, the or each gas velocity sensor can be co-located with a thermocouple.

The reactor is provided with an integrated abatement system 16a, 16b at each end. The abatement system 16a, 16b includes a burner 161a, 161b for combusting the exhaust gases at 700-850° C. so as to destroy polluting reaction by-products, such as HCN. The burner 161a, 161b may be operated using natural gas. The combustion gases are then mixed with fresh air and the mixture vented to atmosphere along a duct 162a, 162b.

Each abatement system 16a, 16b incorporates a heat exchanger 163a, 163b that allows heat to be transferred from the hot combustion gasses to the fresh substantially oxygen-free gas that has been supplied to the reactor 10 along a line 1401a, 1401b. In the present embodiment, the substantially oxygen-free gas is nitrogen. Thus, the cool nitrogen is heated by the combustion gasses so that warm nitrogen can be supplied via a line 1402a, 1402b to the sealing gas nozzle 19a, 19b and the process gas delivery nozzle 110a, 110b located at the inlet and outlet vestibules 13, 14. Similarly, the combustion gasses will be cooled prior to being vented to atmosphere. Thus, the heat exchanger 163a, 163b enables there to be energy recovery from the abatement system 16a, 16b, reducing the overall energy consumption of the reactor 10.

For example, in some embodiments, the energy consumption of the reactor 10 may be 5 kW to 40 kW.

FIG. 1b illustrates a second embodiment of the reactor 10 that has a similar structure to the first embodiment of the reactor shown in FIG. 1a, except in this second embodiment, the reactor does not include a supply line 1402b. Instead, the process gas and sealing gas are fed to the reactor by two separate lines 1101b, 191b from the heat exchanger 163b.

The line 1401b supplying fresh substantially oxygen-free gas is connected to the heat exchanger 163b of the integrated abatement system 16b, as in the first embodiment of the reactor described above with reference to FIG. 1a. Prior to being emitted along the duct 162b, the hot combustion gasses are passed through the heat exchanger 163b that allows heat to be transferred from the hot combustion gasses to the fresh substantially oxygen-free gas that has been supplied to the reactor 10 along the line 1401b. In the present case, the substantially oxygen-free gas is nitrogen. Thus, the cool nitrogen is heated by the combustion gasses so that warm nitrogen can be supplied to the reactor 10.

The heat exchanger 163b of this embodiment includes two outlets: one connected to the line 1101b supplying the process gas to the process gas delivery nozzle 110b, and another connected to the line 191b supplying the sealing gas to sealing gas nozzle 19b. The two outlets emit gas that has been subjected to a different degree of heat exchange with the combustion gasses in the heat exchanger 163b. Thus, the heat exchanger 163b is adapted to emit gas heated to two different temperatures. Accordingly, the process gas delivered by line 1101b is at a different temperature to the sealing gas delivered by line 191b. As the pre-stabilised precursor 81 is cooled prior to exiting the reactor through the outlet 12, it is desirable to supply sealing gas at a cooler temperature than the process gas, so that the sealing gas can cool the pre-stabilised precursor 81 as it passes through the outlet vestibule 14.

The process gas can be emitted from the process gas delivery nozzle 110b using line 1101b at a temperature of 290-310° C. In some embodiments, the gas is emitted from the process gas delivery nozzle 110b at a temperature of between 20° C. and 300° C., e.g. between 100° C. and 220° C., or between 100° C. and 160° C., or below 140° C. The gas may be emitted at a velocity of 0.1 to 1.5 m/s, for example the velocity may be 0.5 to 0.75 m/s.

In some embodiments, the exhaust gas stream exits the reactor 10 through pipe 181a, 181b at a temperature of 100-200° C., preferably at a temperature of 120-160° C., and a pressure of −30 to −2 millibar, for example −10 to −6 millibar. The sealing gas may be emitted at a temperature of 20-250° C., preferably 100-250° C., more preferably at a temperature of 120-160° C., at a pressure of 20.68 to 344.7 kPa (3 to 50 psi) through line 191b. In general, it is preferred to keep the pressure of the flow of sealing gas as low as possible, while still ensuring that an effective gas curtain is produced, in order to minimise disturbance of the fibres. The pre-stabilised precursor 81 may exit the reactor at a temperature of between 20° C. and 220° C.

A temperature of less than 220° C. for the pre-stabilised precursor 81 may be desirable for safety reasons, to at least limit or avoid a fire risk.

A temperature of less than 140° C. may be desirable to ensure the pre-stabilised precursor 81 is below the exotherm of the pre-stabilised precursor 81 as determined by differential scanning calorimetry (DSC). This can help to ensure that the pre-stabilised precursor does not undesirably react to a substantial extent before it enters the oxidation reactor.

A temperature of less than 100° C. for the pre-stabilised precursor 81 may be desirable to enable handling of the pre-stabilised precursor.

FIG. 2b is annotated with arrows illustrating the flow of gasses through this embodiment of the reactor 10.

As in the first embodiment illustrated in FIG. 1a, the heat exchanger 163b now illustrated in FIG. 1b enables cool nitrogen to be heated by the combustion gasses so that warm nitrogen can be supplied to the reactor while also cooling the combustion gasses prior to them being vented to atmosphere. Thus, the heat exchanger 163b enables there to be energy recovery from the abatement system 16b, reducing the overall energy consumption of the reactor 10. In some embodiments, the energy consumption of the reactor 10 may be 5 kW to kW.

Although the heat exchanger 163b with two outlets is shown at the end of the reactor 10 closest to the outlet 12, it will be appreciated that the same arrangement can be used for the heat exchanger 163a and lines 191a, 1101a at the end of the reactor 10 closest to the inlet 11.

FIG. 1c illustrates a third embodiment of the reactor 10 that has a similar structure to the second embodiment of the reactor shown in FIG. 1b, except that the reactor 10 includes heating system comprising heating elements 101a, 101b for externally heating the reaction chamber 17 in addition to the forced gas flow assembly.

In this embodiment, the heating system includes heating elements 101a, 101b for each of the reaction zones 171, 172 that are positioned above and below the reaction chamber 17. For each zone 171, 172, heating elements 101a, 101b are located above and below the reaction chamber 17 along the length of the relevant zone so that they are proximal the feed element 1521a, 1521b and further heating elements 101a, 101b are located above and below the reaction chamber 17 proximal to the exit element 1511a, 1511b.

So as to distribute the heat from the heating elements along the reaction chamber 17, the heating elements 101a, 101b are positioned within a heating jacket 102 containing a heat transfer medium. In this embodiment, the heat transfer medium is air.

The heat transfer medium is circulated within the heating jacket 102 to transfer heat from the heating elements 101a, 101b to the reaction zones 171, 172 of the reactor. The heating system includes medium inlet lines 104a, 104b for providing heat transfer medium to the heating jacket 102. The heating system includes return lines 106a, 106b fluidly connected to the medium inlet lines 104a, 104b for recirculating the heat transfer medium in the heating jacket 102. A fan 105a, 105b is disposed along each return line 106a, 106b to transfer the heat transfer medium along the return lines 106a, 106b and the medium inlet lines 104a, 104b so that in can be recirculated.

It will be appreciated the heating jacket is sealed to retain the heat transfer medium within it in a heat transfer relationship with the walls of the reaction chamber 17. The heating jacket 102 includes an opening 103, around which the heating jacket 102 is sealed, to allow the passing of the ducting from the inlet plenums 159a, 159b to the main process gas delivery nozzle 152a, 152b and the midpoint process gas delivery nozzle 153. The heating jacket 102 extends along the reaction chamber 17 towards the inlet 11 and outlet 12 of the reactor 10. The heating jacket terminates at a point intermediate along the exit element 1511a, 1511b at the end of each zone 171, 172. Thus, the heating jacket 102 surrounds the reaction zones 171, 172 along their full length between the exit elements 1511a, 1511b and the feed elements 1521a, 1521b.

In this illustrated embodiment, the reaction chamber 17 has thermocouples 1301a, 1301b, 1302a, 1302b for monitoring the temperature of the process gas located in each reaction zone 171, 172 near the main process gas delivery nozzle 152a, 152b and then towards the other end of the reaction zone 171, 172 nearer to the inlet 11 or outlet 12, respectively. The reactor also includes a thermocouple 107a, 107b in each medium inlet lines 104a, 104b for monitoring the temperature of the heat transfer medium prior to it being fed into heating jacket 102.

The temperatures measured using thermocouples has thermocouples 1301a, 1301b, 1302a, 1302b, 107a, 107b will be used to assess whether the temperature of the heating elements 101a, 101b is at an appropriate level and whether the heat transfer medium is being recirculated through the heating jacket 102 at suitable rate.

FIG. 2c is annotated with arrows illustrating the flow of gasses through this embodiment of the reactor 10, including the flow of heat transfer medium through the heating system comprising the heating jacket 102, medium inlet lines 104a, 104b and return lines 106a, 106b.

It will be appreciated that additional heating elements and other arrangements and configurations of heating systems comprising heating elements may be used in other embodiments. For example, each zone of the reaction chamber may be provided with a separate heating sub-structure including heating elements and a heating jacket containing a heat transfer medium that is recirculated as described for this illustrated embodiment. Suitable heating systems may include structures similar to those used in carbonisation furnaces, but it will be appreciated that the typical operating temperature of pre-stabilisation reactors are considerably less than the temperatures conventionally employed in carbonisation furnaces.

FIG. 1d provides a schematic view of a fourth embodiment of the reactor 10. In this embodiment, conveying rollers (not shown) are positioned outside the reactor 10 and do not form part of the reactor 10. In some other embodiments, the reactor 10 may include externally located drive rollers that co-operate with the components of the system to pass the precursor 80 through the reactor 10 and provide it to downstream components of the system.

Similarly to the reactors illustrated by FIGS. 1a, 1b, 1c, 2a, 2b and 2c, in use, the interior of the reactor 10 may be too hot for conventional rollers. Accordingly, there is an inlet 11 and an outlet 12 to allow the precursor 80 to pass between the rollers and the interior of the reactor to produce a pre-stabilised precursor 81. As can be seen from FIG. 1d, the precursor moves through the reactor 10 by passing through an inlet vestibule 13, through the transition area 120a, through the reaction chamber 17, through another transition area 120b, and through an outlet vestibule 14, before exiting via the outlet 12.

A sealing gas supply inlet 193a is located in the inlet vestibule 13. The sealing gas supply inlet 193a is adapted to provide a gas curtain of process gas across the vestibule 13. The gas curtain acts to limit the ingress of air from the atmosphere surrounding the reactor through the inlet 11. In addition, the gas curtain limits the egress of gas out of the reaction chamber 17. The sealing gas supply inlet 193a and the sealing gas curtain provided by it is described further below, when the sealing gas supply inlet 193b in the outlet vestibule 14 is described.

The reactor 10 illustrated in FIG. 1b has two reaction zones 171, 172, each generally provided with its own forced gas flow assembly.

FIG. 2d is annotated with arrows illustrating the flow of gasses through this embodiment of the reactor 10.

The structures of the forced gas flow assemblies for the two reaction zones 171, 172 are mirrored. The assemblies are adapted to predominantly supply process gas to the reaction chamber 17 from the ends of the reaction chamber to the centre. That is, most of the hot process gas supplied to the reaction chamber 17 is supplied from each end of the chamber through the main process gas delivery nozzles 152a, 152b and flows towards the ends of the chamber 17. A smaller proportion of process gas is delivered by the process gas delivery nozzles 110a, 110b located towards the inlet 11 and outlet 12.

The process gas delivery nozzles 110a, 110b towards the inlet 11 and outlet 12 are connected to the source of process gas 140 and are for supplying fresh process gas to the chamber 17. The bulk of the process gas in the reactor 10 is recirculated by the forced gas flow assemblies during operation of the reactor 10. That is, the supply of fresh process gas is provided to compensate for losses through the exhaust outlets 183a, 183b.

Typically, so as to provide the process gas with good flow uniformity as it flows through the reaction chamber 17, the forced gas flow assembly will be such that the process gas flows largely parallel to the passage of the precursor through the reactor 10.

An ends-to-centre supply of the process gas, as illustrated in FIG. 2d, can be preferred as it provides good uniformity to the process gas flow throughout the reaction chamber 17. With this arrangement, the majority of the gas is flowing parallel to the precursor. The gas flow uniformity may be such that there is only a 1% to 10% variation in gas flow velocity across each of the width, height, and length of the reaction chamber 17.

It will be appreciated from FIG. 2d that in the first reaction zone 171 the gas flow is provided on a co-flow basis to the passage of the precursor through the reaction chamber 17.

In the second reaction zone 172, the gas flow is provided as a counter-flow with the passage of the precursor.

An ends-to-centre supply of the process gas can be preferred as the direction of gas flow through the gas delivery nozzles 152a, 152b is complementary to the direction of gas flow from the process gas delivery nozzles 110a, 110b. Thus, the ends-to-centre supply of the process gas may facilitate efficient inflow of the fresh process gas into the reaction chamber 17.

Typically, the gas flow rate in the reaction chamber 17 will be such that the temperature measured adjacent to the precursor is within 40° C. of the temperature of the process gas, preferably within 30° C. of the temperature of the process gas. In some embodiments, the gas flow rate may be such that the actual precursor temperature is within 50° C. of the temperature of the process gas, preferably within 40° C. of the temperature of the gas, more preferably within 30° C. of the temperature of the gas. The velocity of the process gas flow may be 0.5 to 4.5 m/s, for example it may be 2 to 4 m/s.

In this embodiment, the process gas flow used should be such that the Reynolds number of the flow is above 100,000 when calculated at points further than 1.0 m, along the direction of the gas flow, from the feed element 1521a, 1521b of the main process gas delivery nozzles 152a, 152b.

As discussed above, other arrangements for providing the process gas to the reaction chamber can be used. However, a forced gas flow assembly adapted to provide a centre-to-ends flow of process gas or ends-to-centre flow of process gas is typically preferred. Some embodiments of the reactor with a centre-to-ends flow of process gas is described above with reference to FIGS. 1a, 1b, 1c, 2a, 2b and 2c.

Each forced gas flow assembly is provided with a gas return duct 156a, 156b along which a heater 157a, 157b is disposed. Downstream from the heater 157a, 157b is a fan 158a, 158b that is used to draw the process gas through the heater 157a, 157b, thus bringing it up to the process temperature. The gas is then blown by the fan 158a, 158b through the inlet plenum 159a, 159b and out the main process gas delivery nozzle 152a, 152b.

The gas return ducts 156a, 156b each include an exhaust outlet 183a, 183b. The exhaust outlets 183a, 183b draw exhaust gases from the gas flow recirculated along the gas return ducts 156a, 156b. In some embodiments, the exhaust gas stream exits the reactor 10 through pipes 181a, 181b at a temperature of 200-400° C. and a pressure of −30 to −2 millibar, for example −10 to −6 millibar. As the exhaust gas is being bled from the process gas stream being recirculated, the exhaust gas stream will typically exit the reactor at a temperature equal to or close to the desired process gas temperature.

The use of exhaust outlets 183a, 183b to draw exhaust gasses from the gas return ducts 156a, 156b may enable more exhaust gases to be removed than embodiments such as those illustrated in FIGS. 1a, 1b, 1c, 2a, 2b and 2c in which exhaust nozzles 18a, 18b are located in the inlet vestibule 13 and outlet vestibule 14.

Notwithstanding a capacity to draw a greater amount of exhaust gas by providing an exhaust outlet 183a, 183b in the gas return duct 156a, 156b, it is desirable to minimise the exhaust draw to minimise the consumption of process gas and sealing gas. In practice, the amount of exhaust draw will be determined by the precise reactor configuration, the nature of the precursor and the nature and amount of reaction by-products produced during pre-stabilisation, as well as the draw rate necessary to balance gas flows so that the sealing of the reactor is effective.

In some embodiments, it may be desirable to provide exhaust nozzle(s) in the inlet and outlet vestibules in addition to an exhaust outlet in the return duct. Suitable exhaust nozzle configurations may include those described above with reference to FIGS. 1a, 1b, 1c, 2a, 2b and 2c.

Returning to the embodiment illustrated in FIGS. 1d and 2d, the main process gas delivery nozzles 152a, 152b are located above and below the precursor and each includes a feed element 1521a, 1521b. In this embodiment, each feed element 1521a, 1521b comprises an array of feed nozzle tubes.

Each process gas inlet plenum 159a, 159b has primary gas flow distribution baffles 154a, 154b and secondary gas flow distribution baffles 155a, 155b to assist in assist in providing a uniform gas flow through the nozzle 152a, 152b. Once the process gas has passed along the reaction zones 171, 172 towards the centre of the reaction chamber 17, it is then directed through the return nozzle 151a, 151b back into the return duct 156a, 156b. Each return nozzle 151a, 151b includes an exit element 1511a, 1511b. In this embodiment, each exit element 1511a, 1511b terminates with a perforated sheet defining the array of exit nozzle apertures. However, in some other embodiments, each exit element 1511a, 1511b comprises an array of exit nozzle tubes.

The gas flow rates through the sealing gas supply inlets 193a, 193b, process gas delivery nozzles 110a, 110b and the exhaust outlets 183a, 183b are controlled so as to effectively seal the reaction chamber 17, thus providing the substantially oxygen-free atmosphere within it, and to limit incidental gas flow out of the reactor through the inlet 11 and outlet 12. Ideally, the gas flows through the sealing gas supply inlets 193a, 193b, process gas delivery nozzles 110a, 110b and the exhaust outlets 183a, 183b are controlled so that there is no incidental gas flow out of the reactor 10 through the inlet 11 or the outlet 12 and so that there is no ingress of air from the surrounding atmosphere past sealing gas supply inlets 193a, 193b. However, in practice, the reactor 10 will be operated at a slight positive pressure so that a minor amount of fugitive emissions are emitted from out the inlet 11 and outlet 12. As the sealing gas supply inlets 193a, 193b are located adjacent the inlet 11 and outlet 12, the makeup of the fugitive emissions will be primarily nitrogen, with the HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Sensors are located at the inlet 11 and the outlet 12 in order to monitor the composition of the emissions to ensure operator safety. Furthermore, there is monitoring of the oxygen levels within the vestibules 13, 14 to ensure that a substantially oxygen-free atmosphere is maintained within the reaction chamber 17. In practice, operating the reactor with a slight over pressure, helps ensure that none of the air from the atmosphere surrounding the reactor can get into the reaction chamber 17.

In some embodiments, the reactor 10 will include at least one sensor at each end for monitoring whether the atmosphere immediately external to the inlet 11 or outlet 12 has an oxygen content that does not fall lower than 20.9%.

In some embodiments, the reactor 10 may be fitted with a secondary external exhaust management system at the inlet 11 and/or outlet 12 in order to collect any fugitive emissions and direct them to an exhaust abatement system. This secondary external exhaust management system can provide additional operator safety.

The process gas flowing through the reaction chamber 17 may be from 200-400° C. Accordingly, the surface temperature of the heater 157a, 157b typically will not exceed 450° C.

In this illustrated embodiment, the reaction chamber 17 has thermocouples 1301a, 1301b, 1302a, 1302b for monitoring the temperature of the process gas located in each reaction zone 171, 172 near the main process gas delivery nozzle 152a, 152b and then towards the other end of the reaction zone 171, 172 nearer to the inlet 11 or outlet 12, respectively. So as to monitor the temperature of the process gas, thermocouples 1301a, 1301b, 1302a, 1302b are located so as to measure the temperature of the gas flow at least 30 mm away from the precursor, preferably at least 40 mm away from the precursor, more preferably at least 50 mm away from the precursor.

The reactor also includes a thermocouple 1303a, 1303b in each return duct 156a, 156b for monitoring the temperature of the gas prior to it being drawn through the heater 157a, 157b.

The reaction chamber 17 may have an effective heated length of 2,000-17,000 mm. The reaction chamber 17 height may be 100-1,600 mm. The reaction chamber 17 width may be 100-3,500 mm. The size of the reaction chamber 17 may be selected on the basis of the desired throughput volume of the precursor. Reactors 10 with dimensions towards the lower ends of the ranges noted above may be suited to research and development applications, with production volumes of around 1 tonne per year. Reactors 10 with dimensions towards the higher ends of the ranges noted above may be suited to use in commercial applications, with production volumes of up to 2,500 tonne per year. For example, production volumes up to 2,000 tonne per year or up to 1,500 tonne per year.

Subject to the size of the reaction chamber 17, the exhaust volume may be 25 Nm³/min to 3,000 Nm³/min, with an associated consumption of process gas of 100 l/min to 5,000 l/min.

At the end of the inlet vestibule 13, there is an internal inlet slot and a process gas delivery nozzle 110a. The precursor passes through the internal inlet, past the process gas delivery nozzle 110a and into a transitional region 120a, where the main process gas delivery nozzle 152a for the first zone 171 of the reaction chamber 17 is located, before entering the main portion of the main first zone 171 of the reaction chamber 17.

The length of the vestibule 13 and the temperature of the gas blown into the reactor 10 are selected so that the precursor is not brought up to reaction temperature until it is located within the substantially oxygen-free atmosphere. The precursor then passes through the two zones 171, 172 of the reaction chamber 17 before reaching the transitional zone 120b at the second reaction zone main process gas delivery nozzle 152b. At the end of the transitional zone 120b, another process gas delivery nozzle 110b is located and beyond that there is an outlet vestibule 14.

The sealing gas may be emitted at a temperature of 100-180° C. at a pressure of 20.68 to 344.7 kPa (3 to 50 psi) through lines 191a, 191b. As the pre-stabilised precursor 81 passes through sealing gas curtain provided by the outbound sealing gas supply inlet 193b immediately before exiting the reactor through the outlet 12, it may be desirable for the sealing gas to be supplied at or below the desired exit temperature of the pre-stabilised precursor.

In general, it is preferred to keep the pressure of the flow of sealing gas as low as possible, while still ensuring that an effective gas curtain is produced, in order to minimise disturbance of the fibres.

The process gas can be emitted from the process gas delivery nozzles 110a, 110b using lines 1101a, 1101b at a temperature of 250-310° C., e.g. 290-310° C. The gas may be emitted at a velocity of 0.1 to 1.5 m/s, for example the velocity may be 0.5 to 0.75 m/s.

As shown in FIG. 1d, the outlet vestibule 14 has a process gas delivery nozzle 110b and outbound sealing gas supply inlet 193a. In addition, the reactor 10 comprises a cooling gas inlet 108 between the process gas delivery nozzle 110b and outbound sealing gas supply inlet 193a. The cooling gas inlet is adapted to provide a curtain of cooling gas as the pre-stabilised precursor 81 passes through the outlet vestibule 14.

As shown in FIG. 1d, lines 191a, 191b connected to the sealing gas supply inlets 193a, 193b and line 1081 connected to the cooling gas inlet 108 are branched from the lines 1401a, 1401b supplying fresh process gas from the source of process gas 140. Thus, the gas emitted from each of the sealing gas supply inlets 193a, 193b and cooling gas inlet 108 may be at the temperature of the gas supplied from the source of process gas 140. The source gas may be heated, cooled or supplied at ambient temperature.

The temperature of the cooling gas provided by cooling gas inlet 108 (and the temperature of the sealing gas provided) to the outlet vestibule 14 and the length of the outlet vestibule 14 is selected so as to ensure that the precursor cools prior to passing through the outlet 12.

The length of the cooling gas curtain provided by cooling gas inlet 108, as well as the flow characteristics of the gas curtain, can also be selected so as to achieve the desired degree of cooling. The precursor will be cooled such that it is below the reaction temperature prior to exiting the reactor 10 so as to ensure that the precursor does not continue to react and, as such, evolve HCN once it is outside the reactor 10 as this would pose a safety risk.

FIG. 1e shows a schematic cross-section view of a section of FIG. 1d, as indicated with the broken lines on FIG. 1d, that illustrates in further detail the outlet vestibule section 14 of the reactor 10. FIG. 1e shows the secondary gas flow distribution baffles 155b for directing gas into the upper and lower main process gas delivery nozzles 152b, 152b′ that each include a feed element 1521b, 1521b′ in the transition zone 120b. It will be appreciated that this structure is mirrored for the secondary gas flow distribution baffles 155a, the upper and lower main process gas delivery nozzles 152a, and feed elements 1521a in the transition zone 120a.

As the pre-stabilised precursor 81 leaves the transition zone and enters the outlet vestibule 14 it passes through the process nozzle 110b. As shown in FIG. 1e, the process gas nozzle 110b includes upper and lower output tubes 1104b, 1104b′ located so as to be positioned above and below the precursor. Each output tube 1104b, 1104b′ has a slot shaped aperture 1102b, 1102b′ for directing process gas towards a distributor 1103b, 1103b′ for directing and distributing the flow of process gas across the width of the precursor. It will be appreciated that the same structure is used for process gas nozzle 110a. The process gas flow rates through the process gas nozzles 110a, 110b may be from 100 to 5,000 l/min.

The precursor then passes through the cooling gas inlet 108 in the outlet vestibule 14. The cooling gas inlet 108 include upper and lower plenums 1084, 1084′ into which cooling gas is provided via the upper and lower cooling gas supply inlets 1082, 1082′. Each plenum 1084, 1084′ includes a plenum plate 1083, 1083′ that includes an array of apertures for producing jets of cooling gas that impinge upon the precursor 81. A positive gas pressure will be provided behind each plenum plate 1083, 1083′. The pressure is typically less than about 1 kPa, with the gas being ejected at velocity through the apertures. Impingement velocity will vary, at least in part according to the fragility of the precursor 81, and is typically less than about 0.5 msec. The cooling gas flow rate through the cooling gas inlet 108 may be from 125 to 6250 I/min.

In some embodiments, the opening area defined by the perimeter of each aperture of the plenum plates 1083, 1083′ is about 0.5-20 mm². For example, the area may be 0.79 mm², 3.14 mm², 7.07 mm², 12.57 mm², or 19.63 mm², preferably about 7.07 mm². In some embodiments, the apertures are circular. Thus, the aperture diameter in some embodiments is about 1, 2, 3, 4, or 5 mm, and preferably about 3 mm. In some embodiments, the apertures are slots. The slots may be 2-20 mm long with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor 81. In other embodiments, the slots will be orientated so that they are perpendicular to the direction of travel of the precursor. In some embodiments, the slots will be orientated at an angle relative to the direction of travel of the precursor, such as 45°.

Before exiting the reactor 10, the precursor 81 passes through the sealing gas supply inlet 193b in the outlet vestibule 14. The sealing gas supply inlet 193a includes upper and lower plenums 1934b, 1934b′ into which sealing gas is provided via the upper and lower sealing gas supply inlets 1932b, 1932b′. Each plenum 1934b, 1934b′ includes a plenum plate 1933b, 1933b′ that includes an array of apertures for producing jets of gas to form a sealing gas curtain at the outlet 12. A positive gas pressure will be provided behind each plenum plate 1933b, 1933b′. The pressure is typically less than about 1 kPa, with the gas being ejected at velocity through the apertures. Impingement velocity will vary, at least in part according to the fragility of the precursor 81, and is typically less than about 0.5 msec. It will be appreciated that the same structure is used for sealing gas supply inlet 193a. The sealing gas flow rates through the sealing gas supply inlets 193a, 193b may be from 110 to 5,500 l/min.

Similarly to plenum plates 1083, 1083′, in some embodiments of the plenum plates 1933b, 1933b′, the opening area defined by the perimeter of each aperture is about 0.5-20 mm². For example, the area may be 0.79 mm², 3.14 mm², 7.07 mm², 12.57 mm², or 19.63 mm², preferably about 7.07 mm². In some embodiments, the apertures are circular. Thus, the aperture diameter in some embodiments is about 1, 2, 3, 4, or 5 mm, and preferably about 3 mm. In some embodiments, the apertures are slots. The slots may be 2-20 mm long with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor 81. In other embodiments, the slots will be orientated so that they are perpendicular to the direction of travel of the precursor. In some embodiments, the slots will be orientated at an angle relative to the direction of travel of the precursor, such as 45°.

At the outlet 12, the reactor 10 includes a choke mechanism comprising comprises two sliding plates 109, 109′ with each plate 109, 109′ sliding independently of the other such that the position of the opening formed between the two plates to permit passage of the precursor 81 may be altered between an upper position, a lower position and any intermediate positions therebetween. The separation of sliding plates 109, 109′ may be adjusted to provide the minimum working gap, that can accommodate for the catenary sag of the precursor, at the outlet 12 to minimise ingress of air from the atmosphere surrounding the reactor outlet 12. The same choke mechanism is also provided at the inlet 11 of the reactor 10.

The reactor is provided with an integrated abatement system 16a, 16b at each end. The abatement system 16a, 16b includes a burner 161a, 161b for combusting the exhaust gases at 700-850° C. so as to destroy reaction by-products, such as HCN. The burner 161a, 161b may be operated using natural gas. The combustion gases are then mixed with fresh air and the mixture vented to atmosphere along a duct 162a, 162b.

Prior to being emitted along the duct 162a, 162b, the hot combustion gasses are passed through a heat exchanger 163a, 163b that allows heat to be transferred from the hot combustion gasses to fresh substantially oxygen-free gas that has been supplied to the reactor 10 along a line 1401a, 1401b. In the present case, the substantially oxygen-free gas is nitrogen. Thus, cool nitrogen supplied via a line 1403a, 1403b to the heat exchanger 163a, 163b and is heated by the combustion gasses so that warm nitrogen can be supplied, via lines 1101a, 1101b, to the process gas delivery nozzle 110a, 110b located at the inlet and outlet vestibules 13, 14. The combustion gasses will be cooled prior to being vented to atmosphere. Thus, the heat exchanger 163a, 163b enables there to be energy recovery from the abatement system 16a, 16b, reducing the overall energy consumption of the reactor 10.

For example, in some embodiments, the energy consumption of the reactor 10 may be 5 kW to 40 kW.

The embodiments described above with reference to FIGS. 1a to 1e and 2a to 2d may be configured to be able to pre-stabilise precursors with widths (e.g. tow band widths for a precursor in fibre form) of up to 3 metres. However, in some embodiments, if the precursor width is greater than 2 meters it may be desirable to modify the reactor to mirror the forced gas flow assembly so that structures are provided on either side of the reaction chamber. In such embodiments, gas return ducts (156a, 156b of FIGS. 1a to 1d), along each of which a heater (157a, 157b of FIGS. 1a to 1d) is disposed, can be provided on either side of the reaction chamber. For each return duct, downstream from the heater a fan (158a, 158b of FIGS. 1a to 1d) is used to draw the process gas through the heater thus bringing it up to the process temperature. The gas is then blown by the fan through an inlet plenum (159a, 159b of FIGS. 1a to 1d) fluidly connected to the return duct. The main process gas delivery nozzle (152a, 152b of FIGS. 1a to 1d) and midpoint process gas delivery nozzle (153 of FIGS. 1a to 1c) (if used) can be adapted to accommodate gas inputs from opposed pairs of inlet plenums so that a suitable forced gas flow can be provided across the whole width of the precursor. In some embodiments, the structures of the inlet and out let vestibules may also be mirrored to provide the desired supply of process gas, sealing gas, and cooling gas and the desired exhaust extraction across the full width of the vestibule.

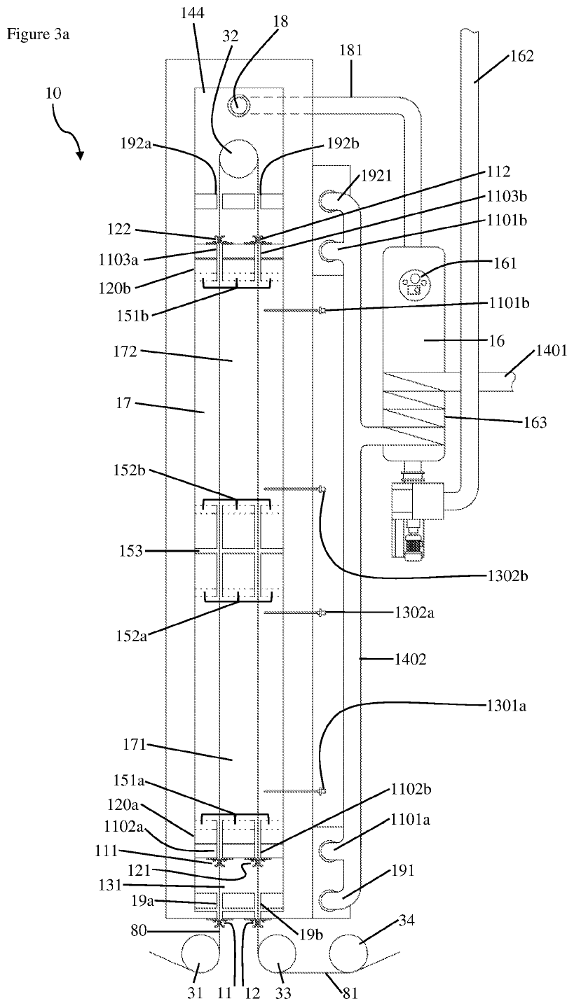

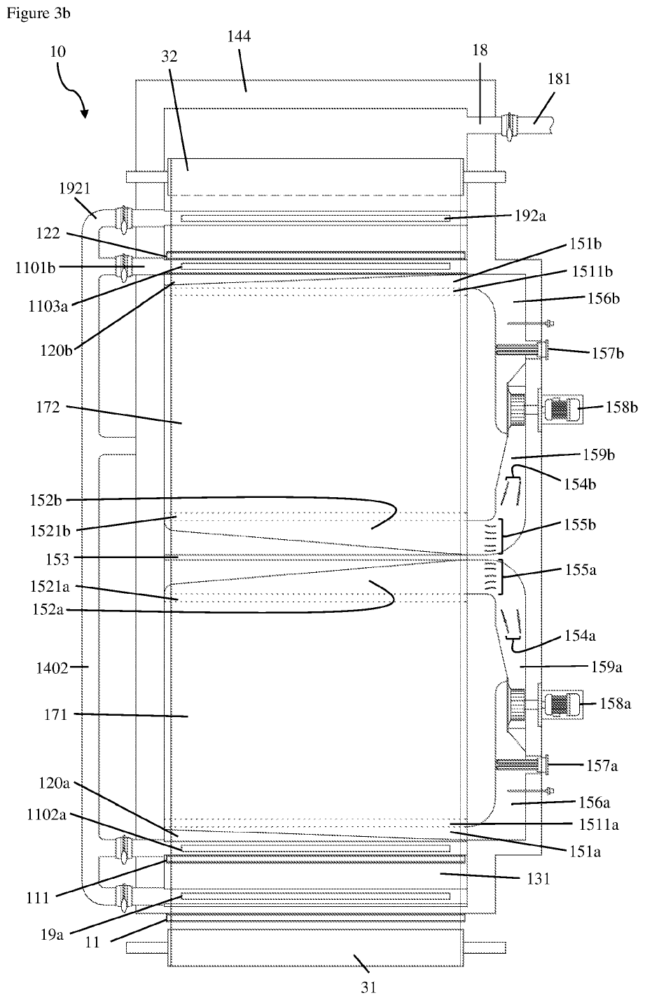

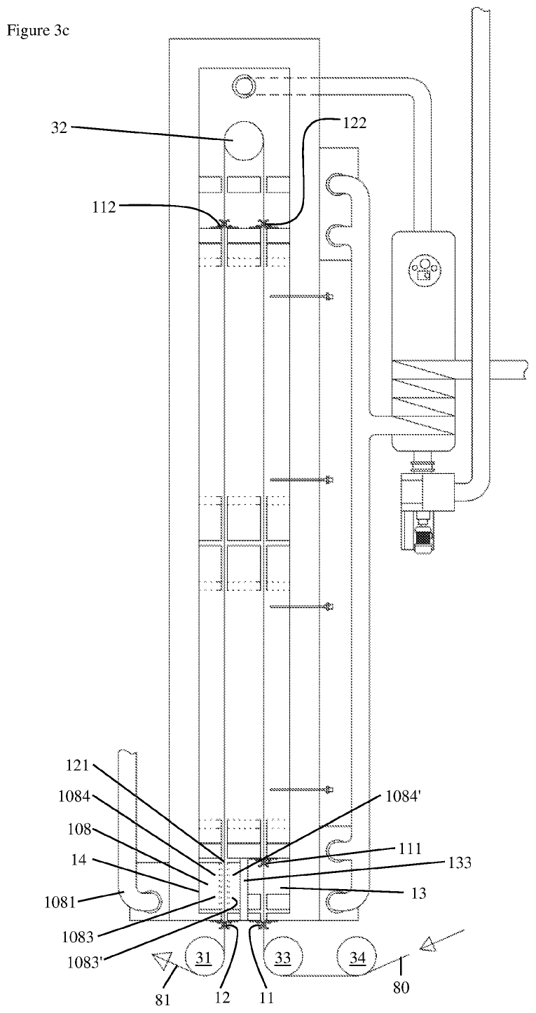

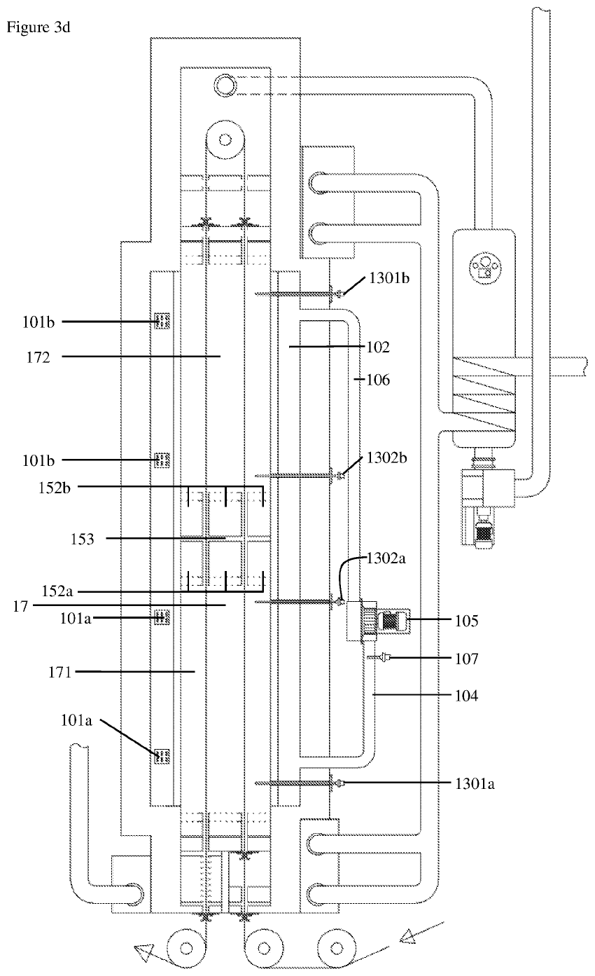

FIGS. 3a and 3b illustrate views of a reactor 10 suitable for being retrofit to existing production lines. In order to provide a small footprint for the reactor 10, thus enabling it to be retrofit on an existing line, the reaction chamber is orientated vertically. Furthermore, so as to ensure that the precursor 80 is passed through the reaction chamber 17 for a suitable residence time and to ensure that the reactor 10 is not impractically high, the precursor 80 passes through each zone 171, 172 of the reaction chamber 17 twice. So as to allow this to be performed while maintaining the precursor in the substantially oxygen-free atmosphere, the reactor includes an internal return roller 32 at its upper end. The internal return roller 32 is located within an intermediate chamber 144 that includes an exhaust nozzle 18 positioned above the return roller 32 and connected to duct 181. A sealing gas supply nozzle 192a, 192b is positioned below the return roller 32. The sealing gas supply nozzle is configured to provide a curtain of sealing gas above and below each pass of the precursor so as to limit ingress of gas from the atmosphere surrounding the internal idle roller 32, as well as limiting egress of gas out of the reaction chamber 17.

The return roller 32 is a non-driven pass roller. By using a non-driven roller, the roller 32 inherently matches the speed at which the precursor is otherwise being conveyed by upstream and downstream drive stations (not shown). By doing so, it minimises the risk of the precursor rubbing or scuffing on the roller (which may occur if the internal roller is a driven roller with a drive speed that does not match the precursor speed) and subsequent precursor damage that may result.

The inlet 11 and outlet 12 are each located at the lower end of the reactor 10, and a sealing gas supply nozzle 19a, 19b is located next to the inlet 11 and outlet 12 in the vestibule 131. The sealing gas supply nozzle 19a, 19b is adapted to provide a gas curtain of process gas across the vestibule 131. The gas curtain acts to limit the ingress of air from the atmosphere surrounding the reactor through the inlet 11 and outlet 12. In addition, the gas curtain limits the egress of gas out of the reaction chamber 17. It will be appreciated that, due to the symmetrical structure of the reactor 10 of this embodiment, the direction of the precursor through the reactor can be reversed such that the inlet 11 serves as the outlet and the outlet 12 serves as the inlet.

In contrast to the horizontally orientated reactor illustrated in FIGS. 1a and 2a, this embodiment of the reactor does not include an exhaust nozzle in the vestibule 131 at the lower end of the reactor 10. Due to the temperature of the process gas and the exhaust gasses resulting from the pre-stabilisation process, the exhaust gasses will tend to travel towards the upper end of the reactor 10. Accordingly, in this embodiment it is not necessary to also provide an exhaust nozzle at the lower end of the reactor 10, and instead only an exhaust nozzle 18 located at the upper end of the reactor 10 is required.

The gas flow rates for the sealing gas supply nozzles 19a, 19b, 192a, 192b and the exhaust nozzle 18 are controlled so as to effectively seal the reaction chamber 17, thus providing the substantially oxygen-free atmosphere within it, and to limit incidental gas flow out of the reactor 10 through the inlet 11 and outlet 12.

Ideally, the gas flows through the sealing gas supply nozzles 19a, 19b, 192a, 192b and the exhaust nozzle 18 are controlled so that there is no incidental gas flow out of the reactor 10 through the inlet 11 and outlet 12, and so that there is no ingress of air from the surrounding atmosphere. However, in practice, the reactor 10 will be operated at a slight positive pressure so that a minor amount of fugitive emissions are emitted from the inlet 11 and outlet 12. The makeup of the fugitive emissions will be primarily nitrogen, with the HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Sensors are located at the lower end of the reactor 10 in order to monitor the composition of the emissions to ensure operator safety. Furthermore, there is monitoring of the oxygen levels within the vestibule 131 to ensure that a substantially oxygen-free atmosphere is maintained within the reaction chamber 17. In practice, operating the reactor with a slight over pressure, helps ensure that none of the air from the atmosphere surrounding the reactor can get into the reaction chamber 17.

In some embodiments, the reactor 10 may include at least one sensor for monitoring whether the atmosphere immediately external to the inlet 11 and outlet 12 has an oxygen content that does not fall lower than 20.9%.

In some embodiments, the reactor 10 may be fitted with a secondary external exhaust management system at the lower end of the reactor in order to collect any fugitive emissions and direct them to an exhaust abatement system. This secondary external exhaust management system can provide additional operator safety.

At the end of the vestibule 131, there are internal inlet and outlet slots 111, 121 and process gas delivery nozzles 1102a, 1102b. The precursor passes through the internal inlet 111, past the process gas delivery nozzle 1102a and into a transitional region 120a, where the return nozzle 151a for the first zone 171 of the reaction chamber 17 is located, before entering the main portion of the first zone 171 of the reaction chamber 17.

The precursor then passes through the two zones 171, 172 of the reaction chamber 17 before reaching the transitional zone 120b at the second reaction zone return nozzle 151b. At the end of the transitional zone 120b, another process gas delivery nozzle 1103a is located and beyond that there the intermediate chamber 144 in which the return roller 32 is located. The precursor passes through the outlet slot 122 to exit the upper reaction zone 172 and enter the intermediate chamber 144. The return roller 32 then directs the precursor back to the inlet slot 112 so that it is conveyed past the process gas delivery nozzle 1103b, through the transitional zone 120b and the two zones 171, 172 of the reaction chamber 17. The precursor then passes back through the transitional zone 120a located at the lower end of the reactor 17, past the process gas delivery nozzle 1102b and into the vestibule 131.

Each of the inlet 11, outlet 12, internal inlet slot 111, inlet slot 112, internal outlet slot 121, outlet slot 122 includes a choke mechanism comprising comprises two sliding plates with each plate sliding independently of the other such that the position of the opening formed between the two plates to permit passage of the precursor may be altered between an upper position, a lower position and any intermediate positions therebetween. The separation of sliding plates may be adjusted to provide the minimum working gap at the outlet to minimise ingress of gas from the atmosphere surrounding the reaction chamber 17.

The length of the vestibule 131 and the temperature of the gas blown into the reactor 10 are selected so that the precursor is not brought up to reaction temperature until it is located within the substantially oxygen-free atmosphere. Furthermore, the length of the vestibule 131 and the temperature of the gas provided by the sealing gas supply nozzle 19a, 19b to the vestibule are selected so as to ensure that the precursor cools prior to passing through the outlet 12. The precursor will be cooled such that it is below the reaction temperature prior to exiting the reactor 10 so as to ensure that the precursor does not continue to react and, as such, evolve HCN once it is outside the reactor 10 as this would pose a safety risk.

The sealing gas supply nozzle located 192a, 192b at the intermediate chamber 144 can provide a gas curtain that acts to limit ingress of gas from the atmosphere surrounding the internal drive roller 32, as well as limiting egress of gas out of the reaction chamber 17 in circumstances where it is necessary to access the internal roller 32 in use. For example, in some embodiments, the reactor 10 may include an access hatch (not shown) that can be opened to access the internal roller 32 in order to deal with fibre wraparounds or similar events that can occur when processing a fibrous precursor. In some other embodiments, the drive roller 32 may include a doctor blade (not shown) in order to deal with any fibre wraparounds.

Furthermore, in practice, it can be difficult to provide an intermediate chamber 144 that is perfectly sealed from the atmosphere surrounding the reactor 10. Accordingly, the flow of sealing gas can limit an incidental ingress of gas from the surrounding atmosphere into the intermediate chamber 144 during normal use of the reactor 10.

As a secondary function to sealing the intermediate chamber 144, the sealing gas can cool the intermediate chamber 144. It can be desirable to cool the precursor as it passes through the intermediate chamber 144 as it is still in a state of exotherm.

The intermediate chamber 144 is not directly heated. However, heat will egress into this area. Most will be subsequently removed by the flow of exhaust gases. Typically, the intermediate chamber 144 will operate at a temperature between 150-200° C. Within such a temperature range there is no detrimental effect on the internal roller 32.

In some embodiments, the exhaust gas stream exits the reactor through a pipe 181 at a temperature of 150-200° C. and a pressure of −30 to −2 millibar, for example −10 to −6 millibar. The sealing gas may be emitted via lines 191, 1921 at a temperature of 200-250° C. at a pressure of 20.68 to 344.7 kPa (3 to 50 psi). In general, it is preferred to keep the pressure of the flow of sealing gas as low as possible, while still ensuring that an effective gas curtain is produced, in order to minimise disturbance of the fibres.

The process gas can be emitted from the process gas delivery nozzles 1102a, 1102b, 1103a, 1103b at a temperature of 250-310° C., e.g. 290-310° C. The gas may be emitted at a velocity of 0.1 to 1.5 m/s, for example it may 0.5 to 0.75 m/s.

The reactor illustrated in FIGS. 3a and 3b has two reaction zones 171, 172, each generally provided with its own forced gas flow assembly. However, it can be seen that at the centre of the reaction chamber a common midpoint process gas delivery nozzle 153 is provided so as to ensure the flow of gas is supplied along the entire length of the reaction chamber 17.

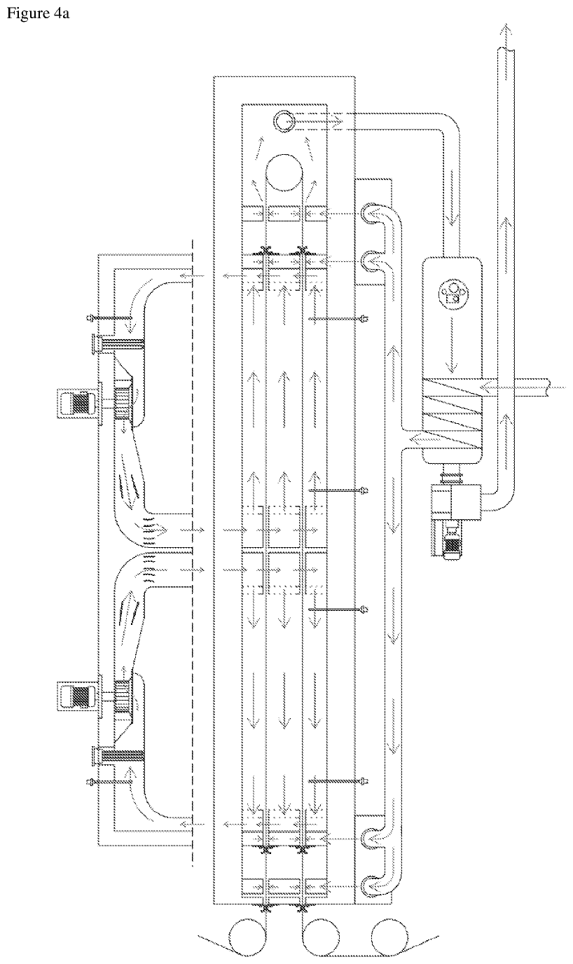

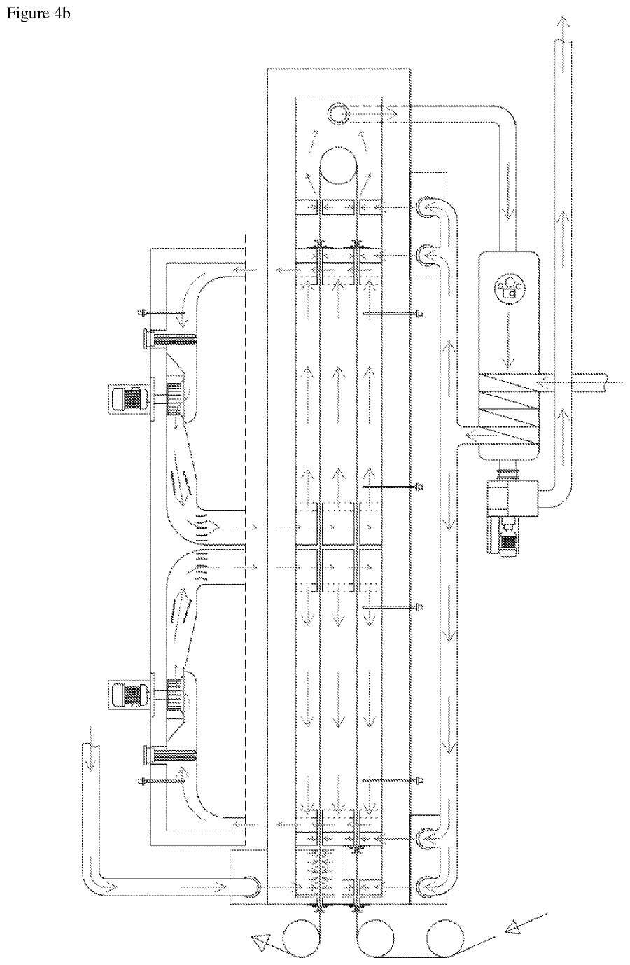

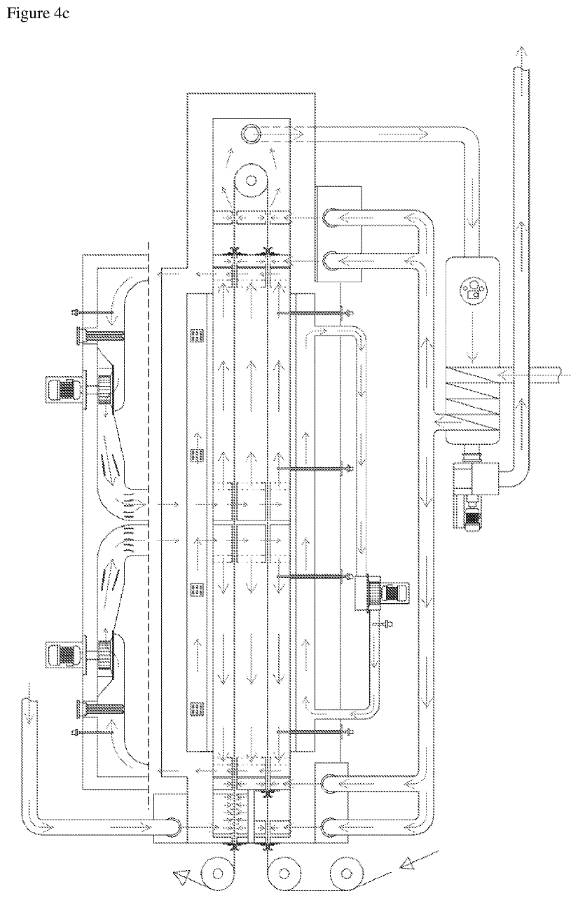

FIG. 4a is annotated with arrows to illustrate the flow of gasses through this embodiment of the reactor 10.

The structures of the forced gas flow assemblies for the two reaction zones 171, 172 are mirrored. The assemblies are adapted to predominantly supply process gas to the reaction chamber 17 from the centre to the ends. That is, most of the hot process gas supplied to the reaction chamber 17 is supplied from the centre of the chamber 17 through the main process gas delivery nozzles 152a, 152b and flows towards the ends of the chamber 17. A smaller proportion of process gas is delivered by the process gas delivery nozzles 1102a, 1102b, 1103a, 1103b located at the upper and lower ends.

A centre-to-end supply of the process gas, as illustrated in FIG. 4, can be preferred as it provides good uniformity to the process gas flow throughout the reaction chamber 17. With this arrangement, the majority of the gas is flowing parallel to the precursor. The gas flow uniformity may be such that there is only a 1% to 10% variation in gas flow velocity across each of the width, height, and length of the reaction chamber 17.

Typically, the gas flow rate will be such that the temperature measured adjacent to the precursor is within 40° C. of the temperature of the process gas, preferably within 30° C. of the temperature of the process gas. In some embodiments, the gas flow rate may be such that the actual precursor temperature is within 50° C. of the temperature of the process gas, preferably within 40° C. of the temperature of the gas, more preferably within 30° C. of the temperature of the gas. The velocity of the process gas flow may be 0.5 to 4.5 m/s, for example it may be 2 to 4 m/s.

In this embodiment, the process gas flow used should be such that the Reynolds number of the flow is above 100,000 when calculated at points further than 1.0 m, along the direction of the gas flow, from the feed element 1521a, 1521b of the main process gas delivery nozzles 152a, 152b.

Also as discussed above, other arrangements for providing the process gas to the reaction chamber 17 can be used. However, a forced gas flow assembly adapted to provide a centre-to-ends flow of process gas is typically preferred.

The reaction chamber 17 may have a heated length of 2,000-10,000 mm. However, it will be appreciated that the precursor passes through this length twice so as to provide the desired residence time and effective heated length. The reaction chamber 17 height may be 100-1,600 mm. The reaction chamber 17 width may be 100-3,500 mm. The size of the reaction chamber 17 may be selected on the basis of the desired throughput volume of the precursor.

Reactors 10 with dimensions towards the lower ends of the ranges noted above may be suited to research and development applications, with production volumes of around 1 tonne per year. Reactors 10 with dimensions towards the higher ends of the ranges noted above may be suited to use in commercial applications, with production volumes of up to 2,500 tonne per year. For example, production volumes up to 2,000 tonne per year or up to 1,500 tonne per year.

Subject to the size of the reaction chamber 17, the exhaust volume may be 25 Nm³/min to 3,000 Nm³/min, with an associated consumption of process gas of 100 l/min to 5,000 l/min.

Each forced gas flow assembly is provided with a gas return duct 156a, 156b along which a heater 157a, 157b is disposed. Downstream from the heater 157a, 157b is a fan 158a, 158b that is used to draw the process gas through the heater 157a, 157b, thus bringing it up to the process temperature. The gas is then blown by the fan through the inlet plenum 159a, 159b and out the main process gas delivery nozzle 152a, 152b. As noted above, a portion of the process gas from each inlet plenum 159a, 159b is also directed through the midpoint process gas delivery nozzle 153. In order to achieve this, the rear walls of the nozzle ducts include an array of nozzles apertures to direct the portion of process gas to the midpoint process gas delivery nozzle 153. However, the majority of the process gas from the inlet plenum 159a, 159b is directed through the nozzle duct out the main process gas delivery nozzle 152a, 152b.

The main process gas delivery nozzles 152a, 152b are located above and below the precursor and each nozzle includes a feed element 1521a, 1521b. In this embodiment, each feed element 1521a, 1521b comprises an array of feed nozzle tubes.

Each process gas inlet plenum has primary gas flow distribution baffles 154a, 154b and secondary gas flow distribution baffles 155a, 155b to assist in assist in providing a uniform gas flow through the nozzle 152a, 152b. Once the process gas has passed along the reaction chamber 17, it is then directed through the return nozzle 151a, 151b back into the return duct 156a, 156b. However, a portion of the process gas will flow out of the reaction chamber 17 into the intermediate chamber 144, carrying with it reaction by-products that are ultimately removed from the reactor 10 via the exhaust nozzle 18.

Each return nozzle 151a, 151b includes an exit element 1511a, 1511b (see FIG. 3b). In this embodiment, each exit element 1511a, 1511b terminates with a perforated sheet defining the array of exit nozzle apertures. However, in some other embodiments, each exit element 1511a, 1511b comprises an array of exit nozzle tubes.

The process gas flowing through the reaction chamber 17 may be from 200-400° C. Accordingly, the surface temperature of the heater 157a, 157b typically will not exceed 450° C.

In this illustrated embodiment, the reaction chamber 17 has thermocouples 1301a, 1301b, 1302a, 1302b for monitoring the temperature of the process gas located in each reaction zone 171, 172 near the main process gas delivery nozzle 152a, 152b and then towards the other end of the reaction zone 171, 172. So as to monitor the temperature of the process gas, thermocouples 1301a, 1301b, 1302a, 1302b are located so as to measure the temperature of the gas flow at least 30 mm away from the precursor, preferably at least 40 mm away from the precursor, more preferably at least 50 mm away from the precursor.

The reactor is provided with an integrated abatement system 16. The abatement system 16 includes a burner 161 for combusting the exhaust gases at 700-850° C. so as to destroy reaction by-products, such as HCN. The burner 161 may be operated using natural gas. The combustion gases are then vented to atmosphere along a duct 162.

Prior to being emitted along the duct, the hot combustion gasses are passed through a heat exchanger 163 that allows heat to be transferred from the hot combustion gasses to the fresh substantially oxygen-free gas that has been supplied to the reactor 10 via a line 1401. In the present case, the substantially oxygen-free gas is nitrogen. Thus, the cool nitrogen is heated by the combustion gasses so that warm nitrogen can be supplied via a line 1402 to the sealing gas nozzles 19a, 19b, 192a, 192b and the process gas delivery nozzles 1102a, 1102b, 1103a, 1103b located at each end of the reactor 10. Similarly, the combustion gasses will be cooled prior to being vented to atmosphere. Thus, the heat exchanger 163 enables there to be energy recovery from the abatement system 16, reducing the overall energy consumption of the reactor 10.

FIG. 3c illustrates a second embodiment of the vertically orientated reactor 10 that has a similar structure to the first embodiment of the reactor shown in FIGS. 3a and 3b. To allow for possible faster precursor speeds, additional cooling is provided at the outlet 12 of the reactor 10 in this embodiment. In this instance, the precursor 80 passes through the vertically orientated reactor 10 in a direction opposite to that shown in FIG. 3a. That is, the precursor 80 is conveyed via a materials handling device including non-driven rollers 33, 34 into the reactor 10. As described above with respect to FIG. 3a the flow path of the precursor through the reaction 10 is defined by the internal roller 32.

The pre-stabilised precursor 81 is conveyed from the reactor 10 to an oxidation reactor downstream by a materials handling device including non-driven roller 31. As a consequence of the change in precursor direction, the positions of the inlet 11, internal inlet slot 111 and outlet slot 122 have swapped with the positions of the outlet 12, internal outlet slot 121 and inlet slot 112, respectively.

In this second embodiment, instead of a vestibule 131 (as shown in FIG. 3a), there is an inlet vestibule 13 and an outlet vestibule 14 separated by an insulated dividing wall 133. A cooling gas inlet 108 is provided in the outlet vestibule 14 between the internal outlet slot 121 and outlet 12. The gas curtain provided by the cooling gas inlet 108 also provides sealing. Accordingly, an extended sealing and cooling gas curtain is provided by cooling gas inlet 108. Also, no choke mechanism is provided at internal outlet slot 121.

The line 1081 connected to the cooling gas inlet 108 is connected to a source of cooling gas to enable the gas curtain seal to provide a cooling effect before the pre-stabilised precursor 81 exits the reactor.

The temperature of the cooling gas provided by cooling and sealing gas inlet 108 to the outlet vestibule 14 and the length of the outlet vestibule 14 is selected so as to ensure that the precursor cools prior to passing through the outlet 12. The length of the cooling and sealing gas curtain provided by cooling gas inlet 108, as well as the flow characteristics of the gas curtain, can also be selected so as to achieve the desired degree of cooling. The precursor will be cooled such that it is below the reaction temperature prior to exiting the reactor 10 so as to ensure that the precursor does not continue to react and, as such, evolve HCN once it is outside the reactor 10 as this would pose a safety risk.

The cooling gas inlet 108 includes upper and lower plenums 1084, 1084′ into which cooling gas is provided via the upper and lower cooling gas supply inlets (not shown) connected to line 1081. Each plenum 1084, 1084′ includes a plenum plate 1083, 1083′ that includes an array of apertures for producing jets of cooling gas that impinge upon the precursor 81. A positive gas pressure will be provided behind each plenum plate 1083, 1083′. The pressure is typically less than about 1 kPa, with the gas being ejected at velocity through the apertures. Impingement velocity will vary, at least in part according to the fragility of the precursor 81, and is typically less than about 0.5 msec.

In some embodiments, the opening area defined by the perimeter of each aperture is about 0.5-20 mm². For example, the area may be 0.79 mm², 3.14 mm², 7.07 mm², 12.57 mm², or 19.63 mm², preferably about 7.07 mm². In some embodiments, the apertures are circular.

Thus, the aperture diameter in some embodiments is about 1, 2, 3, 4, or 5 mm, and preferably about 3 mm. In some embodiments, the apertures are slots. The slots may be 2-20 mm long with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor 81. In other embodiments, the slots will be orientated so that they are perpendicular to the direction of travel of the precursor. In some embodiments, the slots will be orientated at an angle relative to the direction of travel of the precursor, such as 45°.

FIG. 4b is annotated with arrows illustrating the flow of gasses through this embodiment of the reactor 10, including the flow of cooling gas from the cooling gas inlet 108.

FIG. 3d illustrates a third embodiment of the reactor 10 that has a similar structure to the second embodiment of the reactor shown in FIG. 3c, except that the reactor 10 includes heating system comprising heating elements 101a, 101b for heating the reaction chamber 17 in addition to the in addition to the forced gas flow assembly.

In this embodiment, the heating system includes heating elements 101a, 101b for each of the reaction zones 171, 172. For each zone 171, 172, heating elements 101a, 101b are located along the length of the relevant zone so that there is a heating element proximal each end of the reaction zone.

So as to distribute the heat from the heating elements along the reaction chamber 17, the heating elements 101a, 101b are positioned within a heating jacket 102 containing a heat transfer medium. In this embodiment, the heat transfer medium is air.

The heat transfer medium is circulated within the heating jacket 102 to transfer heat from the heating elements 101a, 101b to the reaction zones 171,172 of the reactor. The heating system includes a medium inlet line 104 for providing heat transfer medium to the heating jacket 102. The heating system includes a return line 106 fluidly connected to the medium inlet line 104 for recirculating the heat transfer medium in the heating jacket 102. A fan 105 is disposed along the return line 106 to transfer the heat transfer medium along the return line 106 and the medium inlet line 104 so that it can be recirculated.

It will be appreciated the heating jacket is sealed to retain the heat transfer medium within it in a heat transfer relationship with the walls of the reaction chamber 17. The heating jacket 102 includes an opening (not shown) around which the heating jacket 102 is sealed, to allow the passing of the ducting from the inlet plenums 159a, 159b (consider FIGS. 3b and 4c) to the main process gas delivery nozzle 152a, 152b and the midpoint process gas delivery nozzle 153. The heating jacket 102 extends along the reaction chamber 17 towards the ends of the reaction zones.

In this illustrated embodiment, the reaction chamber 17 has thermocouples 1301a, 1301b, 1302a, 1302b for monitoring the temperature of the process gas located in each reaction zone 171, 172. The reactor also includes a thermocouple 107 in the medium inlet line 104 for monitoring the temperature of the heat transfer medium prior to it being fed into heating jacket 102.

The temperatures measured using the thermocouples 1301a, 1301b, 1302a, 1302b, 107 will be used to assess whether the temperature of the heating elements 101a, 101b is at an appropriate level and whether the heat transfer medium is being recirculated through the heating jacket 102 at suitable rate.

FIG. 4c is annotated with arrows illustrating the flow of gasses through this embodiment of the reactor 10, including the flow of heat transfer medium through the heating system comprising the heating jacket 102, medium inlet line 104 and return line 106.

It will be appreciated that additional heating elements and other arrangements and configurations of heating systems comprising heating elements may be used in other embodiments. For example, each zone of the reaction chamber may be provided with a separate heating sub-structure including heating elements and a heating jacket containing a heat transfer medium that is recirculated as described for this illustrated embodiment. Suitable heating systems may include structures similar to those used in carbonisation furnaces, but it will be appreciated that the typical operating temperature of pre-stabilisation reactors are considerably less than the temperatures conventionally employed in carbonisation furnaces.

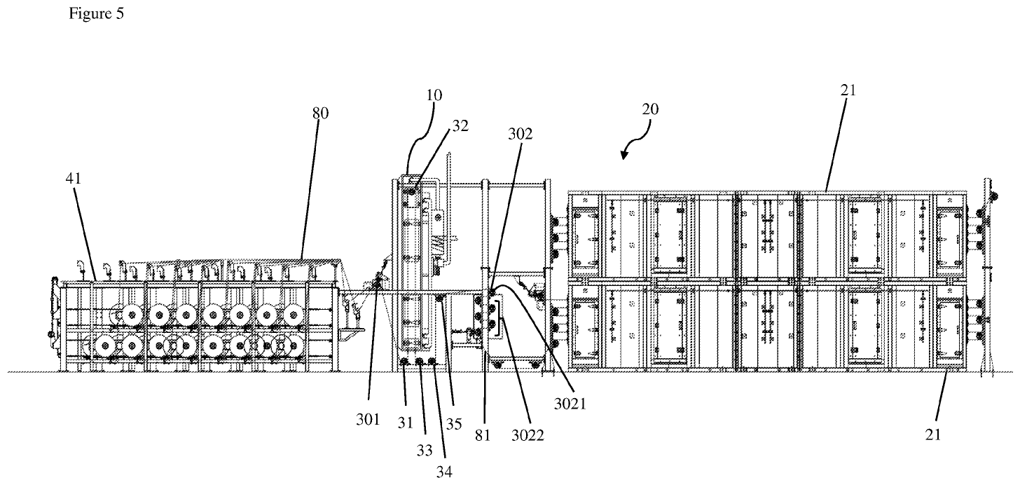

The vertically orientated reactor 10 has a relatively small footprint. For example, in the illustrated embodiment the footprint of the reactor 10 may be 600 mm by 1,000 mm. Accordingly, the vertically orientated reactor may be retrofit to an existing carbon fibre production line in the pre-existing space between the source of the precursor fibre and the oxidation reactor. FIG. 5 illustrates an example of this showing the vertically orientated reactor 10 described with reference to FIG. 3a located between the creel 41 and the oxidation reactor 20 that includes conventional oxidation ovens 21. It will be appreciated that other embodiments of the vertically orientated reactor 10 may be similarly located so as to be retrofit to an existing carbon fibre production line.

There is a drive station 301 with a nip-roller arrangement upstream from the reactor that is used to convey the precursor 80 from the creel 41 to the reactor 10. It is conveyed via an external non-driven roller 31 into the reactor 10. As described above the flow path of the precursor through the reaction 10 is defined by the internal roller 32.

The pre-stabilised precursor 81 is conveyed from the reactor 10 to the oxidation reactor 20 by a materials handling device including non-driven rollers 33, 34, 35 that define the flow path of the precursor 81 from the reactor 10 to the drive station 302. The drive station 302 is a tensioning device that applies a predetermined tension to the precursor as it passes through the reactor 10 between the first drive station 301 and the second drive station 302. The first drive station 301 applies a braking force and it used to convey the precursor 80 from the creel 81.

The second drive station 302 includes a non-driven pass roller 3021 and a 5-roller drive arrangement 3022.

As described above, and without being bound by theory, it is believed that the pre-stabilised precursor 81 formed using the reactor 10 is activated for oxidation due at least in part to partial cyclisation of the precursor fibre during pre-stabilisation. Thus, the operating parameters of the conventional oxidation reactors 20 may be adapted to account for this activation. For example, the oxidation may be carried out at a lower temperature than that conventionally used for the production of a stabilised precursor. Furthermore, activation of the precursor through pre-stabilisation may enable oxidation to be performed more rapidly. Accordingly, when a conventional oxidation reactor 20 is used, fewer oxidation ovens 21 may be required for the oxidation step and/or the precursor may make fewer passes through each oxidation oven 21.

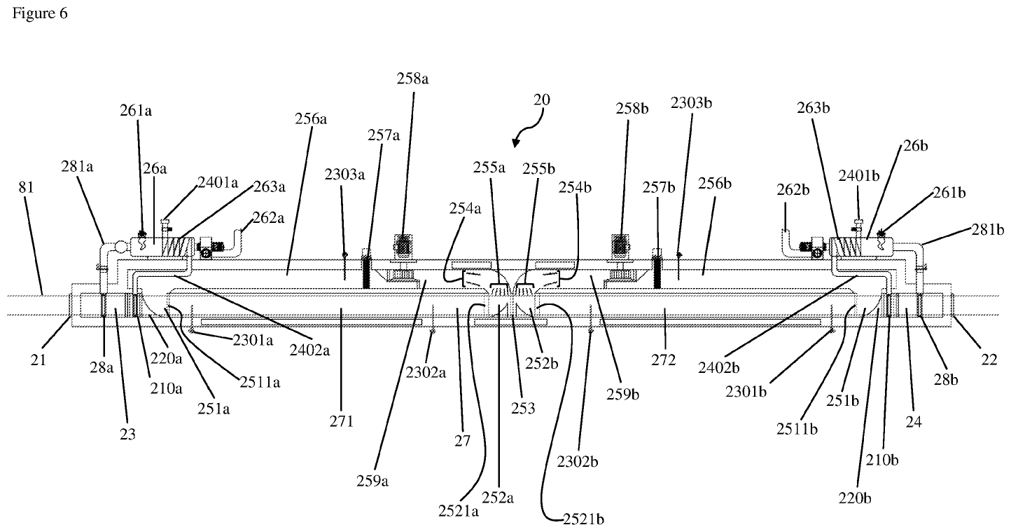

In some embodiments, the oxidation reactor 20 may be specifically adapted for use with the pre-stabilisation reactor 10 of the present invention. Such an oxidation reactor 20 is illustrated in FIG. 6.

FIG. 6 provides a schematic view of a first embodiment of an oxidation reactor 20 suitable for use with the reactor 10 of the present invention. Conveying rollers (not shown) are positioned outside the oxidation reactor and do not form part of the reactor. In some other embodiments, the oxidation reactor may include externally located rollers that co-operate with the components of the system to pass the precursor through the reactor and provide it to downstream components of the system.

In use, the interior of the oxidation reactor 20 may be too hot for conventional rollers. Accordingly, there is an inlet 21 and an outlet 22 to allow the precursor 81 to pass between the rollers and the interior of the oxidation reactor 20. As can be seen from FIG. 6, the pre-stabilised precursor 81 moves through the oxidation reactor 20 by passing through an inlet vestibule 23, through the transition area 220a, through the reaction chamber 27, through another transition area 220b, and through an outlet vestibule 24, before exiting via the outlet 22.

The ability to pass the fibres freely between the rollers and the interior of the reactor 20 must be balanced with the need to limit egress of gas from the atmosphere within the oxidation reactor 20 into the atmosphere surrounding the oxidation reactor.

An oxygen-containing gas is provided to the oxidation chamber 27. Often this oxygen-containing gas is air and, for convenience, the following description refers to air as the substantially oxygen-containing gas. However, it would be appreciated that other oxygen-containing gases described above can be used.

The inlet vestibule 23 includes exhaust nozzles 28a (lower one only shown) located adjacent to the inlet. The exhaust nozzles 28a draw exhaust gases from above and below the precursor as it passes through the oxidation reactor.

The rate at which gas is drawn through the exhaust nozzles 28a, 28b is controlled so as to effectively seal the oxidation chamber 27 by limiting incidental gas flow out of the oxidation reactor 27 through the inlet. In this embodiment where air is the oxidation gas, cool air is drawn in by the exhaust nozzles 28a through the inlet 21. Accordingly, the oxidation reactor will be operated with a slight negative pressure in the inlet vestibule 23 so that fugitive emissions are not emitted from out the inlet 21. Sensors are located at the inlet 21 in order to monitor for fugitive emissions to ensure operator safety. One or more sensors will monitor whether the atmosphere immediately external to the inlet 21 has a HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Also, at least one sensor will be used to monitor whether the atmosphere immediately external to the inlet 21 has an oxygen content that does not fall lower than 20.9%.

At the end of the vestibule 23, there is an internal inlet slot and an oxidation gas delivery nozzle 210a. The pre-stabilised precursor passes through the internal inlet, past the oxidation gas delivery nozzle 210a and into a transitional region 220a, where the return nozzle 251a for the first oxidation zone 271 of the oxidation chamber 27 is located, before entering the main portion of the first zone 271 of the oxidation chamber 27.

The length of the vestibule 23, the amount of air drawn in through the inlet 21 and the temperature of the gas blown into the oxidation reactor 20 are selected so that the precursor is not brought up to reaction temperature until it is located within the oxidation chamber 27 so as to minimise evolution of HCN in the vestibule 23. The precursor then passes through the two zones 271, 272 of the oxidation chamber 27 before reaching the transitional zone 220b at the second oxidation zone return nozzle 251b. At the end of the transitional zone 220b, another oxidation gas delivery nozzle 210b is located and beyond that there is an outlet vestibule 24.

In some embodiments, the exhaust gas stream exits the oxidation reactor 20 through pipes 281a, 281b at a temperature of 150-250° C. and a pressure of −30 to −2 millibar, for example −10 to −6 millibar.

The oxidation gas can be emitted from the oxidation gas delivery nozzles 210a, 210b at a temperature of 210-280° C. The gas may be emitted at a velocity of 0.1 to 1.5 m/s, for example the velocity may be 0.5 to 0.75 m/s.

As shown in FIGS. 6a and 6b, the outlet vestibule 24 has an arrangement of oxidation gas delivery nozzle 210b and exhaust nozzles 28b that generally mirrors the arrangement shown for the inlet vestibule 23. Once again, the flow rate of the exhaust gasses through the exhaust nozzles 28b is selected to ensure that there is no incidental gas flow out of the outlet 22 from the reactor 20. As described above with reference to the inlet vestibule 23, typically in practice the reactor 20 will be operated slightly under pressure within the outlet vestibule 24 so that air will be drawn it through the outlet 22.

Sensors are located at the outlet 22 in order to monitor for fugitive emissions to ensure operator safety. One or more sensors will monitor whether the atmosphere immediately external to the outlet 22 has a HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Also, at least one sensor will be used to monitor whether the atmosphere immediately external to the outlet 22 has an oxygen content that does not fall lower than 20.9%.

The amount of air drawn in through the outlet 22 into the outlet vestibule 24 and the length of the outlet vestibule 24 are selected so as to ensure that the precursor cools prior to passing through the outlet 22. The precursor will be cooled such that it is below the reaction temperature prior to exiting the reactor 20 so as to ensure that the precursor does not continue to react and, as such, evolve HCN once it is outside the oxidation reactor 20 as this would pose a safety risk.

In some embodiments, such as embodiments where the oxygen-containing gas is not air, the oxidation reactor may include sealing gas supply nozzles in the inlet and outlet vestibules. The sealing gas supply nozzles are adapted to supply a gas curtain of oxidation gas across each vestibule. The gas curtain acts to limit the egress of gas out of the oxidation chamber. Furthermore, the gas curtain may limit the ingress of air from the atmosphere surrounding the reactor through the inlet and outlet.

The gas flow rates through the sealing gas supply nozzles and the exhaust nozzles are controlled so as to effectively seal the oxidation chamber, thus maintaining the oxygen-containing atmosphere within it, and to limit incidental gas flow out of the reactor through the inlet and outlet. Ideally, the gas flows through the sealing gas supply nozzle and the exhaust nozzles are controlled so that there is no incidental gas flow out of the oxidation reactor through the inlet and outlet, and so that there is no ingress of air from the surrounding atmosphere past the exhaust nozzles. However, in practice, the reactor will be operated at a slight positive pressure so that a minor amount of fugitive emissions are emitted from out the inlet. The makeup of the fugitive emissions will be primarily the oxygen-containing gas, with the HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Sensors are located at the inlet and outlet in order to monitor the composition of the emissions to ensure operator safety. Also, sensors will be used to monitor whether the atmosphere immediately external to the inlet and outlet has an oxygen content that does not fall lower than 20.9%.

If provided, the sealing gas supply nozzle for each vestibule may be located between the exhaust nozzles and the oxidation gas delivery nozzle. Alternatively, the sealing gas supply nozzle may be located between the exhaust nozzles and the inlet or outlet. The sealing gas may be emitted at a temperature of 50-250° C. The gas may be emitted at a velocity of 0.5 to 4.5 m/s, for example the velocity may be 1 to 4 m/s.

In some embodiments, the reactor 20 may be fitted with a secondary external exhaust management system in order to collect any fugitive emissions and direct them to an exhaust abatement system. This secondary external exhaust management system can provide additional operator safety.

The oxidation reactor illustrated in FIG. 6 has two oxidation zones 271, 272, each generally provided with its own forced gas flow assembly. However, it can be seen that at the centre of the reaction chamber a common midpoint oxidation gas delivery nozzle 253 is provided so as to ensure the flow of gas is supplied along the entire length of the oxidation chamber 27.

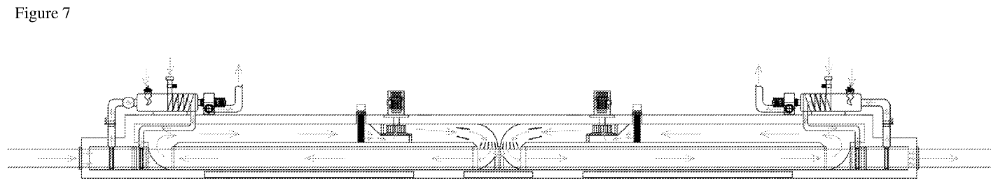

FIG. 7 is annotated with arrows to illustrate the flow of gasses through this embodiment of the oxidation reactor 20.

The structures of the forced oxidation gas flow assemblies for the two oxidation zones 271, 272 are mirrored. The assemblies are adapted to predominantly supply oxidation gas to the oxidation chamber 27 from the centre to the ends. That is, most of the hot oxidation gas supplied to the reaction chamber 27 is supplied from the centre of the chamber through the main oxidation gas delivery nozzles 252a, 252b and flows towards the ends of the chamber 27. A smaller proportion of oxidation gas is delivered by the oxidation gas delivery nozzles 210a, 210b located towards the inlet 21 and outlet 22. The oxidation gas delivery nozzles 210a, 210b towards the inlet 21 and outlet 22 are connected to the source of oxygen-containing gas 2401a, 2401b and are for supplying fresh oxidation gas to the oxidation chamber 27. The bulk of the oxidation gas is recirculated by the forced oxidation gas flow assemblies during operation of the oxidation chamber 27.

Typically, so as to provide the oxidation gas with good flow uniformity as it flows through the reaction chamber 27, the forced oxidation gas flow assembly will be such that the oxidation gas flows largely parallel to the passage of the precursor through the reactor 20.

A centre-to-end supply of the oxidation gas, as illustrated in FIG. 7, can be preferred as it provides good uniformity to the oxidation gas flow throughout the reaction chamber 27. With this arrangement, the majority of the gas is flowing parallel to the precursor. The gas flow uniformity may be such that there is only a 1% to 10% variation in gas flow across each of the width, height, and length of the reaction chamber 27.

Typically, the gas flow rate will such that the temperature measured adjacent to the precursor is within 60° C. of the temperature of the process gas, preferably within 50° C. of the temperature of the process gas. As used herein, “adjacent to the precursor” means within 10 mm of the precursor, preferably within 3 mm of the precursor, more preferably within 1 mm of the precursor. The velocity of the oxidation gas flow may be 0.5 to 4.5 m/s, for example it may be 2 to 4 m/s.

In this embodiment, the process gas flow used should be such that the Reynolds number of the flow is above 100,000 when calculated at points further than 1.0 m, along the direction of the gas flow, from the feed element 2521a, 2521b of the main process gas delivery nozzles 252a, 252b.

As discussed above, other arrangements for providing the oxidation gas to the reaction chamber 27 can be used. However, a forced gas flow assembly adapted to provide a centre-to-ends flow of oxidation gas is typically preferred.

The oxidation chamber 27 may have an effective heated length of 2,000-17,000 mm. The oxidation chamber 27 height may be 100-1,600 mm. The oxidation chamber 27 width may be 100-3,500 mm. The size of the chamber 27 may be selected on the basis of the desired throughput volume of the precursor. Oxidation reactors 20 with dimensions towards the lower ends of the ranges noted above may be suited to research and development applications, with production volumes of around 1 tonne per year. Reactors 20 with dimensions towards the higher ends of the ranges noted above may be suited to use in commercial applications, with production volumes of up to 2,500 tonne per year. For example, production volumes up to 2,000 tonne per year or up to 1,500 tonne per year.

Subject to the size of the oxidation chamber 20, the exhaust volume may be 25 Nm³/min to 3,000 Nm³/min, with an associated consumption of process gas of 100 l/min to 5,000 l/min.

Each forced gas flow assembly is provided with a gas return duct 256a, 256b along which a heater 257a, 257b is disposed. Downstream from the heater 257a, 257b is a fan 258a, 258b that is used to draw the oxidation gas through the heater 257a, 257b, thus bringing it up to the process temperature. The gas is then blown by the fan 258a, 258b through the inlet plenum 259a, 259b and out the main oxidation gas delivery nozzle 252a, 252b. As noted above, a portion of the oxidation gas from each inlet plenum 259a, 259b is also directed through the midpoint oxidation gas delivery nozzle 253. In order to achieve this, the rear walls of the nozzle ducts include an array of nozzles apertures to direct the portion of oxidation gas to the midpoint oxidation gas delivery nozzle 153. However, the majority of the oxidation gas from the inlet plenum 259a, 259b is directed through the nozzle duct out the main oxidation gas delivery nozzle 252a, 252b.

The main oxidation gas delivery nozzles 252a, 252b are located above and below the precursor and each nozzle includes a feed element 2521a, 2521b. In this embodiment, each feed element 2521a, 2521b comprises an array of feed nozzle tubes.

Each oxidation gas inlet plenum 259a, 259b has primary gas flow distribution baffles 254a, 254b and secondary gas flow distribution baffles 255a, 255b to assist in assist in providing a uniform gas flow through the nozzle. Once the oxidation gas has passed along the oxidation chamber 27, it is then directed through the return nozzle 251a, 251b back into the return duct 256a, 256b. However, a portion of the oxidation gas will flow out of the reaction chamber 27 into either the inlet or outlet vestibule 23, 24, carrying with it reaction by-products that are ultimately removed from the reactor via the exhaust nozzles 28a, 28b.

Each return nozzle 251a, 251b includes an exit element 2511a, 2511b. In this embodiment, each exit element 2511a, 2511b terminates with a perforated sheet defining the array of exit nozzle apertures. However, in some other embodiments, each exit element 2511a, 2511b comprises an array of exit nozzle tubes.

In some embodiments, there may be a supplementary gas inlet (not shown) into either or each gas return duct 256a, 256b. The supplementary gas inlet may be used to provide more oxidation gas as necessary to compensate for the consumption of oxygen in the oxidation process. Alternatively, the supplementary gas inlet may be used to add gas of a different composition to the oxidation gas to provide the desired gas composition within the oxidation chamber. For example, in some embodiments, a gas mixture rich in oxygen may be introduced to compensate for higher than anticipated levels of oxygen consumption.

The oxidation gas flowing through the reaction chamber 27 may be from 200-400° C. Accordingly, the surface temperature of the heater 257a, 257b typically will not exceed 450° C.

In this illustrated embodiment, the oxidation chamber has thermocouples 2301a, 2301b, 2302a, 2302b, for monitoring the temperature of the oxidation gas located in each oxidation zone 271, 272 near the main oxidation gas delivery nozzle 252a, 252b and then towards the other end of the oxidation zone 271, 272 nearer to the inlet 21 or outlet 22, respectively. The oxidation reactor 20 also includes a thermocouple 2303a, 2303b in each return duct 256a, 256b for monitoring the temperature of the gas prior to it being drawn through the heater 257a, 257b.

The oxidation reactor 20 is provided with an integrated abatement system 26a, 26b at each end. The abatement system 26a, 26b includes a burner 261a, 261b for combusting the exhaust gases at 700-850° C. so as to destroy reaction by-products, such as HCN. The burner 261a, 261b may be operated using natural gas. The combustion gases are then vented to atmosphere along a duct 262a, 262b.

Prior to being emitted along the duct 262a, 262b, the hot combustion gasses are passed through a heat exchanger 263a, 263b that allows heat to be transferred from the hot combustion gasses to the fresh oxygen-containing gas that has been supplied to the reactor 20. In the present case, the oxygen-containing gas is air. Thus, the cool air is heated by the combustion gasses so that warm air can be supplied via a line 2402a, 2402b to the oxidation gas delivery nozzle 210a, 210b located at the inlet and outlet vestibules 23, 24 (and any sealing gas nozzle, if used). Similarly, the combustion gasses will be cooled prior to being vented to atmosphere. Thus, the heat exchanger 263a 263b enables there to be energy recovery from the abatement system 26a, 26b, reducing the overall energy consumption of the oxidation reactor 20.

For example, in some embodiments, the energy consumption of the reactor 20 may be 5 kW to 40 kW.

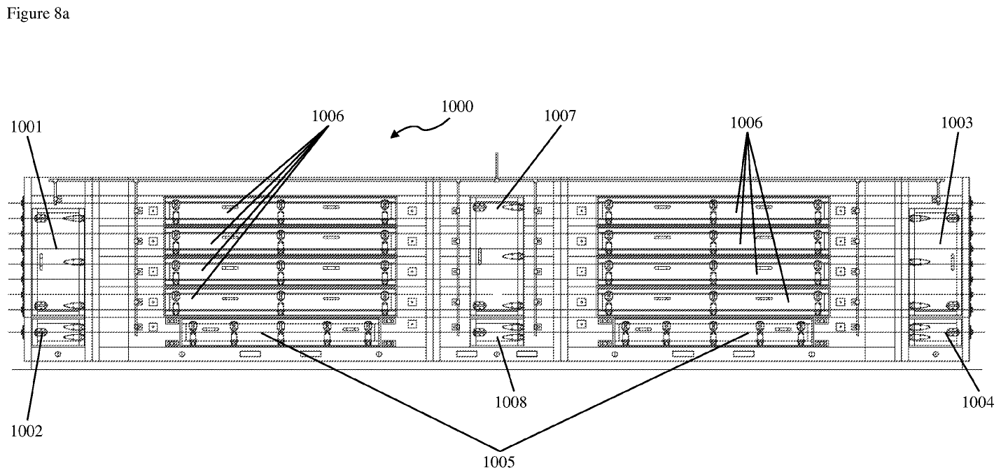

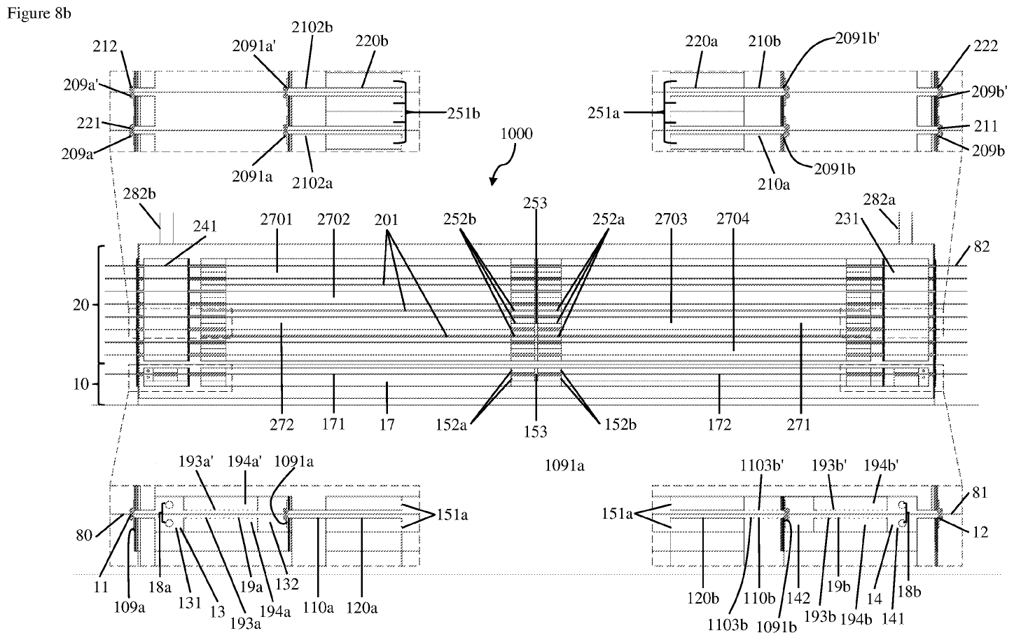

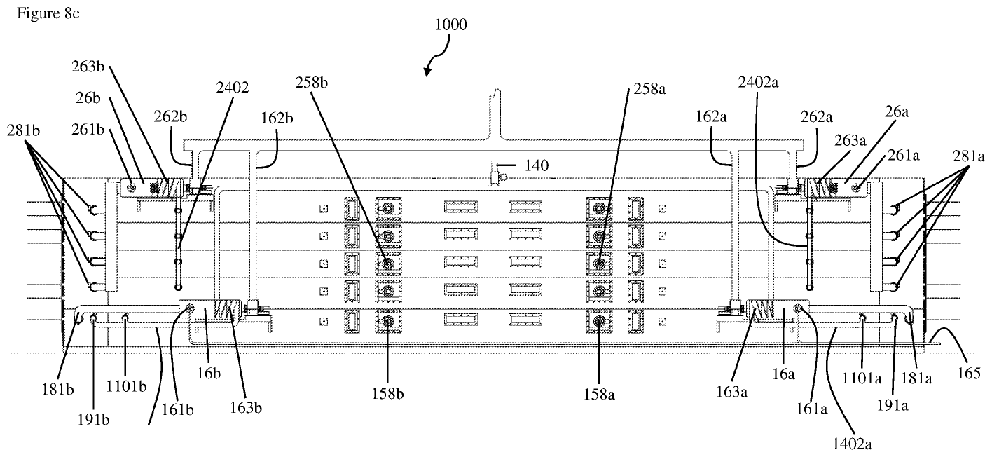

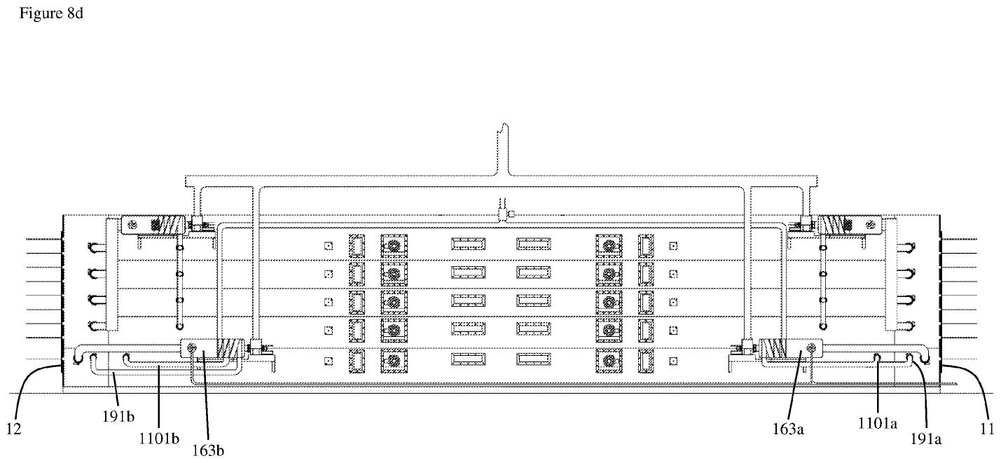

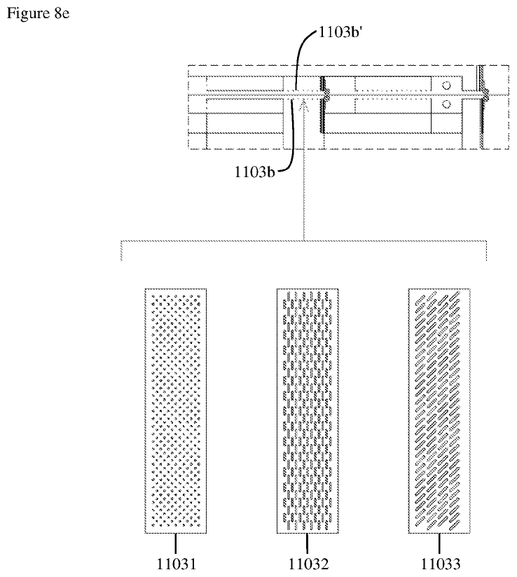

In some embodiments the reactor 10 and the oxidation reactor 20 are provided as part of a single apparatus 1000. An embodiment of such an apparatus 1000 is illustrated in FIGS. 8a, 8b and 8c. In the illustrated embodiment of the stabilisation apparatus, the reactor 10 is provided at the bottom of the apparatus with the oxidation reactor 20 stacked on top. The oxidation reactor 20 has four oxidation chambers 2701, 2702, 2703, 2704 that are also stacked one on top of the other. Thus, this stabilisation apparatus includes four oxidation chambers 2701, 2702, 2703, 2704 that are each the same length as the reaction chamber 17. FIG. 8b shows how the precursor 80, 81, 82 passes through the interior of the stabilisation apparatus 1000. The precursor makes a single pass through the reactor 10, it then makes two passes through each of the oxidation chambers 2701, 2702, 2703, 2704 of the oxidation reactor. Thus, in order to provide the desired residence time for oxidation relative to the residence time for pre-stabilisation the precursor will make eight passes through the oxidation reactor 20 while only making one pass through the reactor 10.

As can be seen in FIG. 8b, the reactor 10 has an inlet 11, an inlet vestibule 13 including ventilation ports that acts as exhaust nozzles 18a above and below the precursor. Adjacent to the precursor is a sealing gas supply nozzle 19a that is adapted to supply the gas curtain of process gas across the precursor.

The sealing gas supply nozzles 19a, 19b each includes upper and lower plenums 194a, 194a′, 194b, 194b′ into which sealing gas is provided via the upper and lower sealing gas supply inlets (not shown) connected to the line 191a, 191b. Each plenum 194a, 194a′, 194b, 194b′ includes a plenum plate 193a, 193a′, 193b, 193b′ that includes an array of apertures for producing jets of gas to form a sealing gas curtain across the inlet vestibule 13 and outlet vestibule 14. A positive gas pressure will be provided behind each plenum plate 193a, 193a′, 193b, 193b′. The pressure is typically less than about 1 kPa, with the gas being ejected at velocity through the apertures. Impingement velocity will vary, at least in part according to the fragility of the precursor, and is typically less than about 0.5 msec.

In some embodiments of the plenum plates 193a, 193a′, 193b, 193b′, the opening area defined by the perimeter of each aperture is about 0.5-20 mm². For example, the area may be 0.79 mm², 3.14 mm², 7.07 mm², 12.57 mm², or 19.63 mm², preferably about 7.07 mm². In some embodiments, the apertures are circular. Thus, the aperture diameter in some embodiments is about 1, 2, 3, 4, or 5 mm, and preferably about 3 mm. In some embodiments, the apertures are slots. The slots may be 2-20 mm long with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor 81. In other embodiments, the slots will be orientated so that they are perpendicular to the direction of travel of the precursor. In some embodiments, the slots will be orientated at an angle relative to the direction of travel of the precursor, such as 45°.

The position and structure of the sealing gas supply nozzle 19a is such that the inlet vestibule 13 is divided into two sub-chambers 131, 132. The first sub-chamber is the sealing chamber 131 in which the exhaust nozzles 18a are located.

On the other side of the sealing gas supply nozzle 19a, a process gas pre-purge sub-chamber 132 is provided prior to the internal inlet, leading into the transition zone 120a of the reaction chamber 17, at which the process gas return nozzle 151a is located. As in the case of the reactor 10 illustrated in FIG. 1, the reactor 10 of the stabilisation apparatus also provides process gas in a centre-to-ends manner. Also, the reactor includes a process gas supply nozzle 110a, 110b at the end of each vestibule 13, 14. The process gas supply nozzles 110a, 110b are connected to the source of process gas 140.

A choke mechanism 109a, 109b is provided at the inlet 11 and the outlet 12. In addition, a choke mechanism 1091a is provided at the internal inlet between the process gas pre-purge sub-chamber 132 and the process gas supply nozzle 110a. A further choke mechanism 1091b is provided at the internal outlet between the process gas pre-purge sub-chamber 142 and the process gas supply nozzle 110b.

Each choke mechanism 109a, 109b, 1901a, 1091b comprises two sliding plates with each plate sliding independently of the other such that the position of the opening formed between the two plates to permit passage of the precursor may be altered between an upper position, a lower position and any intermediate positions therebetween. The separation of sliding plates may be adjusted to provide the minimum working gap, that can accommodate the catenary sag of the precursor, at the outlet to minimise ingress and egress of gas.

The gas flow rates through the sealing gas supply nozzles 19a, 19b and the exhaust nozzles 18a, 18b are controlled so as to effectively seal the reaction chamber 17, thus providing the substantially oxygen-free atmosphere within it, and to limit incidental gas flow out of the reactor through the inlet 11. Ideally, the gas flows through the sealing gas supply nozzle 19a and the exhaust nozzles 18a are controlled so that there is no incidental gas flow out of the reactor through the inlet 11 and so that there is no ingress of air from the surrounding atmosphere past the exhaust nozzles 18a. However, in practice, the reactor will be operated at a slight positive pressure so that a minor amount of fugitive emissions are emitted from out the inlet 11. The makeup of the fugitive emissions will be primarily nitrogen, with the HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Sensors are located at the inlet 11 in order to monitor the composition of the emissions to ensure operator safety. Furthermore, there is monitoring of the oxygen levels within the vestibule 13 to ensure that a substantially oxygen-free atmosphere is maintained within the reaction chamber 17. In practice, operating the reactor 10 with a slight over pressure helps ensure that none of the air from the atmosphere surrounding the reactor can get into the reaction chamber 17.

The length of the vestibule 13 and the temperature of the gas blown into the reactor 10 are selected so that the precursor is not brought up to reaction temperature until it is located within the substantially oxygen-free atmosphere. Typically, the atmosphere in the process gas pre-purge sub-chamber 132 will be substantially oxygen-free.

The reaction chamber 17 includes two reaction zones 171, 172, each provided with mirrored forced gas flow assemblies. Accordingly, at the centre of the reaction chamber 17 the main process gas delivery nozzles 152a, 152b are located with a midpoint process gas delivery nozzle 153 in between which is provided so as to ensure that there is a flow of gas supplies along the entire length of the reaction chamber 17. Each return nozzle 151a, 151b is connected to a return gas duct (not shown) along which a heater (not shown) is disposed.

Downstream from the heater is a fan 158a, 158b (shown in FIG. 8c) that is used to draw the process gas through the heater, thus bringing it up to processed temperature. The gas is then blown by the fan 158a, 158b through the inlet plenum (not shown) and out the main process gas delivery nozzle 152a, 152b.

The structure of the outlet vestibule 14 generally mirrors that of the inlet vestibule 13, with it including a process gas pre-purge sub-chamber 142 immediately outside the internal outlet, a sealing gas delivery nozzle 19b and then a sealing sub-chamber 141 in which the ventilation ports acting as the exhaust nozzles 18b are located.

Once again, the flow rate of the exhaust gasses through the exhaust nozzles 18b and the flow rate of process gas used to provide a gas curtain across the outlet vestibule 14 are ideally controlled to ensure that a substantially oxygen-free atmosphere is provided within the reaction chamber 17 and to ensure that there is no incidental gas flow out of the outlet 12 from the reactor. However, as described above with reference to the inlet 11, typically in practice the reactor will be operated slightly over pressure so that there will be a minor amount of fugitive emissions. These emissions will be predominantly nitrogen (i.e., the process gas) and outside the outlet 12 there will be monitoring HCN so as to ensure that the fugitive emissions have a HCN content that does not exceed 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm.

Also similarly to the inlet vestibule 13, at the outlet vestibule 14 there is also oxygen monitoring so as to ensure that a substantially oxygen-free atmosphere is still being maintained towards the outlet end of the reaction chamber 17.

The temperature of the gas provided by the sealing gas supply nozzle 19b to the outlet vestibule 14 and the length of the outlet vestibule 14 is selected so as to ensure that the precursor cools prior to passing through the outlet 12. The precursor will be cooled such that it is below the reaction temperature prior to exiting the reactor 10 so as to ensure that the precursor does not continue to react and, as such, evolve HCN once it is outside the reactor as this would pose a safety risk.

In some embodiments, the positions of the exhaust nozzles 18a, 18b and the sealing gas supply nozzles 19a, 19b can be reversed so that the sealing gas supply nozzles 19a, 19b are located closest to the inlet 11 and outlet 12, respectively, with the exhaust nozzles 18a, 18b being located inwardly adjacent to each sealing gas supply nozzle 19a, 19b.

In some embodiments, the exhaust gas stream exits the reactor through pipes 181a, 181b at a temperature of 150-200° C. and a pressure of −30 to −2 millibar, for example −10 to −6 millibar. The sealing gas may be emitted at a temperature of 200-250° C. at a pressure of 20.68 to 344.7 kPa (3 to 50 psi) through lines 191a, 191b. In general, it is preferred to keep the pressure of the flow of sealing gas as low as possible, while still ensuring that an effective gas curtain is produced, in order to minimise disturbance of the fibres.

In some embodiments, the process gas delivery nozzle 110a may include upper and lower output tubes located so as to be positioned above and below the precursor, with each output tube having a slot shaped aperture for directing gas towards the precursor. In some embodiments, the process gas delivery nozzle 110a may include upper and lower output tubes located so as to be positioned above and below the precursor, with each output tube having a slot shaped aperture for directing process gas towards a distributor. The distributor is for directing and distributing the flow of gas across the width of the precursor. An example of such a nozzle configuration is illustrated in FIG. 1e for process gas nozzle 110b. In a further embodiment, the process gas delivery nozzle may have the same structure as the process gas delivery nozzle 110b described below.

So as to facilitate cooling of the precursor before it exits the reactor 10, the process gas delivery nozzle 110b has a similar structure to the sealing gas supply nozzles 19a, 19b. Accordingly, the process gas delivery nozzle 110b includes upper and lower plenums into which process gas is provided via the upper and lower sealing gas supply connected to the line 1101b. Each plenum includes a plenum plate 1103b, 1103b′ that includes an array of apertures for producing jets of gas to form a gas curtain across width of the precursor. The pressure is typically less than about 1 kPa, with the gas being ejected at velocity through the apertures. Impingement velocity will vary, at least in part according to the fragility of the precursor, and is typically less than about 0.5 msec.

Some embodiments of the plenum plate 1103b, 1103b′ are illustrated in FIG. 8e. The opening area defined by the perimeter of each aperture is about 0.5-20 mm². For example, the area may be 0.79 mm², 3.14 mm², 7.07 mm², 12.57 mm², or 19.63 mm², preferably about 7.07 mm². In some embodiments, the apertures are circular (see plate 11031). Thus, the aperture diameter in some embodiments is about 1, 2, 3, 4, or 5 mm, and preferably about 3 mm. In some embodiments, the apertures are slots (see plates 11032, 11033). The slots may be 2-20 mm long with an appropriate thickness to provide the desired opening area. In some embodiments, the slots may have a thickness of 1, 2, 3, 4, or 5 mm, and preferably about 3 mm. In some embodiments, the slots will be orientated so that they are parallel to the direction of travel of the precursor (see plate 11032). In other embodiments, the slots will be orientated so that they are perpendicular to the direction of travel of the precursor. In some embodiments, the slots will be orientated at an angle relative to the direction of travel of the precursor, such as 45° (see plate 11033).

The process gas can be emitted via line 1101a from the process gas delivery nozzle 110a at a temperature of 250-310° C., e.g. 290-310° C. The process gas can be emitted via line 1101b from the process gas delivery nozzle 110b at a temperature of between 20° C. and 300° C., e.g. between 100° C. and 220° C., or between 100° C. and 160° C., or below 140° C. The gas may be emitted at a velocity of 0.1 to 1.5 m/s, for example the velocity may be 0.5 to 0.75 m/s.

As noted above, the structures of the forced gas flow assemblies for the two reaction zones 171, 172 are mirrored. The assemblies are adapted to predominantly supply process gas to the reaction chamber from the centre to the ends. That is, most of the hot process gas supplied to the reaction chamber is supplied from the centre of the chamber through the main process gas delivery nozzles 152a, 152b and flows towards the ends of the chamber.

A supply of fresh process gas is provided to compensate for losses through the exhaust nozzles 18a, 18b.

As described with reference to FIG. 2a, a centre-to-end supply of the process gas can be preferred as it provides good uniformity to the process gas flow throughout the reaction chamber 17. With this arrangement, the majority of the gas is flowing parallel to the precursor. The gas flow uniformity may be such that there is only a 1% to 10% variation in gas flow across each of the width, height, and length of the reaction chamber 17.

It will be appreciated from FIG. 8b that in the first reaction zone 171 the gas flow is provided on a counter-flow basis to the passage of the precursor through the reaction chamber 17. In the second reaction zone 172, the gas flow is provided as a co-flow with the passage of the precursor.

Typically, the gas flow rate will be such that the temperature measured adjacent to the precursor is within 40° C. of the temperature of the process gas, preferably within 30° C. of the temperature of the process gas. In some embodiments, the gas flow rate may be such that the actual precursor temperature is within 50° C. of the temperature of the process gas, preferably within 40° C. of the temperature of the gas, more preferably within 30° C. of the temperature of the gas. The velocity of the process gas flow may be 0.5 to 4.5 m/s, for example it may be 2 to 4 m/s.

In this embodiment, the process gas flow used should be such that the Reynolds number of the flow is above 100,000 when calculated at points further than 1.0 m, along the direction of the gas flow, from the main process gas delivery nozzles 152a, 152b.

The reaction chamber 17 of this illustrated embodiment has an effective heated length of about 8,000 mm. The reaction chamber 17 height is about 300 mm. The reaction chamber 17 width is about 500 mm. However, it will be appreciated that the size of the reaction chamber 17 may be selected on the basis of the desired throughput volume of the precursor.

In the illustrated embodiment, the production volume may be up to 250 tonne per year.

Subject to the size of the reaction chamber 17, the exhaust volume may be 25 Nm³/min to 3,000 Nm³/min, with an associated consumption of process gas of 100 l/min to 5,000 l/min.

As noted above, a portion of the process gas from each inlet plenum is also directed through the midpoint process gas delivery nozzle 153. In order to achieve this, the rear walls of the nozzle ducts for the main process gas delivery nozzles 152a, 152b include an array of nozzles apertures to direct the portion of process gas to the midpoint process gas delivery nozzle 153. However, the majority of the process gas from the inlet plenum is directed through the nozzle duct out main process gas delivery nozzles 152a, 152b.

The process gas flowing through the reaction chamber 17 may be from 200-400° C. Accordingly, the surface temperature of the heater typically will not exceed 450° C.

As shown in FIG. 8c, the reactor 10 is provided with an integrated abatement system 16a, 16b at each end. The abatement system 16a, 16b includes a burner 161a, 161b for combusting the exhaust gases at 700-850° C. so as to destroy reaction by-products, such as HCN. The burner 161a, 161b may be operated using natural gas supplied via line 165. The combustion gases are then vented to atmosphere along a duct 162a, 162b. The ducts 162a, 162b of the reactor 10 are connected to the ducts 262a, 262b of the integrated abatement systems 26a, 26b of the oxidation reactor 20.

Prior to being emitted along the duct 162a, 162b, the hot combustion gasses are passed through a heat exchanger 163a, 163b that allows heat to be transferred from the hot combustion gasses to the fresh substantially oxygen-free gas that has been supplied to the reactor 10. In the present case, the substantially oxygen-free gas is nitrogen. Thus, the cool nitrogen is heated by the combustion gasses so that warm nitrogen can be supplied to the sealing gas nozzle 19a, 19b and the process gas delivery nozzle 110a, 110b located at the inlet and outlet vestibules 13, 14. Similarly, the combustion gasses will be cooled prior to being vented to atmosphere. Thus, the heat exchanger 163a, 163b enables there to be energy recovery from the abatement system 16a, 16b, reducing the overall energy consumption of the reactor 10.

In the embodiment shown in FIG. 8c lines 191a, 191b and lines 1101a, 1101b branch from a line 1402a, 1402b from the heat exchanger 163a, 163b. An alternative embodiment, similar to the embodiment shown in FIG. 1b, is shown in FIG. 8d. In that embodiment, the heat exchanger 163b includes two outlets: one connected to the line 1101b supplying the process gas to the process gas delivery nozzle 110b, and another connected to the line 191b supplying the sealing gas to sealing gas nozzle 19b. The two outlets emit gas that has been subjected to a different degree of heat exchange with the combustion gasses in the heat exchanger 163b. Thus, the heat exchanger 163b is adapted to emit gas heated to two different temperatures. Accordingly, the process gas delivered by line 1101b is at a different temperature to the sealing gas delivered by line 191b. As the pre-stabilised precursor 81 is cooled prior to exiting the reactor through the outlet 12, it is desirable to supply sealing gas at a cooler temperature than the process gas, so that the sealing gas can cool the pre-stabilised precursor 81 as it passes through the outlet vestibule 14.

Although the heat exchanger 163b with two outlets is shown at the end of the reactor 10 closest to the outlet 12, it will be appreciated that the same arrangement can be used for the heat exchanger 163a and lines 191a, 1101a at the end of the reactor 10 closest to the inlet 11.

The reactor 10 is sealed and insulated from the oxidation reactor 20 positioned on top of it. It will be appreciated that the reactor 10 may, in alternative embodiments, be positioned on top of the oxidation reactor 20.

The oxidation reactor 20 of the stabilisation apparatus 1000 includes four reaction chambers 2701, 2702, 2703, 2704. Some features have been labelled with respect to one chamber 2703 only, but it will be appreciated that each chamber 2701, 2702, 2703, 2704 has the same structure in the apparatus 2000.

The reactor 20 has inlets 211, 212 and outlets 221, 222 for each pass of the precursor through the oxidation reactor 20. Each oxidation chamber 27 has a structure similar to the embodiment shown in FIGS. 6a and 6b, with an oxidation gas delivery nozzle 210a, 210b, 2102a, 2102b located next to the internal inlet and outlet for each oxidation chamber 2701, 2702, 2703, 2704.

As shown in FIG. 8b, a choke mechanism 209a, 209a′, 209b, 209b′ is provided at the inlets 211, 212 and outlets 221, 222. In addition, choke mechanisms 2091a, 2091a′, 2091b, 2091b′ are provided between the common vestibules 231, 241 and the oxidation gas delivery nozzle 210a, 210b, 2102a, 2102b, at the internal inlet and outlet for each oxidation chamber 2701, 2702, 2703, 2704.

Each choke mechanism 209a, 209a′, 209b, 209b′, 2091a, 2091a′, 2091b, 2091b′ comprises two sliding plates with each plate sliding independently of the other such that the position of the opening formed between the two plates to permit passage of the precursor may be altered between an upper position, a lower position and any intermediate positions therebetween.

The separation of sliding plates may be adjusted to provide the minimum working gap at the outlet to minimise ingress and egress of gas.

Each of the oxidation gas delivery nozzles 210a, 210b, 2102a, 2102b may include upper and lower output tubes located so as to be positioned above and below the precursor, with each output tube having a slot shaped aperture for directing gas towards the precursor. In some embodiments, each of the oxidation gas delivery nozzles 210a, 210b, 2102a, 2102b may include upper and lower output tubes located so as to be positioned above and below the precursor, with each output tube having a slot shaped aperture for directing process gas towards a distributor. The distributor is for directing and distributing the flow of gas across the width of the precursor. An example of such a nozzle configuration is illustrated in FIG. 1e for process gas nozzle 110b.

Insulated chamber barriers 201 are provided between the oxidation chambers to insulate the chambers 2701, 2702, 2703, 2704 from each other to permit independent adjustment of the temperature in each oxidation chamber 2701, 2702, 2703, 2704.

The oxidation chambers 2701, 2702, 2703, 2704 share common vestibules 231, 241 at each end. As the precursor passes back and forth through the oxidation chambers, each vestibule 231, 241 is adapted so as to be suitable for the passage of the precursor into and out of an oxidation chamber 2701, 2702, 2703, 2704. The ability to pass the precursor freely through the vestibules 231, 241, between a roller and the interior of the oxidation reactor 20, must be balanced with the need to limit egress of gas from the atmosphere within the oxidation reactor 20 into the atmosphere surrounding the oxidation reactor 20.

Accordingly, the length of each vestibule 231, 241, the amount of air drawn in through the inlets 211, 212 and outlets 212, 222 and the temperature of the gas blown into the oxidation reactor 20 are selected so that the precursor is not brought up to reaction temperature until it is located within an oxidation chamber 2701, 2702, 2703, 2704 so as to minimise evolution of HCN in each vestibule 231, 241.

Furthermore, the amount of air drawn in through the inlets 211, 212 and outlets 221, 222 into each vestibule 231, 241 and the length of each vestibule 231, 241 are selected so as to ensure that the precursor cools prior to passing through an outlet 221, 222. The precursor will be cooled such that it is below the reaction temperature prior to exiting the reactor 20 so as to ensure that the precursor does not continue to react and, as such, evolve HCN once it is outside the oxidation reactor 20 as this would pose a safety risk.

Each vestibule 231, 241 includes an exhaust duct 282a, 282b for directly extracting exhaust gas from the vestibules 231, 241, as well as exhaust nozzles (not shown) above and below the precursor for each pass. The exhaust ducts 282a, 282b and pipes 281a, 281b from the exhaust nozzles are connected to the integrated abatement systems 26a, 26b.

The rate at which gas is drawn through the exhaust ducts 282a, 282b and exhaust nozzles is controlled so as to effectively seal the oxidation chambers 2701, 2702, 2703, 2704 by limiting incidental gas flow out of the oxidation reactor 20 through the inlets 211, 212 and outlets 221, 222. In this embodiment where air is the oxidation gas, cool air is drawn in by the exhaust duct through the inlets 211, 212 and outlets 221, 222. Accordingly, the oxidation reactor 20 will be operated with a slight negative pressure in the vestibules 231, 241 so that fugitive emissions are not emitted from out the inlets 211, 212 and outlets 221, 222. Sensors are located at the inlets 211, 212 and outlets 221, 222 in order to monitor for fugitive emissions to ensure operator safety. One or more sensors will monitor whether the atmosphere immediately external to the inlets 211, 212 and outlets 221, 222 has a HCN content not exceeding 10 ppm, noting that the Australian Adopted National Exposure Standards For Atmospheric Contaminants In The Occupational Environment [NOHSC: 1003 (1995)] specifies exposure standards of exposure standards 10 ppm, peak, skin and 10 mg/m³, peak, skin. Preferably, the HCN content will not exceed 2.5 ppm, more preferably not exceeding 1 ppm. Also, at least one sensor will be used to monitor whether the atmosphere immediately external to the inlets 211, 212 and outlets 221, 222 has an oxygen content that does not fall lower than 20.9%.

At the end of each vestibule 231, 241, there is an internal inlet slot and an oxidation gas delivery nozzle 210a, 2102b. The pre-stabilised precursor passes through the internal inlet, past the oxidation gas delivery nozzle 210a, 2102b and into a transitional region 220a, 220b, where the return nozzle 251a, 251b for the oxidation zone 271, 272 of the oxidation chamber 2701, 2702, 2703, 2704 is located, before entering the main portion of the relevant zone 271, 272 of the oxidation chamber 2701, 2702, 2703, 2704.

In some embodiments, the exhaust gas stream exits the oxidation reactor 20 through a pipe 281a, 281b at a temperature of 150-250° C. and a pressure of −10 to −6 millibar.

As can be seen from FIG. 8b, for each pass of the pre-stabilised precursor 81 through the oxidation reactor 20, after the pre-stabilised precursor moves through one vestibule 231, 241, it moves through a transition area 220a, 220b for an oxidation chamber 2701, 2702, 2703, 2704. The precursor then passes through the oxidation chamber 2701, 2702, 2703, 2704, through another transition area 220b, 220a, and through the other vestibule 241, 231, before exiting via an outlet 221, 222. The precursor may then be passed back through the same oxidation chamber 2701, 2702, 2703, 2704 or passed on to the next chamber 2701, 2702, 2703, 2704 of the oxidation reactor 20 until all passes through the reactor 20 have been completed and a stabilised precursor 82 has been produced.

Each oxidation chamber 2701, 2702, 2703, 2704 has two oxidation zones 271, 272, each generally provided with its own forced gas flow assembly. However, it can be seen that at the centre of each reaction chamber a common midpoint oxidation gas delivery nozzle 253 is provided so as to ensure the flow of gas is supplied along the entire length of the oxidation chamber 2701, 2702, 2703, 2704.

The structures of the forced oxidation gas flow assemblies for the two oxidation zones 271, 272 are mirrored. The assemblies are adapted to predominantly supply oxidation gas to the oxidation chamber 2701, 2702, 2703, 2704 from the centre to the ends. That is, most of the hot oxidation gas supplied to the reaction chamber 2701, 2702, 2703, 2704 is supplied from the centre of the chamber through the main oxidation gas delivery nozzles 252a, 252b and flows towards the ends of the chamber 2701, 2702, 2703, 2704. The bulk of the oxidation gas is recirculated by the forced oxidation gas flow assemblies during operation of the oxidation chamber, with fresh oxidation gas being supplied to compensate for losses through the exhaust ducts 282a, 282b and exhaust nozzles.

The gas flow uniformity may be such that there is only a 1% to 10% variation in gas flow across each of the width, height, and length of each oxidation chamber 2701, 2702, 2703, 2704. Typically, the gas flow rate will be such that the temperature measured adjacent to the precursor is within 60° C. of the temperature of the process gas, preferably within 50° C. of the temperature of the process gas. The velocity of the oxidation gas flow may be 0.5 to 4.5 m/s, for example it may be 2 to 4 m/s.

In this embodiment, each oxidation chamber 2701, 2702, 2703, 2704 has an effective heated length of about 16,000 mm, corresponding to two passes through the heated length of about 8,000 mm. The reaction chamber 2701, 2702, 2703, 2704 height is about 300 mm. The reaction chamber 2701, 2702, 2703, 2704 width is about 500 mm. It will be appreciated that in some embodiments the reaction chambers 2701, 2702, 2703, 2704 will be different sizes.

For example, in some embodiments, a reaction chamber 2701, 2702, 2703, 2704 may be higher than other reaction chambers 2701, 2702, 2703, 2704 so as to accommodate more passes of the precursor through that reaction chamber 2701, 2702, 2703, 2704 compared to the one or more other chambers 2701, 2702, 2703, 2704 of the stabilisation apparatus 1000.

Subject to the size of the reaction chamber 2701, 2702, 2703, 2704, the exhaust volume may be 25 Nm³/min to 3,000 Nm³/min, with an associated consumption of oxidation gas of 100 l/min to 5,000 l/min.

Each forced gas flow assembly is provided with a gas return duct (not shown) along which a heater (not shown) is disposed. Downstream from the heater is a fan 258a, 258b that is used to draw the oxidation gas through the heater, thus bringing it up to the process temperature. The gas is then blown by the fan through the inlet plenum (not shown) and out the main oxidation gas delivery nozzle 252a, 252b. A portion of the oxidation gas from each inlet plenum is also directed through the midpoint oxidation gas delivery nozzle 253. In order to achieve this, the rear walls of the nozzle ducts include an array of nozzle apertures to direct the portion of oxidation gas to the midpoint oxidation gas delivery nozzle 253. However, the majority of the oxidation gas from the inlet plenum is directed through the nozzle duct out the main oxidation gas delivery nozzle 252a, 252b.

The main oxidation gas delivery nozzles 252a, 252b are located above and below each pass of the precursor and terminate with a perforated sheet defining the array of nozzle apertures. Each oxidation gas inlet plenum has primary and secondary gas flow distribution baffles (not shown) to assist in assist in providing a uniform gas flow through the nozzle. Once the oxidation gas has passed along the oxidation chamber 2701, 2702, 2703, 2704, it is then directed through the return nozzle 251a, 251b back into the return duct. However, a portion of the oxidation gas will flow out of the reaction chamber 2701, 2702, 2703, 2704 into either vestibule 231, 241, carrying with it reaction by-products that are ultimately removed from the reactor via the exhaust ducts 282a, 282b and nozzles.

The oxidation gas flowing through the reaction chamber 2701, 2702, 2703, 2704 may be from 200-400° C. Accordingly, the surface temperature of the heater typically will not exceed 450° C.

The oxidation reactor 20 with the stacked oxidation chambers 2701, 2702, 2703, 2704 is provided with an integrated abatement system 26a, 26b at each end, similar to the abatement system 16a, 16b for the reactor 10. The abatement system 26a includes a burner 261a, 261b for combusting the exhaust gases at 700-850° C. so as to destroy reaction by-products, such as HCN. The burner 261a, 261b may be operated using natural gas. The combustion gases are then vented to atmosphere along a duct 262a, 262b.

Prior to being emitted along the duct 262a, 262b, the hot combustion gasses are passed through a heat exchanger 263a, 263b that allows heat to be transferred from the hot combustion gasses to the fresh oxygen-containing gas that has been supplied to the reactor 20. In the present case, the oxygen-containing gas is air. Thus, the cool air is heated by the combustion gasses so that warm air can be supplied to the oxidation chambers 2701, 2702, 2703, 2704 via a line 2402a, 2402b connected to the oxidation gas delivery nozzles 210a, 2102b. Similarly, the combustion gasses will be cooled prior to being vented to atmosphere. Thus, the heat exchanger 263a, 263b enables there to be energy recovery from the abatement system 26a, 26b, reducing the overall energy consumption of the oxidation reactor 20.

As shown in FIG. 8a, access hatches 1001, 1002, 1003, 1004 are provided to permit access to the vestibules 13, 14, 231, 241 of the reactor 10 and the oxidation reactor 20. In addition, access hatches 1005, 1006 are provided to permit access to each reaction zone 171, 172 or oxidation zone 271, 272. A hatch 1008 is provided to access the main gas delivery nozzles 152a, 152b, and the common midpoint process gas delivery nozzles 153 at the centre of the reaction chamber 17, and a hatch 1007 is provided to access the main gas delivery nozzles 252a, 252b and the common midpoint process gas delivery nozzles 253 at the centre of each oxidation chamber 2701, 2702, 2703, 2704.

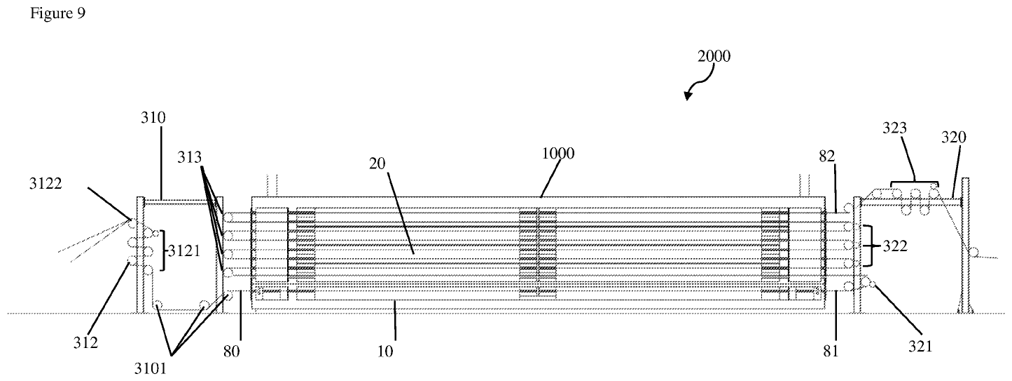

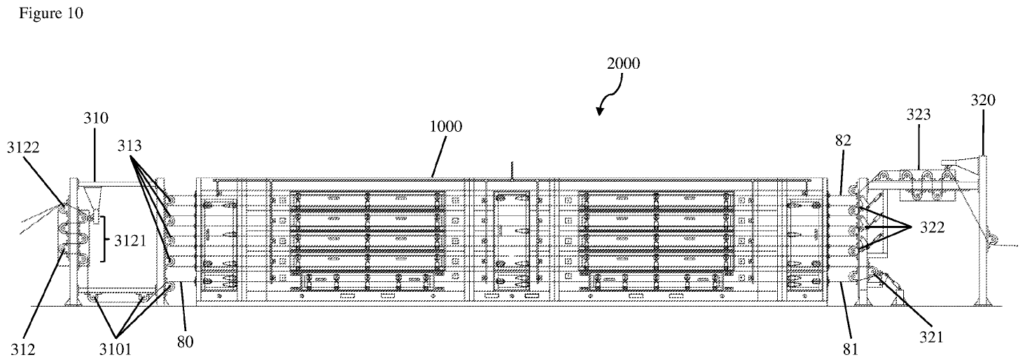

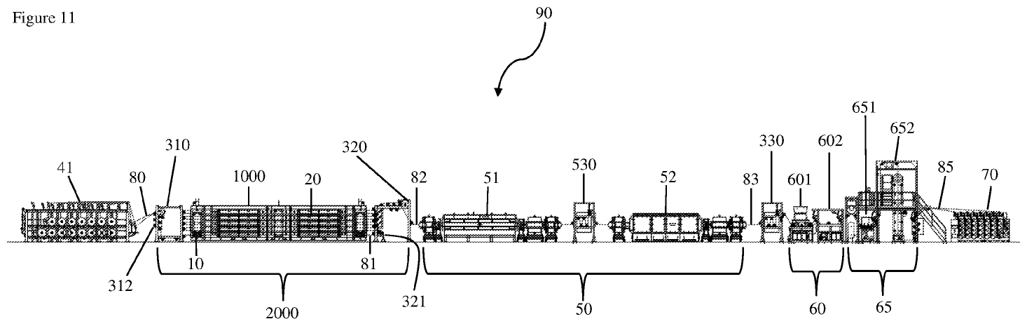

FIGS. 9 and 10 illustrate a stabilisation system using the apparatus 1000 illustrated in FIGS. 8a, 8b, and 8c. The system has first and second materials handling devices 310, 320 positioned at either end of the apparatus.

FIG. 9 shows the flow path of the precursor 80, 81, 82 through the stabilisation system. The precursor 80 enters the system from the fibre source (not shown) and passes through a drive station 312. The drive station 312 includes a 5-roller drive arrangement with a nip 3121 and a non-driven roller 3122. It is then transmitted through pass rollers 3101 that define the desired precursor flow path before entering the reactor 10. At the other end of the reactor there is a drive station 321 with an S-wrap arrangement. The drive stations 312, 321 are used to apply a substantially constant tension to the precursor as it is passed through the reactor 10. The precursor 81 then travels from the drive station 321 through the lowermost oxidation chamber 2704. Once it passes through the outlet 221 it travels around a non-driven roller 313 that then transmits the fibre back through the lowermost reactor 2704 for a second pass.

A drive station 322 is then used to transmit the fibre into the next reactor 2703 in the series. This drive station also has an arrangement of driven rollers with nip-rollers.

As shown in FIGS. 9 and 10 this arrangement of drive stations 322 and non-driven return rollers 313 is used for the remaining oxidation chambers 2702, 2701 in the oxidation reactor 20, with the final drive station 323 being used to transmit the stabilised precursor 82 to the next part of the system. The final drive station 323 has a 5-roller arrangement and a nip roller.

The stabilised precursor may be spooled and stored for later use in a carbon fibre production system. Alternatively, the stabilised precursor may be directly passed on to a carbonisation unit as part of a continuous carbon fibre production process. The drive stations 322, 323 at the end of each of oxidation chamber 2701, 2702, 2703, 2704 can be adapted to control the tension of the precursor passing through the chamber 2701, 2702, 2703, 2704. Accordingly, each chamber 17, 2701, 2702, 2703, 2704 in the system 2000 can have its own individual tension setting.

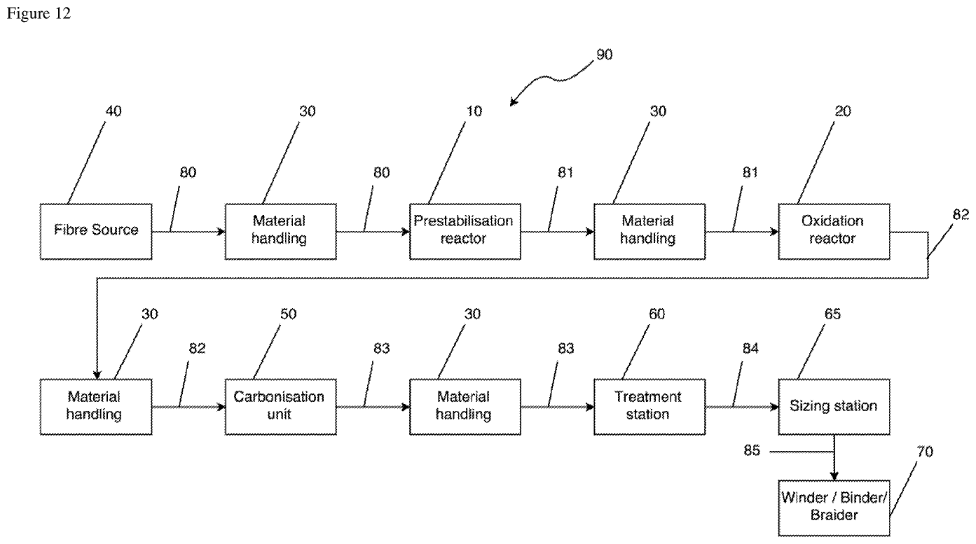

FIG. 12 shows the carbon fibre production system 90 in the form of a block diagram, which includes a reactor 10 in accordance with the present invention for producing a pre-stabilised precursor 81 from a polyacrylonitrile fibre precursor 80.

A fibre source 40 is used to dispense the precursor 80. Multiple fibres of the precursor 80 are simultaneously dispensed by the fibre source 40 as a tow. After the precursor fibres 80 are dispensed, they are passed through a material handling device 30, such as a tension stand having a plurality of rollers, as is well known in the art. This material handling device 30 is used, together with the material handling device 30 downstream of the reactor 10, to apply a predetermined tension to the precursor 80 as it passes through the reactor 10 to form the pre-stabilised precursor 81.

The pre-stabilised precursor 81 is then fed into an oxidation reactor 20, which may include a series of oxidation chambers (see FIGS. 5, 8a, 8b and 8c, for example). A further material handling device 30 is used to draw the pre-stabilised precursor 81 through the oxidation reactor 20. Similarly to the reactor 10, the material handling devices 30 upstream and downstream of the oxidation reactor 20 may be used to apply a predetermined tension to the pre-stabilised precursor 81 as it passes through the oxidation reactor 20 to form the stabilised precursor 82.

The stabilised precursor 82 is then processed by the carbonisation unit 50 to pyrolyse the stabilised precursor 82 and convert it into carbon fibre 83. The carbonisation unit includes one or more carbonisation reactors. The carbonisation reactors may be ovens or furnaces that are adapted to contain a substantially oxygen-free atmosphere and can withstand the high temperature conditions generally employed for carbon fibre formation. Next, a surface treatment may be performed at a treatment station 60. Then, a sizing may be applied to the treated carbon fibre 84 at a sizing station 65.

The tows of sized carbon fibres 85 are then wound using a winder 70 and/or bundled.

FIG. 11 illustrates an embodiment of a carbon fibre production system 90 that includes a stabilisation system 2000 as illustrated in FIGS. 9 and 10. Thus, the system 90 includes a stabilisation apparatus 1000 as shown in FIGS. 8a, 8b and 8c.

A creel 41 is used to unwind and dispense tows of the precursor 80. After the precursor fibres 80 are unwound, they are passed through a material handling device 310. The first drive station 312 and the drive station 321 downstream from the reactor 10 are used to apply a predetermined tension to the precursor 80 as it passes through the reactor 10 and is pre-stabilised.

The pre-stabilised precursor 81 is then fed into an oxidation reactor 20, which includes four oxidation chambers 2701, 2702, 2703, 2704. The further material handling device 320 cooperates with the first material handling device 310 to draw the pre-stabilised precursor 81 through the oxidation reactor 20 as described above.

The stabilised precursor 82 is the processed by the carbonisation unit 50 to pyrolyse the stabilised precursor 82 and convert it into carbon fibre 83. The carbonisation unit includes a first, low-temperature carbonisation reactor 51 and a second, high-temperature carbonisation reactor 52, with a material handling station 530 in between. The resulting carbon fibre 83 is then passed by a further material handling system 330 to the treatment station 60.

In the treatment station 60, the surfaces of the carbon fibre 83 are chemically etched through an electrolysis process using an electrolysis bath 601. The treatment station 60 includes a contact dryer 602 to reduce the moisture content on the treated fibre 84. Contact drying involves weaving the fibre through a single series of stainless steel, heated rollers that apply direct, uniform heat to the filaments.

The treated fibre 84 is then passed to the sizing station 65 at which a sizing in applied to the fibre 84. The fibre 84 is passed through a liquid sizing solution that coats individual fibre filaments using a sizing bath 651.

Non-contact drying takes place after sizing and is performed with a recirculation air dryer 652 to produce the sized carbon fibre 85.

The sized carbon fibres 85 are then wound using a winder 70.

Each line or pipe (e.g. 140, 1401, 1401a, 1401b, 1402, 1402a, 1402b, 1403a, 1403b 165, 181, 181a, 181b, 281a, 281b, 191, 191a, 191b, 1921, 1931a, 1931b, 1101a, 1101b, 1081, 2401a, 2401b, 2402a, 2402b) in the illustrated embodiments may include a flow damper so that the flow through the line or pipe can be regulated and fine-tuned.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Variations and modifications may be made to the parts previously described without departing from the spirit or ambit of the disclosure.

1. A reactor for pre-stabilising a precursor for a carbon-based material, the reactor comprising:
a reaction chamber adapted to pre-stabilise the precursor in a substantially oxygen-free atmosphere as the precursor is passed through the reaction chamber under a predetermined tension;
an inlet for allowing the precursor to enter the reaction chamber;
an outlet for allowing the precursor to exit the reaction chamber; and
a gas delivery system for delivering substantially oxygen-free gas to the reaction chamber, the gas delivery system comprising:
a gas seal assembly for sealing the reaction chamber to provide the substantially oxygen-free atmosphere therein and for limiting incidental gas flow out of the reactor through the inlet and the outlet; and
a forced gas flow assembly for providing a flow of heated substantially oxygen-free gas in the reaction chamber to heat the precursor in the substantially oxygen-free atmosphere.

2. A reactor according to claim 1, wherein the forced gas flow assembly comprises at least one return duct arranged to receive substantially oxygen-free gas from the reaction chamber and return substantially oxygen-free gas to the reaction chamber to recirculate substantially oxygen-free gas through the reaction chamber.

3. A reactor according to claim 2, wherein the forced gas flow assembly is adapted to recirculate 80% to 98% of the flow of heated substantially oxygen-free gas in the reaction chamber.

4. A reactor according to claim 2, wherein the forced gas flow assembly is adapted to recirculate at least 90% of the flow of heated substantially oxygen-free gas in the reaction chamber.

5. A reactor according to claim 1, wherein the reaction chamber comprises two or more reaction zones.

6. A reactor according to claim 1, wherein the forced gas flow assembly is adapted to provide a flow of heated substantially oxygen-free gas from the centre of the reaction chamber towards each end of the reaction chamber.

7. A reactor according to claim 1, wherein the forced gas flow assembly is adapted to provide a flow of heated substantially oxygen-free gas from each end of the reaction chamber towards the centre of the reaction chamber.

8. A reactor according to claim 1, comprising a heating system for externally heating one or more reaction zones of the reaction chamber.

9. A reactor according to claim 8, wherein the heating system comprises one or more heating elements for heating said one or more reaction zones.

10. A reactor according to claim 9, wherein the one or more heating elements are positioned within a heating jacket, the heating jacket being adapted to contain a heat transfer medium for distributing the heat from the heating elements along said one or more reaction zones.

11. A reactor according to claim 10, wherein the heating system comprises at least one return line arranged to receive heat transfer medium from the heating jacket and return heat transfer medium to the heating jacket to recirculate heat transfer medium through the heating jacket.

12. A reactor according to claim 1, wherein the gas seal assembly comprises: a gas curtain sub-assembly for providing a sealing gas curtain between the reaction chamber and each of the inlet and outlet; and an exhaust sub-assembly for extracting exhaust gases.

13. A reactor according to claim 12, wherein the exhaust sub-assembly comprises a hazardous gas abatement system for decontaminating the exhaust gases.

14. A reactor according to claim 13, wherein the hazardous gas abatement system includes a burner for combusting the exhaust gases so as to destroy reaction by-products and produce hot combustion gasses.

15. A reactor according to claim 14, wherein:
the gas delivery system comprises a supply line fluidly connected to a source of substantially oxygen-free gas for supplying substantially oxygen-free gas; and
the hazardous gas abatement system comprises a heat exchanger for transferring heat from the hot combustion gasses to the substantially oxygen-free gas supplied by the supply line so as to warm the substantially oxygen-free gas and cool the combustion gasses.

16. A reactor according to claim 1, comprising a cooling section, between the reaction chamber and the outlet, for actively cooling the precursor before the precursor exits the reactor.

17. A reactor according to claim 1, comprising two or more reaction chambers.

18. A reactor according claim 1, wherein:
the reaction chamber is vertically-orientated;
the reactor has a lower end and an upper end;
the inlet and the outlet are located at the lower end of the reactor; and
the reactor further comprises a roller for passing the precursor through the reaction chamber from the inlet to the outlet, wherein the roller is located at the upper end of the reactor and is for being disposed in the substantially oxygen-free atmosphere.

19. An apparatus for stabilising a precursor for a carbon-based material, the apparatus comprising:
a reactor according to claim 1 for producing a pre-stabilised precursor; and
an oxidation reactor downstream from the reactor, the oxidation reactor comprising at least one oxidation chamber adapted to stabilise the pre-stabilised precursor in an oxygen-containing atmosphere as the pre-stabilised precursor is passed through the oxidation chamber(s).

20. An apparatus according to claim 19, wherein for the or each oxidation chamber the oxidation reactor comprises:
an inlet for allowing the precursor to enter the oxidation chamber; and
an outlet for allowing the precursor to exit the oxidation chamber;
and the oxidation reactor further comprises:
an oxidation gas delivery system for delivering oxygen-containing gas to the or each oxidation chamber, the oxidation gas delivery system comprising:
a gas seal assembly for limiting incidental gas flow out of the oxidation reactor through the inlet(s) and the outlet(s); and
a forced gas flow assembly for providing a flow of heated oxygen-containing gas in the or each oxidation chamber to heat the pre-stabilised precursor in the oxygen-containing atmosphere.

21. An apparatus according to claim 19, wherein the reactor is located beneath the oxidation reactor.

22. An apparatus according to claim 19, comprising two or more oxidation chambers.

23. An apparatus according to claim 22, comprising four or more oxidation chambers.

24. An apparatus according to claim 19, said apparatus being adapted for production volumes of stabilised precursor up to 1,500 tonne per year.

25. An apparatus according to claim 19, said apparatus being configured to fit within a standard 40-foot shipping container.

26. An apparatus according to claim 19, comprising tensioning devices located upstream and downstream of the reaction chamber, wherein the tensioning devices are adapted to pass the precursor through the reaction chamber under a predetermined tension.

27. A system for stabilising a precursor for a carbon-based material, the system comprising:
a reactor according to claim 1 for producing a pre-stabilised precursor;
tensioning devices located upstream and downstream of the reaction chamber, wherein the tensioning devices are adapted to pass the precursor through the reaction chamber under a predetermined tension; and
an oxidation reactor downstream from the reactor, the oxidation reactor comprising
at least one oxidation chamber adapted to stabilise the pre-stabilised precursor in an oxygen-containing atmosphere as the pre-stabilised precursor is passed through the oxidation chamber(s).

28. A system for preparing a carbon-based material, the system comprising:
a reactor according to claim 1 for producing a pre-stabilised precursor;
tensioning devices located upstream and downstream of the reaction chamber, wherein the tensioning devices are adapted to pass the precursor through the reaction chamber under a predetermined tension; and
an oxidation reactor downstream from the reactor, the oxidation reactor comprising at least one oxidation chamber adapted to stabilise the pre-stabilised precursor in an oxygen-containing atmosphere as the pre-stabilised precursor is passed through the oxidation chamber(s); and
a carbonisation unit for carbonising the stabilised precursor to form the carbon-based material.

29. An apparatus according to claim 19, comprising tensioning devices located upstream and downstream of the or each oxidation chamber, wherein the tensioning devices are adapted to pass the pre-stabilised precursor through the or each oxidation chamber under a predetermined tension.

30. An apparatus according to claim 19, wherein each tensioning device comprises a load cell for sensing the amount of tension being applied.

31. An apparatus according to claim 19, comprising a reflectance Fourier-transform infra-red (FT-IR) spectrometer disposed downstream of the outlet of the reactor and upstream of the oxidation reactor, said FT-IR spectrometer being for monitoring the percentage of cyclised nitrile groups in the pre-stabilised precursor output from the reactor.
